(19) United States
(12) Patent Application Publication
(10) Pub. No.: US 2025/0312125 A1
(43) Pub. Date: Oct. 9, 2025

(54) SERIES OF DEVICES FOR PREPARING THE DISPLACEMENT, IN PARTICULAR A PERMANENT DISPLACEMENT, OF THE OCCLUSAL PLANE OF A PERSON, AND ASSOCIATED METHODS

(71) Applicant: Forstgarten International Holding GmbH, St. Gallen (CH)

(72) Inventors: Frank Hornung, Wolferschwenden (DE); Gerhard Polzar, Büdingen (DE); Johannes Landgraf, Karlsruhe (DE)

(21) Appl. No.: 18/865,550

(22) PCT Filed: May 17, 2022
(86) PCT No.: PCT/EP2022/063270

§ 371 Date: Nov. 13, 2024

(51) Int. Cl. A61C 7/08; A61C 7/00; A61C 13/34

(52) U.S. Cl. CPC A61C 7/08; A61C 7/002; A61C 13/34

(57) ABSTRACT

A series (100) of devices for assisting in the displacement of the chewing plane of a person (P) is explained, comprising
at least two devices (10),
wherein the devices (10) each comprise at least one jaw device (11, 12),
wherein the at least one jaw device (11, 12) comprises an upper jaw device (11) and/or a lower jaw device (12),
and wherein the devices (10) are designed to be worn by the person (P) according to a predetermined sequence.

In at least one device (10.1, 10.2), the at least one jaw device (11, 12) comprises at least one height element on a first side. At least two contact areas, preferably local contact areas, are formed on the at least one height element at mutually different positions of molar elements. At least one further contact area is formed on a second side of the at least one jaw device (11, 12), in particular a further local contact area. The at least three contact areas define the plane (GE),
wherein the plane (GE) deviates from a starting chewing plane of the person (P) or from a current chewing plane of the person (P) with respect to its inclination changed by the at least one height element in a frontal section or sagittal section and/or deviates with respect to its height position changed by the at least one height element, and
wherein in at least one other device of the series (100) a different inclination in a frontal section or sagittal section and/or a different height position of the respective plane is adjusted by at least one further height element, which differs from the at least one height element in the adjusted height.

The present invention is in the field of dentistry. In dentistry, complexly designed devices and methods are used to:
1) Readjust the chewing/masticatory plane/chewing surface, and/or
2) To advantageously displace teeth in the dentition before, simultaneously or subsequently, and/or
3) To simultaneously improve the appearance and shape of the teeth aesthetically, whereby aesthetic improvements often also result in functional improvements.

Dentistry includes, for example:
The restoration of teeth,
The use of implants,
The esthetic correction and improvement of teeth,
The orthodontic displacement of teeth in their orientation and position in the upper and lower jaw.

Well-known series of devices are also known as aligners because they have an alignment function that aligns teeth. However, it may be dentally unfavorable if only the alignment functions are considered singularly.

It is therefore the task of the invention to provide a series that has functions that go beyond the functions used to date or that have other functions. In particular, it should be possible to change the position of a chewing plane, for example in a simple manner and/or in combination with alignment functions or displacement functions, which may affect the teeth of the entire dental arch or an arch-shaped tooth element structure. Furthermore, associated methods and associated units should be disclosed, such as a computer system, a computer program, a computer program product and associated digital design data and associated digital manufacturing data. An associated treatment plan should also be disclosed, in particular a digital treatment plan.

This task is solved with regard to the series by the series specified in patent claim 1. Further embodiments are indicated in the dependent claims. The tasks relating to the methods and the other units are solved by the patent subject matter of the corresponding independent claims. Here too, further embodiments are indicated in the dependent claims.

The series may comprise devices to assist in displacing a person's chewing plane. There may be at least two, five, ten, etc. devices or at least two, five, ten, etc. pairs of devices. The devices or pairs of devices may each comprise at least one jaw device. The at least one jaw device may each comprise or consist of an upper jaw device and/or a lower jaw device.

According to one embodiment, the devices or pairs of devices may be designed to be worn by the person according to a predetermined sequence, in particular according to a sequence defined in a treatment plan, in particular in a digital treatment plan stored or storable on a computer.

According to one embodiment, the jaw device may extend from a receiving region for a left molar (tooth) element via at least one receiving region for an anterior element or a canine element to a receiving region for a right molar element. Thus, the jaw device may comprise at least one first receiving region for a left molar (tooth) element, at least one second receiving region for an anterior tooth or canine tooth element and at least one third receiving region for a right molar (tooth) element. The receiving regions may be arranged in device elements of the device, e.g. in veneer elements or tooth veneers, e.g. at anterior tooth positions or canine tooth positions or in device elements or height elements in the molar region (molar, premolar).

According to one embodiment, the jaw device may define a plane.

According to one embodiment, in at least one device, the at least one jaw device may comprise at least one height element on a first side.

According to one embodiment, at least two contact areas may be formed on the at least one height element at different positions of molar (tooth) elements, in particular local contact areas, which may be parts of a larger contact area, e.g. a larger flat contact area. The two contact areas on the height element or the two local contact areas on the height element may have a distance between them of at least 10 mm or at least 15 mm, e.g. less than 30 mm. This may allow at least two points of a plane to be defined in a simple and/or defined manner. The contact areas may be in contact with tooth elements during biting if no device is placed on the opposite jaw or in contact with the device on the opposite jaw, in particular with tooth replicas or other areas of the opposite device.

For example, there may only be one height element on the first side, which has two contact areas, for example. Alternatively, there may be, for example, two or at least two height elements, each of which has at least one contact area, e.g. exactly one contact area or more than one contact area.

According to one embodiment, at least one further contact area may be formed on a second side of the at least one jaw device, in particular also a local contact area, which may be part of a larger contact area, for example a larger planar sliding area.

The contact areas, in particular the local contact areas, may be punctiform or typically planar, especially if compliant, plastically deformable or elastically deformable materials are used for the devices or pairs of devices.

According to one embodiment, the at least three contact areas may define the plane. If there are more than three contact areas, these may lie in one plane. Alternatively, a plane may be determined using suitable mathematical methods, e.g. using the least sum of squares method or a similar method in which another suitable mathematical measure is used for minimization when determining the position of the plane. Instead of the plane, reference may also initially be made to two straight lines, which then define the plane.

According to one embodiment, the plane may deviate from a starting chewing plane of the person or from a current chewing plane of the person with regard to its inclination changed by the at least one height element in a frontal section and/or sagittal section and/or with regard to its height position changed by the at least one height element. A frontal section may, for example, be perpendicular to a support plane on which the device rests. The frontal section may be made through the same tooth positions on the right/left, particularly in the molar region. The sagittal section may be parallel to a left/right center line of the device and may also be parallel to a support plane on which the device rests. When resting on the device, the receiving regions for tooth elements may face downwards, i.e. towards the support plane. This may apply to both the lower jaw device and the upper jaw device. Occlusal surfaces of the device may also be suitable for resting on a plane in order to define the frontal section and/or the sagittal section. In other variants, a frontal section/sagittal section may be defined on the basis of skull structures or digital images of skull structures of a patient, which is explained in more detail below.

According to one embodiment, in at least one other device of the series, a different inclination in a frontal section or sagittal section and/or a different height position (e.g. distance to a cranial structure) of the respective plane may be adjusted/set by at least one further height element, which differs from the at least one height element in the adjusted/set height.

According to one embodiment, in at least one device of the devices, the at least one jaw device may thus comprise at least one contact area on at least one height element. The at least one contact area may define a plane, in particular a plane that may deviate from a starting chewing plane of the person or from a current chewing plane of the person with respect to its inclination changed by the height element. The position of the person's chewing plane may be determined using mathematical methods.

The height element may adjust or set a distance of at least 1 mm (millimeters) of at least 2 mm or at least 3 mm between the contact area and an occlusal surface of an underlying tooth element or a surface facing away from the contact area in a receiving region for the underlying tooth element. In the case of a maxillary device, it may also be said that the tooth element lies below the contact area, as it is covered by the latter.

The at least one height element or the height elements may adjust or set a height that is at least twice as high or at least three times as high as a height of the at least one device above the at least one receiving region for the anterior tooth element or for the canine tooth element.

The plane may be a contact plane in which the at least one contact area of the height element and preferably other contact areas are located, e.g. contact areas on height elements or on other elements or surfaces of the device, e.g. a lower jaw device and/or an upper jaw device.

In the contact plane, there may be a keying, i.e. height profiles, which may prevent sliding movements. Nevertheless, a new chewing plane may be learned by the person, e.g. during the chewing movement when eating or during involuntary chewing movements outside of mealtimes. Habituation effects may also lead to relearning.

According to another embodiment, the at least one contact area may be a sliding contact area and may define a sliding plane in which the jaw device may slide such that the person is assisted in learning a new chewing plane that may differ from the person's current chewing plane, for example with respect to its inclination or another parameter. For example, the upper jaw device and the lower jaw device may slide relative to each other in the plane defined by the at least one contact area. Instead of sliding movements, rolling movements or rolling-sliding movements may also be possible. Flat sliding surfaces may therefore be used at the contact areas or differently shaped sliding surfaces.

“Sliding” here may mean that transverse relative movements between the jaw device and an opposing dental arch or between two jaw devices of a device are possible by at least one value that is in the range of 1 mm (millimeters) to 5 mm or in the range of 1 mm to 3 mm. The minimum value may therefore be 1 mm, 2 mm or 3 mm, for example. The maximum value of the relative movement may be given by the anatomy of the jaws or by additional ramps that may form a stop.

Sliding may be possible in at least one spatial direction or in at least two spatial directions that are orthogonal to each other. In the case of two spatial directions, the values specified above for the sliding movement may apply to one of the two spatial directions, e.g. left-right or rear-front, or to both spatial directions.

The deviation of an angle of inclination in the frontal plane or in the sagittal plane may, for example, be in the range of 0.2 degrees to 2 degrees or in the range of 0.5 degrees to 1 degree. The angle may be measured between the two chewing planes that are compared, e.g. if they are superimposed using the same reference point. The angle may then be determined between the directions of the surface normals.

In a further embodiment, the angle may be determined relative to a reference structure, e.g. a sagittal plane of the person's head, etc.

The deviation in the inclination may be manifested by a “tilting” of the chewing/masticatory plane, whereby a change in the distance from the occlusal reference point of a tooth to the chewing/masticatory plane may occur at at least one tooth position according to a tooth scheme or at several tooth positions. The distance may change, for example, in the range of 0.5 mm to 2 mm. No change in the distance may occur at other tooth positions. At other tooth positions, the distance may change in the opposite direction.

In addition or alternatively, there may also be a transverse displacement of the chewing/masticatory plane in the current chewing/masticatory plane or in the chewing/masticatory plane whose inclination has changed, e.g. from back to front, from front to back, from left to right or from right to left, rotation around the surface normal of the chewing/masticatory plane, etc. A parallel shift of the chewing/masticatory plane may also take place in addition to or as an alternative to the change in inclination, whereby a transverse displacement may be carried out or whereby no transverse displacement may be carried out.

The plane, e.g. the sliding plane, may be defined by contact areas, e.g. by one contact area, by at least two contact areas, by at least three contact areas, by at least four contact areas or by more than four contact areas. In this way, the position of a plane may be defined by at least three points. The size and/or number of contact areas may make it easier to define the sliding plane or its stable position in space.

The contact area may be flat, e.g. to better define the position of the sliding plane. The lateral extent of the flat surface of the contact area may exceed the extent of areas that are usually formed by a fissure on teeth/tooth elements. This may make it possible to avoid a so-called “keying” of teeth or tooth elements of the upper and lower jaw, i.e. a lateral relative movement of the upper and lower jaw may be made possible. This lateral mobility may enable the chewing/masticatory muscles and/or the person's brain to be stimulated to make lateral corrections to the position of the upper jaw or lower jaw and thereby learn the new position of the chewing plane, in particular the new inclination. An edge gap between the jaw device and teeth or dental elements may support the relearning process, but is not a prerequisite.

A contact area of an upper jaw device may be opposite a contact area in a lower jaw device. If the contact area is flat, “keying”, which may manifest itself in “latch/lock biting”, may be effectively prevented if there is a flat sliding surface only in the upper jaw device at the sliding contact area or only in the lower jaw device at the sliding contact area. Opposite the flat sliding surface, there may be at least one sliding element that may slide on the plane, e.g. only one sliding element, two sliding elements, three sliding elements or more than three sliding elements. The at least one sliding element may, for example, be a protrusion that is the size of a dental fissure, e.g. a dental fissure itself or a replica of a dental fissure. Alternatively, the protrusion may also be smaller than a dental fissure, i.e. a maximum lateral dimension may, for example, be smaller than 2 mm or even smaller than 1 mm. Rounded protrusions may reduce friction. A contact line may be formed, e.g. when a cylinder or wedge makes contact with a sliding plane. The cylinder or wedge may extend along a transverse direction, e.g. from a left molar to a right molar.

The at least one sliding element may have a preferably point contact with the flat sliding surface of the contact area or a linear contact, which may reduce the mechanical friction between the two. On the other hand, a greater hardness of the material of the flat sliding surface or a sliding element may be used in the case of an approximately point contact or a linear contact. If there is a small planar contact, softer materials may be used to form the sliding surface and/or the contact element.

In general, the position of a masticatory plane may be defined by three angles of the surface normal of the masticatory plane or a tangent to the masticatory plane to three coordinate axes of a Cartesian coordinate system and by three position coordinates with respect to the three coordinate axes, i.e. by a total of six parameters.

The inclination of the chewing/masticatory plane may therefore be described by, for example, two (room) angles between the normal of the/masticatory plane and two of the coordinate axes or three of the coordinate axes, whereby the normal may be extended in the direction of the origin of the coordinates and/or shifted parallel so that it intersects the relevant coordinate axis, for example. The plane in which the angle is then determined may be the plane that comprises both the surface normal and the coordinate axis. In this context, we may also talk about tilt angles or inclination.

A third angle may describe a rotation/twisting of the chewing plane, e.g. a twisting of a front-back “center line” of the dental arches, whereby the center line may lead exactly through a point of contact of the front incisors or in the middle of a gap that may lie between these incisors. The two incisors may preferably each lie in a different quadrant of a tooth pattern. At least one coordinate axis may be projected into the chewing/masticatory plane in order to determine the third angle in the chewing/masticatory plane, i.e. the angle between the projection of the coordinate axis and the centerline. On the other hand, the center line may also be projected into a plane in which two of the three coordinate axes lie in order to determine the third angle there. In this context, it is also possible to speak of a rotation of the chewing/masticatory plane within the chewing/masticatory plane.

A reference point on a tooth or tooth element may be used to determine the position of the chewing plane, e.g. the incisal point (contact with or gap center between the two front incisors in the lower jaw), a corresponding point may be used in the upper jaw. Alternatively, another reference point on a tooth or tooth element may be used to determine the position of the chewing plane. Alternatively, the reference point may also be determined in another way, e.g. on a geometric shape that circumscribes the respective dental arch, e.g. a triangle, a quadrilateral, a pentagon, etc. Other options for defining a suitable reference point may also be used.

In particular, the series of devices may be assigned to the same person and/or aimed at a uniform treatment goal for this person's teeth.

The use of the proposed series may therefore make a decisive difference to known series, because in known methods the chewing plane is not displaced at all or only after a displacement of the teeth/tooth elements or a widening or other change of a dental arch carried out with the series. This may lead to blockages when teeth/tooth elements are displaced and/or to the person counteracting the displacement as soon as the devices are no longer used. For example, teeth that have been built up in a final restoration may be “chewed off” again because the person has not yet learned where the new chewing plane should be. This may be counteracted with the proposed series, because the new position of the chewing plane may be adjusted (set) and/or learned first and, if necessary, tooth positions/arches may be shifted or the final restoration may be made only afterwards.

In particular, relearning may be neuromuscular relearning. Relearning may be achieved through habituation and/or conscious training.

There may be at least 10, at least 20 or at least 30 devices in the series. There may be less than 100 devices in the series. The exact number of devices may be specified in a treatment plan and may depend, for example, on whether or not attachments are used or what pressure on their teeth the person concerned still finds acceptable.

The attachment of attachments to the teeth may play an important role in the success of the treatment. Compared to the teeth, the attachments may be small fastening elements made of composite, i.e. a tooth-like substance, which ensure that tooth movement may take place more quickly, easily and efficiently. The attachments may act as an anchor that the aligner grips to accomplish the movement. Attachments allow the necessary pressure for tooth movement to be applied precisely. In addition, the attachments may enable complex movements such as the rotation of the teeth and ensure that the correction takes place without unnecessary “intermediate movements”. Attachments may be used, for example, to move teeth away from the jaw.

In principle, treatment may also be carried out without attachments. For some malalignments, attachments are simply not required and/or may be omitted or scheduled for a later date if desired. Treatment without attachments may result in more splints being required to achieve the target alignment.

The devices may remain in the mouth while eating, so that the person/patient may get used to the new position of the chewing plane even while eating. Teeth or remaining dental element structures of the person may form at least one new bite structure together with the devices, the bite plane of which may correspond to the new position of the chewing plane, e.g. an intermediate chewing plane, a training chewing plane or the planned final chewing plane. After eating or at the usual times, the respective worn device may be removed from the mouth in order to simply clean the teeth and/or the device, e.g. the respective upper jaw device and/or the respective lower jaw device.

In another embodiment, the device or devices may also be removed from the mouth when eating. The new position of the chewing plane may then be learned in the periods between meals.

The tooth element structure may be formed from several tooth elements. A tooth element may be a natural tooth, e.g. a non-treated tooth, a treated tooth (e.g. comprising one or more fillings), a partially crowned tooth, a fully crowned tooth or an artificial tooth, in particular a tooth with an artificial tooth root, an implant, a veneered tooth, a pin tooth, a ground or grinded tooth, an implant fastening device, in particular a pin-shaped fastening device, etc.

Between the first device and the second device, in all of the above embodiments, no further devices of the series may be interposed according to the predetermined sequence. On the other hand, a further device or further devices of the series may be interposed between the first device and the second device in all of the above embodiments in accordance with the predetermined sequence. The first device may have the number 1 in the numbering of the devices, but does not have to. The second device may or may not have the number 2 in the numbering of the devices. However, the second device is in the sequence after the first device. The first device may therefore have a number n, where n may be a natural number greater than 1. The second device may then have a number n+1 or a number n+m, where m is also a natural number, in particular greater than zero and, for example, also greater than 1.

In particular, this may involve the preparation of a permanent displacement of the chewing/masticatory plane, which may differ, for example, from a temporary displacement, e.g. to enable certain tooth displacements. In particular, the permanent chewing/masticatory plane may be permanently set in a final restoration, e.g. by using table tops (height build-up) and/or onlay(s) (with grinding of the tooth surface), crown(s), bridges, implants, in particular also combinations of the aforementioned elements. Blocking over several teeth should be avoided as far as possible in order to prevent disadvantages such as damage to the fine retaining fibers (Sharpey fibers) of the teeth.

In this way, the position of the chewing/masticatory plane may be built up to the last aligner, directly, e.g. by asymptotic approximation, or indirectly, i.e. with overshooting, which is explained in more detail below.

The final height position of the chewing/masticatory plane or the final position of the chewing/masticatory plane may be a physiologically suitable position of the chewing/masticatory plane. This final position may differ from a non-permanent position of the chewing/masticatory plane, such as may be used, for example, for “shunting activity” to relocate individual teeth or for only temporary, in particular exaggerated, neurological reprogramming. The final position or the target position of the chewing/masticatory plane may adjust or set a new axial position in relation to the joint axis of the chewing/masticatory joint.

In particular, the following variants may be possible:
a) Only the inclination of the chewing/masticatory plane in a frontal plane may be changed, especially in preparation for a permanent change, i.e. not, for example, the inclination of the chewing/masticatory plane in the sagittal plane or the height of the chewing/masticatory plane.
b) Only the inclination of the chewing/masticatory plane in a sagittal plane may be changed, especially in preparation for a permanent change, i.e. not, for example, the inclination of the chewing/masticatory plane in the frontal plane or the height of the chewing/masticatory plane.
c) The inclination of the chewing/masticatory plane in the sagittal plane and the inclination of the chewing/masticatory plane in the frontal plane may be changed, in particular preparing a permanent change, whereby the height of the chewing/masticatory plane cannot be changed.
d) Only the height of the chewing/masticatory plane may be changed in order to prepare for a permanent change in height. The inclination of the chewing/masticatory plane in a sagittal section or a frontal section may remain the same, i.e. not change.
e) There may be further combinations of the above changes, e.g. a change to all three parameters.
f) There may be further changes, i.e., for example, a rotation of the chewing/masticatory plane within the chewing/masticatory plane itself, i.e., a rotation about an axis of a surface normal of the chewing/masticatory plane, in particular without other changes to the aforementioned parameters or in combination with a change to the aforementioned parameters.

The contact areas or contact points may be individual, they may be comprised in contact lines or they may be comprised in contact surfaces. The three contact areas or contact points may be arranged in such a way that they form a triangle, i.e. all three contact areas do not lie on a straight line. This means that the plane may be easily and precisely defined or predetermined by the three contact areas, in particular by at least one local contact area.

The height elements of the series used to displace the chewing plane may be designed in such a way that a permanent displacement of the chewing plane is prepared. The preparation of the permanent displacement may be carried out by a direct approach to a target chewing plane, in which the height adjusted or set by the height elements increases or decreases incrementally. Direct approximation may be performed more quickly than indirect displacement, for example using fewer devices or fewer device pairs in the series. However, medical conditions may argue against the use of direct preparation.

Alternatively, an indirect approach to the target chewing plane may be used, in which the height adjusted or set by at least one height element initially increases incrementally and then decreases in the opposite direction or initially decreases and then increases in the opposite direction. This may make it possible to take better account of medical conditions. Alternatively or additionally, neurophysiological relearning may be facilitated if, for example, an exaggeration is initially made, which is then reduced. Such an “exaggeration” may also lead to a stretching of the temporomandibular joint, which makes relearning easier or, in certain cases and/or for certain people, may make it possible in the first place.

According to one embodiment, in at least two devices or in at least two pairs of devices, the jaw device, for example the upper jaw device and/or the lower jaw device, may each comprise the at least one (local) contact area, e.g. a sliding contact area, on at least one height element. In a first device or in a first device pair of the at least two devices/device pairs, first receiving regions for teeth or tooth elements may be present, e.g. for a tooth element structure of the upper jaw or of the lower jaw. The first receiving regions may be arranged relative to the first plane, e.g. a first sliding plane, of the first device or the first pair of devices according to a first arrangement.

According to one embodiment, in a second device or in a second device pair of the at least two devices/device pairs, second receiving regions for the teeth/tooth elements or for the tooth element structure of the upper jaw or of the lower jaw may be arranged relative to a second plane, e.g. sliding plane, of the second device or of the second device pair according to a second arrangement which differs from the first arrangement. The second arrangement, which differs from the first arrangement, may allow the chewing plane to be adjusted, in particular with regard to its inclination. A relearning, in particular a neuromuscular relearning, of the position of the chewing plane of the person may be made possible from a chewing plane associated with the first arrangement, e.g. the first plane, to a chewing plane associated with the second arrangement, which may be located, for example, in the second plane, in particular by changing the inclination of the chewing plane/sliding plane or the height position.

According to another embodiment, there may be the following sliding surfaces:
A first sliding surface at the top right, and/or
A second sliding surface at the top left, and/or
A third sliding surface at the bottom left, and/or
A fourth sliding surface at the bottom right.

A first sliding contact may be formed by the first sliding surface and the fourth sliding surface. A second sliding contact may be formed by the second sliding surface and the third sliding surface. The first sliding contact area and the second sliding contact area may be arranged in the sliding plane. The sliding surfaces may be flat or planar.

Instead of a chewing plane or plane or flat/plane sliding surfaces, a curved surface, e.g. sliding surface, may also be defined as long as it is ensured that the surface benefits the success of the treatment and/or relative movements may take place, e.g. surfaces that comprise curves in the sense of a Spee curve.

The chewing plane may be determined, for example, with a metal plate that is placed between the teeth, e.g. before the start of treatment to determine a starting chewing plane. This means that a bite plane may be determined when the occlusal surfaces of the teeth of the upper jaw are in mechanical contact with the chewing/occlusal surfaces of the teeth of the lower jaw. As mentioned above, the bite structures may also be supplemented by the devices, in particular by parts of the devices arranged on occlusal surfaces of the teeth/tooth elements. The chewing plane displaced by these devices in the course of treatment with the devices of the series may then be permanently realized in a final restoration at the end of the treatment, i.e. in particular in a form firmly anchored to the teeth, whereby the existing or still existing teeth may also be used as far as possible.

According to one embodiment, in a third device of the at least two devices, the at least one jaw device may include the at least one contact area on at least one height element. In the third device or a third device pair of the at least two devices/device pairs, third receiving regions for teeth/tooth elements or for the tooth element structure of the upper jaw or the lower jaw may be arranged relative to a third plane, for example a third sliding plane, of the third device pair according to a third arrangement. The third arrangement may differ from the first arrangement and/or from the second arrangement. The third arrangement may cause a change in the position of the chewing plane of the person towards a third chewing plane (third plane in or at the third device), which for example lies in the third plane and which may differ from the first chewing plane (first plane in or at the first device) and/or from the second chewing plane (second plane in or at the second device), in particular a change in the inclination of the chewing plane and/or other parameters of the chewing plane. The third arrangement may enable a preferably neuromuscular relearning of the position of the chewing plane of the person towards the third chewing plane, which may differ from the first chewing plane and/or from the second chewing plane.

A change in the second arrangement compared to the first arrangement may take place in the same direction or with the same tendency as a change in the third arrangement compared to the second arrangement. The same direction or the same tendency may mean, for example, that an angle between the respective plane, e.g. the sliding plane, and the chewing plane in a frontal plane becomes successively larger or smaller. Additionally or alternatively, an angle between a respective plane, e.g. sliding plane, and chewing plane in a sagittal plane may also become successively larger or smaller. Furthermore, additionally or alternatively, the distance between the respective plane and the chewing plane may become successively larger or smaller. Or, additionally or alternatively, the height position of the plane, in particular the chewing/masticatory plane, may be changed.

The technical effect of the embodiment may be that changes may be made in several steps, e.g. to achieve a better feeling in the person, i.e. to increase the acceptance of the devices and/or also to reduce pain.

The third device or the third pair of devices may have the number “3” according to the sequence, but does not have to. The third device or the third pair of devices may be located after the second pair of devices/devices and/or also after the first pair of devices/devices according to the sequence, e.g. the sequence provided for in the treatment plan. The three device/device pairs may be located directly behind each other in the sequence. Alternatively, there may be other devices/device pairs in between, in which, for example, the position of the masticatory plane is maintained.

According to one embodiment, in particular according to an alternative embodiment, in a third device of the at least two devices, the at least one jaw device may comprise the at least one contact area at at least one height element. In the third device or in a third pair of devices of the at least two pairs of devices, third receiving regions for teeth/tooth elements or for a tooth element structure of the upper jaw or of the lower jaw may be arranged relative to a third plane, for example a sliding plane, of the third device or of the third pair of devices according to a third arrangement. The third arrangement may differ from the second arrangement. The third arrangement may cause a change in the position of the chewing plane of the person (P) towards a third chewing plane (third plane), which differs from the first chewing plane (first plane) and/or from the second chewing plane/second plane), in particular a change in the inclination of the chewing plane. The third arrangement may enable a preferably neuromuscular relearning of the position of the chewing plane of the person towards a third chewing plane, which may differ from the first chewing plane and/or from the second chewing plane. A change in the second arrangement compared to the first arrangement may be made in the opposite direction or with the opposite tendency as a change in the third arrangement compared to the second arrangement.

Thus, the third arrangement may be like the first arrangement. The third arrangement may also be different from the first arrangement. The three devices/pairs of devices may again be located directly one behind the other in the sequence. Alternatively, there may be other devices/pairs of devices in between, in which, for example, the position of the chewing plane is maintained.

“Opposite direction” or “opposite tendency” may mean, for example, that an angle between the respective plane, e.g. the sliding plane, and the chewing plane in a frontal plane first becomes larger and then smaller again or that this angle first becomes smaller and then larger again. Additionally or alternatively, an angle between a respective plane, e.g. sliding plane, and chewing plane in a sagittal plane may first become larger or smaller and then smaller or larger. Likewise, additionally or alternatively, a distance between the respective plane, e.g. sliding plane, and chewing plane may first become larger and then smaller or first smaller and then larger.

For example, further devices of the series may be located in between according to the sequence, i.e. between the second device and the third device, in particular with constant arrangements of respective receiving regions to respective sliding planes, i.e. in particular with regard to the possibility of relearning the chewing plane.

A technical effect of the embodiment may be seen in enabling an “overshoot”. For example, during learning, a chewing plane may be offered as a learning goal that deviates more clearly from the final intended chewing plane than is subsequently realized. This may make relearning easier, as the difference is greater. However, there may also be other reasons for such “overshooting”, e.g. to better dissolve blockages, i.e. to achieve a unblocking more easily, for example.

In this embodiment, the third pair of devices may also bear the number “3” according to the sequence, but does not have to. The third pair of devices may be located after the second device or the second pair of devices and/or also after the first device or the first pair of devices according to the sequence, e.g. the sequence provided for in the treatment plan.

According to one embodiment, in a fourth device of the devices
the at least one jaw device comprises the at least one contact area on at least one height element. In the fourth device or in a fourth device pair of the at least two device pairs, fourth receiving regions for teeth/tooth element or a tooth element structure of the upper jaw or of the lower jaw may be arranged relative to a fourth sliding plane of the fourth device or of the fourth device pair according to a fourth arrangement.

The fourth arrangement may differ from the third arrangement. The fourth arrangement may enable a preferably neuromuscular relearning of the position of the chewing plane of the person towards a fourth chewing plane, which differs from the first chewing plane and/or from the second chewing plane, in particular with respect to its inclination and/or with respect to another position parameter of the chewing plane. Thus, for example, the fourth arrangement may enable a preferably neuromuscular relearning of the position of the chewing plane of the person towards a fourth chewing plane, which may differ from the first chewing plane and/or from the second chewing plane. A change in the third arrangement compared to the second arrangement may be made in the opposite direction to a change in the fourth arrangement compared to the third arrangement.

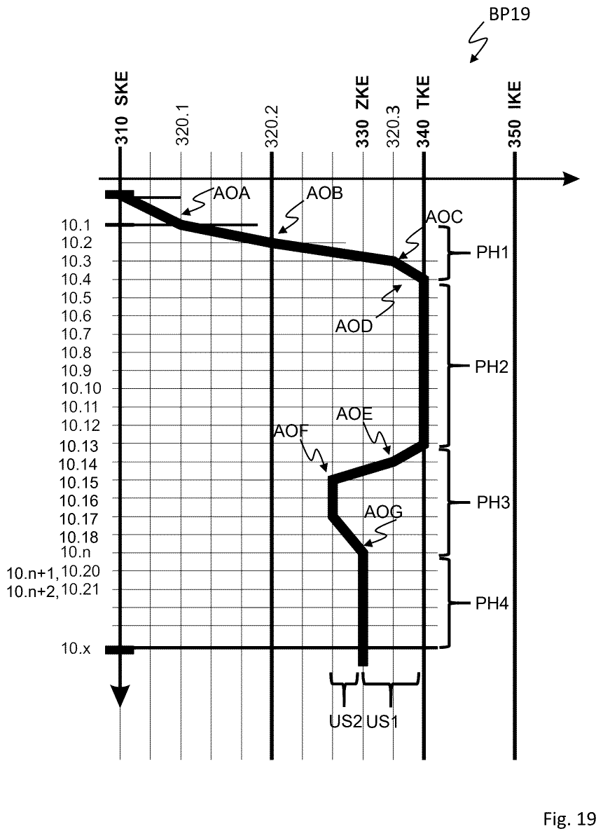

The technical effect of this embodiment may be to achieve a “back and forth” and “back and forth” “swing”. This is explained in more detail below using FIG. 19. This may result in further degrees of freedom in the design of the devices and in the dental treatments to be carried out. For example, more space may be created for further displacement of teeth or at least one dental arch.

In this embodiment, the fourth pair of devices may also bear the number “4” according to the sequence, but does not have to. The fourth pair of devices may be located after the third device or after the third pair of devices and/or also after the first device/pair of devices and/or after the second device/pair of devices according to the sequence, e.g. the sequence provided for in the treatment plan. The four devices/device pairs may be located directly behind each other in the sequence. Alternatively, there may be other devices/device pairs in between, in which, for example, the position of the chewing plane is maintained.

According to one embodiment, the at least one height element may extend over at least two receiving regions or at least three receiving regions for at least one molar element each or have a length in the range from 15 mm (millimeters) to 30 mm. Thus, the position of the plane may be determined robustly and/or in a simple manner, in particular already decisively or determiningly by the at least one height element.

According to one embodiment, the at least one height element may have a height of at least 2 mm, at least 3 mm or at least 4 mm, in particular of less than 5 mm or less than 7 mm, at at least one of the at least two receiving regions or of the at least three receiving regions. Thus, the position of the plane may be determined robustly and/or in a simple manner, in particular already decisively or determiningly by the at least one height element.

According to one embodiment, the at least one height element may define a height between the at least one contact area and a surface of a receiving region facing away from the at least one contact area. According to one embodiment, an occlusal surface of a tooth element at the same tooth element position as the at least one contact region and covered by the height element may lie against the surface. The surface may also lie opposite the occlusal surface, for example if an occlusal gap is provided.

The distance defined by the height element may be in the range from 2 mm to 6 mm or in the range from 2.5 mm to 5 mm.

According to one embodiment, no height element may be arranged on the second side of the at least one device, in particular no height element which, for example, causes a height difference of more than 1 mm. This may result in a device with strong right/left asymmetry, which may be necessary for certain treatments.

According to one embodiment, the at least one height element may define a height between the at least one contact area and a surface of a receiving region facing away from the at least one contact area. According to one embodiment, an occlusal surface of a tooth element at the same tooth element position as the at least one contact region and covered by the height element may lie against the surface. The surface may also lie opposite the occlusal surface, for example if an occlusal gap is provided.

According to one embodiment, the distance may be in the range from 2 mm to 6 mm or in the range from 2.5 mm to 5 mm.

According to one embodiment, at least one height element may also be arranged on the second side of the at least one device, which causes a height difference of, for example, more than 1 mm, more than 2 mm or more than 3 mm. The height difference may, for example, be less than 4 mm or less than 5 mm. This means that a device may be provided with no or comparatively little right/left asymmetry.

According to another embodiment, the at least one height element on the first side may adjust or set a different height than the at least one height element on the other side, preferably a height that differs by at least 0.5 mm, at least 1 mm or at least 1.5 mm. The difference in the set height may be less than 5 mm (millimeters), less than 4 mm, less than 3 mm or less than 2 mm.

According to one embodiment, the at least one height element may set a height that is at least twice as high or at least three times as high as a height of the at least one device above the at least one receiving region for the anterior element or for the canine element. Thus, the difference in height implemented/realized by the height element may be significant compared to other areas of the device in which height differences may be, for example, aesthetically and/or functionally undesirable or obstructive. The difference may be less than 10 times as high or less than 7 times as high.

According to one embodiment, the at least one height element may be free of detents (locking devices) which are designed to enter into a mechanical or magnetic coupling with a counter-detent (counter-locking device). Such detents could be used to push the lower jaw forwards or backwards relative to the upper jaw. In particular, recesses and/or protrusions that exceed the usual height of fissures may serve as detents. For example, protrusions and/or recesses on occlusal surfaces of the height element may only have heights of less than 1 mm in order to avoid locking.

Alternatively, the at least one height element may also have precisely such locking mechanisms.

According to one embodiment, the at least one height element may set a first height at a first tooth position and a second height at a second tooth position. The first height may be at least 0.25 mm or at least 0.5 mm or at least 1.0 mm greater than the second height. In this way, a height that decreases towards the front or towards the front or a height that increases towards the front or towards the front may be realized.

This may apply in particular if the height element extends over at least two receiving regions or over at least three receiving regions for molar elements and/or has a length in the range of at least 20 mm to 30 mm.

The change in height within the height element may be less than 3 mm or less than 2 mm. The change in height within the height element may take into account the anatomy of the lower jaw and/or the lower jaw (mandibular) joint.

Two regression lines or two regression planes may be used on occlusal surfaces, i.e. occlusal surfaces of the height element and surfaces facing away from these surfaces, on which occlusal surfaces of the teeth or other tooth elements may lie or which may face them.

A minimization of the sum of the distances or the error squares or other suitable mathematical measures may be used to determine the position of the straight lines or planes. In this context, the Gauss method of the smallest sum of squared errors is also used. Suitable mathematical measures other than error squares may also be used.

According to another embodiment, the height element may define a distance between the contact area and an occlusal surface of a tooth element covered by the height element. The distance may be in the range from 2 mm to 6 mm or in the range from 2.5 mm to 5 mm. The distance may be less than 8 mm or less than 6 mm.

The height element may be solid in its interior or have at least one cavity located between an occlusal surface of the tooth element and the contact area, e.g. a honeycomb-shaped or otherwise supported cavity. The cavity may be connected to the receiving region for the dental element, which may facilitate fabrication. However, the cavity may also be separated from the neighboring or adjacent receiving region, e.g. by a sealing step during manufacture.

The height element may be designed as an overlay and, for example, simulate dental fissures or have a different occlusal surface shape.

A height element may extend over at least one tooth element, e.g. over exactly one tooth element, over at least two tooth elements or over at least three tooth elements of a tooth arch (arch-shaped tooth element structure) or over corresponding receiving regions for such tooth elements.

There may be an asymmetry of a height element on the right side as seen from the patient compared to the left side in relation to the same jaw, e.g. only one height element (height greater than 1 mm, for example) on one side and no height element on the other side. In another embodiment, there may be height elements (height greater than 1 mm, for example) with different heights on the left and right. The difference in height may be more than 1 mm, for example.

Height elements may or at least one height element may be present only in the lower jaw (mandibular) device but not in the upper jaw (maxillary) device or only in the upper jaw (maxillary) device but not in the lower jaw (mandibular) device. On the other hand, height elements may also be present in the lower jaw device and the upper jaw device of a device.

According to another embodiment, the new chewing plane may deviate from the person's starting chewing plane or from the person's current chewing plane with regard to its position along an up-down direction and/or its position along a right-left direction. Thus, cumulatively or alternatively to the change in inclination, a shift in height may also be achieved. The chewing plane may thus be shifted in the direction in which it is medically required. The shifting of the chewing plane may be supported by an optional sliding function that promotes relearning, in particular neuromuscular relearning.

The position along an up-down direction may, for example, be changed by a value that is, for example, in the range of 0.5 mm to 3 mm or in the range of 1 mm to 3 mm.

The position along a right-left direction may be changed, for example, by a value in the range from 0.5 mm to 3 mm or in the range from 1 mm to 3 mm.

A rotation of teeth/tooth elements of a dental arch (arch-shaped tooth element structure) or both dental arches within the current chewing/masticatory plane, e.g. around a surface normal of the chewing/masticatory plane, may also be performed, e.g. in addition to or as an alternative to the other changes, i.e. e.g. with the position of the chewing/masticatory plane unchanged. The angle of rotation may, for example, be in the range from 1 degree to 5 degrees or in the range from 1 degree to 10 degrees.

In all these cases, relearning may be supported by the optional sliding function(s).

According to one embodiment, the at least one device or the at least one pair of devices may provide at least one further additional dental function, i.e. in addition to the setting function of the plane, e.g. in addition to a sliding function. The at least one device or the at least one pair of devices may differ from at least one other device or from at least one other pair of devices in the series due to the additional function itself, i.e. this additional function does not exist in the other device or the other pair of devices.

The differing/deviating function may be one of the following functions, for example: alignment function, shifting function, height function, ramp function. These functions may only be present in the device or devices with adjustment of the chewing plane, e.g. using a sliding contact surface, or in the other device or devices. The function for adjusting the plane, in particular the chewing plane, which may be made possible by the at least one contact area on the at least one height element, may, for example, only be present in some devices of the series and not in other devices.

These additional function(s) may shorten the treatment time because several functions may be carried out at the same time.

According to one embodiment, the at least one device or the at least one pair of devices may provide at least one further additional dental function, i.e. in addition to the adjustment function of the masticatory plane via the contact area on the at least one height element and/or a sliding function in a sliding contact plane. The at least one device or the at least one pair of devices may have the additional function in common with the at least one other device of the series or another pair of devices of the series in the same characteristic/configuration of functional elements for providing the function or in a different characteristic/configuration of functional elements for providing the function.

Functions with the same characteristics (value, strength) of functional elements for providing the function may be: a veneering element/tooth veneer/shape function, in particular with regard to the outer contour or a frontal contour or canine contour and/or a color function.

These additional function(s) may be used, for example, to ensure that the person gets to know a tooth target state or an intermediate tooth target state at a comparatively early stage. This may support habituation or training. Furthermore, corrections may be made at an early stage or the final restoration may be modified so that the person will be satisfied with the final restoration, e.g. with regard to a color and/or with regard to a tooth shape/tooth alignment or tooth element shape/tooth element alignment ultimately used.

Common functions that have a different characteristic (value, strength) of functional elements to provide the function may be: alignment function, shifting function, height function, ramp function.

These additional function(s) may shorten the treatment time because, for example, several functions may be carried out in parallel.

According to one embodiment, the arrangement may include an angle between the respective plane, e.g. sliding plane, and the respective chewing plane in a frontal plane. The angle between the respective plane, e.g. sliding plane, and the respective chewing plane in the frontal plane may change from one of the arrangements to an arrangement following this arrangement according to the order of the devices. Alternatively or additionally, the arrangement may include an angle between the respective plane, e.g. sliding plane, and the respective chewing plane in a sagittal plane. The angle between the respective plane, e.g. sliding plane, and the respective chewing plane in the sagittal plane may change from one of the arrangements to a subsequent arrangement according to the order of the devices.

This means that all tilting movements of the chewing planes may be performed, i.e. in particular tilting movements in one spatial direction or in two spatial directions that are orthogonal to each other, for example.

According to one embodiment, the jaw device of the at least one device may comprise an upper jaw device and a lower jaw device, wherein:
A flat first sliding surface area and a flat second sliding surface area may be present on the underside of the upper jaw device,
A planar third sliding surface region and a planar fourth sliding surface region may be present on the upper surface of the lower jaw device, and
the first sliding surface region and the fourth sliding surface region as well as the second sliding surface region and the third sliding surface region may slide against one another in the sliding plane when the at least one device is in the inserted state.

At least one, at least two, at least three or all four sliding surface areas may be formed on a respective height element.

The use of four flat sliding surface areas may enable a particularly precise alignment of the sliding plane, e.g. in the order of a tenth of a millimeter, i.e. 100 micrometers and smaller. Furthermore, the stick-slide effect or slick-stick effect may be used, for example, to facilitate relearning of the chewing plane, i.e. a kind of jerk-slide, which may considerably facilitate neuromuscular relearning, for example.

Furthermore, flat/planesliding surface areas may be more robust than smaller sliding contact elements, in particular more resistant to wear, which could lead to unwanted displacement of the chewing planes.

Compared to fissures, the flat sliding surface areas may be larger and, for example, also extend over several teeth or tooth elements, in particular over adjacent teeth or tooth elements.

According to one embodiment, the four sliding surface areas may have a surface with a lower mechanical frictional resistance than other surface areas of the device, e.g. to promote sliding.

According to one embodiment, the following features may be realized in the jaw device, e.g. in the upper jaw device and/or in the lower jaw device, of the first device or of the first pair of devices:
A lowest point of a right-hand receiving region for a right-hand tooth/tooth element may have a right-hand distance to the plane, e.g. to a sliding plane,
A lowest point of a left-hand receiving region for a left-hand tooth/tooth element to the plane, e.g. to a sliding plane, may have a left-hand distance,
whereby a first frontal difference may be given by subtracting the value of the right distance from the value of the left distance.

In the jaw device, e.g. in the upper jaw device and/or in the lower jaw device, of the second device or of the second pair of devices, the following features may be realized:
A lowest point of a right-hand receiving region for the right-hand tooth/tooth element may have a right-hand distance to the plane, e.g. to a sliding plane,
A lowest point of a left-hand receiving region for the left-hand tooth/tooth element to the plane, e.g. to a sliding plane, may have a left-hand distance,
whereby a second frontal difference may be given by subtracting the value of the right distance from the value of the left distance.

The value of the first frontal difference may differ from the value of the second frontal difference, in particular, for example, by at least 0.3 mm or at least 0.5 mm and/or by a value in the range from 0.3 mm to 2 mm.

The embodiment may refer either to the two upper jaw (maxillary devices) of the first device/device pair and the second device/device pair, or to the two lower jaw (mandibular) devices of the first device/device pair and the second device/device pair. In another embodiment, the aforementioned feature may be fulfilled for both the upper jaw devices and the lower jaw devices of both devices/device pairs.

The comparison may be based on absolute amounts (absolute value function), i.e. without the influence of the sign. Alternatively, the mathematical signs may be used.

The distances may be measured at the same tooth positions in the upper jaw device of the first pair of devices as in the upper jaw device of the second pair of devices.

The distances may be measured normal to the planes or sliding planes, i.e. in particular minimum distances. “Normal” here may mean lying in the direction of a normal vector to the plane/sliding plane, i.e. perpendicular to a tangential vector, for example.

The change in the chewing plane in a frontal plane may therefore be significant, i.e. differ from random fluctuations, for example. This applies all the more if the tendency to change the chewing/masticatory plane persists over several pairs of devices/devices.

According to one embodiment, the following may apply in the in the jaw device, e.g. upper jaw device and/or in the lower jaw device, the first device or the first pair of devices:
A lowest point of a first right-hand receiving region for a first right-hand tooth/tooth element may have a first right-hand distance to a plane, e.g. to one of the sliding planes, in particular the first sliding surface or fourth sliding surface, for example as seen from the person,
A lowest point of a second right receiving region for a second right tooth/tooth element may have a second right distance to the plane, e.g. to a sliding plane, e.g. as seen from the person,
whereby a first difference may be given by subtracting the value of the first right distance from the value of the second right distance.

In the jaw device, e.g. in the upper jaw device and/or in the lower jaw device, of the second device or of the second pair of devices, the following may apply:
A lowest point of a first right receiving region for the first right tooth/tooth element may have a first right distance to the plane, e.g. to a sliding plane, e.g. as seen from the person,
A lowest point of a second right receiving region for the second right tooth/tooth element may have a second right distance to the plane, e.g. to a sliding plane, e.g. as seen from the person,
whereby a second difference may be given by subtracting the value of the first right distance from the value of the second right distance.

The value of the first difference may differ from the value of the second difference, in particular, for example, by at least 0.3 mm or at least 0.5 mm and/or by a value in the range from 0.3 mm to 2 mm.

The comparison may be based on absolute amounts (absolute value function), i.e. without the influence of the sign. Alternatively, the mathematical signs may be taken into account.

The first right-hand tooth/tooth element and the second right-hand tooth/tooth element may be adjacent to each other. In another embodiment example, there is still one tooth/tooth element, or several teeth/tooth elements between the first right tooth/tooth element and the second right tooth/tooth element. This may apply to teeth/tooth elements in the upper jaw as well as in the lower jaw. Other/tooth elements or tooth element structures may also be present in place of the teeth.

This means that the change in the chewing plane on the right side may be significant, for example in a sagittal plane, i.e. it may differ from random fluctuations, for example. This applies all the more if the tendency of the change in the chewing plane persists over several pairs of devices.

According to one embodiment, the following may apply in the jaw device, e.g. in the upper jaw device and/or in the lower jaw device, of the first device or of the first pair of devices:
A lowest point of a first left receiving region for a first left tooth/tooth element may have a first left distance to the plane, e.g. to a sliding plane, e.g. as seen from the person,
A lowest point of a second left receiving region for a second left tooth/tooth element may have a second left distance to the plane, e.g. to a sliding plane, e.g. as seen from the person,
whereby a first difference may be given by subtracting the value of the first left distance from the value of the second left distance.

In the jaw device, e.g. in the upper jaw device and/or in the lower jaw device, of the second device or of the second pair of devices, the following may apply:
A lowest point of a first left receiving region for the first left tooth/tooth element may have a first left distance to the plane, e.g. to a sliding plane, e.g. as seen from the person,
A lowest point of a second left receiving region for the second left tooth/tooth element has a second left distance to the plane, e.g. to a sliding plane, e.g. as seen from the person,
whereby a second difference may be given by subtracting the value of the first left distance from the value of the second left distance.

The value of the first difference may differ from the value of the second difference, in particular, for example, by at least 0.3 mm or at least 0.5 mm and/or by a value in the range from 0.3 mm to 2 mm.

When comparing, reference may again be made to absolute amounts (absolute value function), i.e. without the influence of the sign. Alternatively, the mathematical signs may be used.

Thus, the change in the chewing plane on the left side may be significant, e.g. in a sagittal plane, i.e. differ from random fluctuations, for example. This applies all the more if the tendency of the change in the chewing plane persists over several pairs of devices.

The first left tooth/tooth element and the second left tooth/tooth element may be adjacent to each other. In another embodiment example, there is still one tooth/tooth element, or several teeth/tooth elements between the first left tooth/tooth element and the second left tooth/tooth element. This may apply to teeth/tooth elements in the upper jaw as well as in the lower jaw. Other/tooth elements or tooth element structures may also be present in place of the teeth.

The embodiment may concern either the two upper jaw devices of the first device and the second device or the first pair of devices and the second pair of devices, or the two lower jaw devices of the first device and the second device or the first pair of devices and the second pair of devices.

In one embodiment, however, the features mentioned may be fulfilled both for the upper jaw devices and for the lower jaw devices of both devices/device pairs.

A combination with the previous embodiment is also possible, i.e. changing the inclination in frontal section and changing the inclination in a sagittal/parasagittal section. This means that the chewing plane may be displaced in any desired direction.

According to one embodiment, the jaw device of the first device, e.g. the upper jaw device of the first device or of the first pair of devices or the lower jaw device of the first device or of the first pair of devices, may preferably carry at least one veneering element (first) or at least one tooth/dental veneer on its front side. The jaw device of the second device, e.g. the upper jaw device of the second device or of the second pair of devices or the lower jaw device of the second device or of the second pair of devices, may preferably carry at least one veneering element (second) or at least one tooth/dental veneer on its front side.

According to one embodiment, the at least one jaw device of a first device may carry a first veneering element on its outer side as partial region of the first device, in particular as partial region of the first jaw device.

According to one embodiment, the at least one jaw device of a second device may carry a second veneering element on its outer side as partial region of the second device, in particular as partial region of the second jaw device.

According to one embodiment, the at least one optional jaw device of a third device may carry a third veneering element on its outer side as partial region of the third device. The inclusion of the optional third jaw device may serve in particular to delimit “shaking movements” on the tooth elements.

All three veneering elements may be in the same position according to a tooth pattern/scheme. The veneering elements may also be referred to as tooth veneers.

In a first transverse cross-section, there may be a first outer contour and a first inner contour on the first veneering element, in particular a front-side outer contour and a front-side inner contour.

In a second transverse cross-section corresponding to the first transverse cross-section, there may be a second outer contour and a second inner contour on the second veneering element, in particular a front-side outer contour and a front-side inner contour.

Preferably, the following feature may also be optionally realized: In a third transverse cross-section corresponding to the first transverse cross-section, there may be a third outer contour and a third inner contour on or in the third veneering element, in particular a front-side outer contour and a front-side inner contour.

The relative position of the respective inner contour to the respective outer contour may change incrementally progressively from the first veneering element towards the second veneering element or via the second veneering element towards the third veneering element, in particular in order to enable or effect an offset of a tooth element in the relevant receiving region, in particular an offset in at least one or more of the following directions:
From front to back,
From the back to the front,
Axial rotation,
Laterally towards the neighboring tooth, i.e. to the left or to the right,
Possibly also an offset from top to bottom or an offset from bottom to top.

The change in the relative position or offset may be strictly monotonic, in particular strictly monotonically increasing or decreasing in one direction. Alternatively, there may also be a simple monotonic increase. Thus, in a series of successive devices, there may also be devices in which the relative position remains the same, e.g. because an offset is caused on other teeth.

Thus, there may be no further devices between the first device, the second device and the third device according to the sequence. On the other hand, there may also be further devices between the first device and the second device and/or between the second device and the third device according to the sequence.

The numbering of the devices may differ from the numbering according to a treatment plan, but does not have to. This means that the first device may be the first device according to the treatment plan. Alternatively, the first device may also be another device according to the treatment plan, e.g. the second device, the third device, etc. The other numbers according to claim then follow.

The first device according to claim may have a relative position A of inner contour and outer contour. The second device according to claim may have a relative position B of inner contour and outer contour. The third device according to claim may have a relative position C of inner contour and outer contour. Then, for example, the following sequence of layers may be realized: A, B, C or A, A, B, C, C or the like.

The transversal cross-section may, for example, have a target chewing plane as a reference or a plane that lies at a predetermined distance from the target chewing plane.

The relative position of the first inner contour to the first outer contour may differ from the relative position of the second inner contour to the second outer contour.

The displacement of the inner contour relative to the dental arch may be greater than the displacement of the outer contour relative to the dental arch. This means that the tooth may “wander” or move comparatively strongly and the tooth veneer, i.e. preferably its front side, may rest or only move comparatively slowly.

The inner contour may comprise pressure elements, i.e. functional elements for tooth displacement, in particular pressure elements that effect the displacement with at least one additional attachment on the tooth or tooth element or without attachments on the tooth or tooth element.

The change in the relative position of the inner contour to the outer contour may be reflected in a change in the wall thickness profile. For example, the wall thickness profile, in particular the front wall thickness profile, of the first veneering element may differ from the wall thickness profile of the second veneering element and the wall thickness profile, in particular the front wall thickness profile, of the third veneering element may differ both from the wall thickness profile of the second veneering element and from the wall thickness profile of the first veneering element, in particular due to a specific change in the relative position of the respective inner contour to the respective outer contour, e.g. in contrast to a deep-drawing processor thermoforming process using foils of uniform layer thickness, in which the inner contour and outer contour conform to each other and thus have an essentially constant position relative to each other.

The technical effect of changing the relative position of the inner contour and outer contour is that a degree of freedom is created that makes it possible to determine the position of the outer contour independently of the position of the inner contour. For example, the outer contour may be implemented, realized or aimed for early on in the series, while the inner contour “maps” the tooth elements or allows the tooth elements to be relocated.

A receiving region of the first veneering element may be designed differently and/or have a different position than a receiving region of the second veneering element. This difference may be suitable for effecting the incremental displacement of the tooth element. At the same time, a front-side wall thickness of the second veneering element may differ from a front-side wall thickness of the first veneering element, in particular when the tooth element is displaced from the front to the rear or from the rear to the front.

Thus, the wall thickness, in particular the front wall thickness, may generally decrease from the first veneer element towards the second veneer element and possibly also from the second veneer element towards the third veneer element when the tooth element is displaced from the rear to the front. The rear wall thickness may increase accordingly, for example, or remain unchanged.

Thus, the wall thickness, in particular the front wall thickness, may generally increase (along the entire course of the wall in the transverse cross-section) from the first veneer element towards the second veneer element and possibly also from the second veneer element towards the third veneer element when the tooth element is displaced from the front to the rear. The rear wall thickness may, for example, decrease accordingly or remain unchanged.

If a tooth element is displaced laterally, the front wall thickness may decrease in one section and increase in another section. However, the wall thickness to a neighboring tooth element may be reduced or increased overall or along the entire length of the wall, especially if the neighboring tooth element is not displaced at the same time. The same applies to rotating a tooth or lifting a tooth out of the upper jaw or lower jaw as well as to combined displacements, e.g. rotation and lifting out.

The first veneering element may be located at the same position according to a tooth pattern/scheme as the second veneering element. According to one embodiment, a receiving region formed in the first veneering element may be designed differently and/or have a different position than a receiving region formed in the second veneering element. Known tooth schemes are the quadrant scheme with four quadrants (e.g. upper right (seen from the patient), upper left, lower left and lower right) or a numbering of the teeth from left to right or from right to left in the upper jaw or lower jaw.

This difference in design and/or position may be suitable for causing the incremental displacement of the tooth element. A front-side wall thickness of the second veneering element may deviate from a front-side wall thickness of the first veneering element, for example due to this difference in design and/or position.

This series makes it possible, for example, to implement or approximate the position and/or shape of teeth or tooth elements in the devices after the final restoration at an early stage. If this position and/or shape may still change during treatment, reference may be made to provisional tooth/tooth element target states, for example. Other dental special features may also be taken into account.

The at least one first veneering element and the at least one second veneering element may substantially match in the position and/or the shape of their front-side outer contour.

The at least one tooth veneer of the first device/device pair may be located at the same tooth position as the tooth veneer/veneering element of the second device/device pair. The at least one tooth veneer/veneering element of the first device/device pair and the at least one tooth veneer of the second device/device pair may be adapted to or match the tooth located at this tooth position in a target tooth state or intermediate target tooth state or represent an enlargement of the target tooth state or intermediate target tooth state, e.g. an enlargement in the range of 1 percent to 10 percent. The magnification may be isotropic, i.e. uniform in all directions, or anisotropic.

The intermediate target or the intermediate target tooth state may result from intermediate targets of the treatment. For example, the intermediate target tooth state is only reached by the device under consideration in the sequence at least one device and several devices later.

The at least one first veneering element (toothed veneer) and the at least one second veneering element (toothed veneer) may substantially match in the position and/or the shape of their front-side outer contour.

The front-side outer contour may be adapted to the tooth element located at this tooth position in its target tooth state, as it is intended in a final restoration of the tooth element, e.g. with comparatively small associated tooth elements, such as teeth, tooth stumps, implants, etc. Alternatively, the front-side outer contour may be adapted to an intermediate target tooth state, e.g. of an intermediate target tooth arrangement.

The tooth element may be regarded as a remaining bite element. Several remaining bite elements may form a remaining bite structure. Together with the devices, the remaining bite structure and the device may result in a temporary bite structure, which is then converted into a permanent bite structure in the final dental restoration, which corresponds exactly to a target bite structure or has only comparatively small deviations, for example due to dental technical conditions.

The relocation/displacement of the dental element(s) may be part of a treatment plan. Only part of the dental/tooth elements may need to be relocated. Another part may already be in a suitable position so that no further relocation is required.

“Adapted” may mean to match. Alternatively, “adapted” may mean that there is a match with the target state as far as the dental conditions allow.

The enlargement may take place in at least one spatial dimension or spatial direction, e.g. anisotropic, in at least two spatial dimensions (e.g. spatial directions orthogonal to each other), e.g. anisotropic or in all three spatial dimensions/directions (isotropic). An isotropic enlargement may, for example, be a so-called blow-up, e.g. in the case of a canine or premolar that is much too small. On the other hand, an anisotropic enlargement may be, for example, an increase in width without another dimension being enlarged equally or at all. Preferred directions for enlargement may be labial, labial-lingual, buccal and buccal-lingual.

The target tooth state or the intermediate target tooth state may also be defined more broadly as relating not only to individual teeth, but to the entire dental arch. The dental arch in the device may already be an anticipation of the target tooth state or the intermediate target tooth state of the tooth or dental arch in the upper jaw and/or lower jaw, in particular of its outer contour and/or inner contour. The aim is often to enlarge the dental arch in the upper or lower jaw or both dental arches. The dental arch may comprise teeth or dental elements, i.e. it may be an arch-shaped dental element structure.

The front-side outer contour may represent an enlargement of the target tooth state in at least one dimension. According to another embodiment, the anterior tooth veneer of the first pair of devices and the anterior tooth veneer of the second pair of devices may represent the tooth located at this tooth position in a target tooth state or in an enlargement of the target tooth state. The magnification may be made by a value which may be, for example, in the range of 1 to 25 percent, preferably in the range of 5 to 15 percent, for example 10 percent. The magnification may be performed using a factor, e.g. a magnification factor in the range from 1.01 to 1.25. The target tooth state or its magnification may include the shape, color, position, alignment, etc. of the tooth in question, e.g. the anterior tooth, canine tooth, etc. in question. The tooth veneer and/or the magnification may increase and/or ensure the stability of the device and is therefore a technical feature in this respect.

Thus, in one embodiment, the veneer may be a mock-up or an anticipation of the target tooth state or an intermediate target tooth state. On the other hand, the veneer may also be designed according to other criteria, as already mentioned above.

The dental veneer/veneering element may veneer a corresponding tooth when inserted into the person's mouth. For example, the veneer may comprise a recess for the tooth in question, in particular a recess with an alignment function or without an alignment function, i.e. depending on a treatment plan defined for the person. Alternatively, the dental/tooth veneer may also only partially enclose an associated tooth, e.g. only be arranged on the front side but not on the back side of the tooth.

Tooth veneers/veneering elements may also be used to which no tooth has yet been assigned, e.g. because the corresponding tooth is missing. In this case, the veneer may assume a support/carrier function on soft tissue or on an implant. These functions are explained in more detail below.

The at least one tooth veneer/veneering element may reproduce the physical outer contour in the target state of the tooth or a slight enlargement of the outer contour or the outer geometry. This may create corresponding sensory impressions in the mouth of the wearer of the devices, i.e. the person, e.g. on the inside of the lips or on the inside of the cheeks. This means that the person only has to get used to the target tooth arrangement or the intermediate target tooth arrangement once, which increases the person's acceptance of the large number of devices. If the target tooth arrangement or the intermediate target tooth arrangement is perceived as uncomfortable or unsuitable by the person even after familiarization, the target tooth arrangement or intermediate target tooth arrangement may be corrected at an early stage, i.e. at the start of treatment or in the first third, for example. User acceptance may increase because the user may already see or feel what the result will be at the end of a long treatment at the beginning of the treatment.

The dentist and/or orthodontist and/or the person may recognize at any time from the position of the recesses in a device how far away the actual state of the teeth is from the target tooth state because, for example, distances from recesses to frontal target surfaces are reduced. The same may also apply to the intermediate target tooth state or the intermediate target tooth arrangement. The dentist or orthodontist may see how close the actual state is to the target tooth position by comparing the actual state of the teeth with the target tooth state represented by the dental veneer, particularly on the front surface of the dental veneer.

The outer surface of the tooth veneer may be designed like the outer surface of the target arrangement or only slightly different, e.g. also due to the enlargement to be taken into account and/or within the scope of the manufacturing tolerances and/or deviations of, for example, less than 1 mm or less than 0.5 mm. If the tooth in question has reached its final position and is not to be changed by superstructures/abutments or attachments in a final treatment, a very thin tooth veneer may be used. Openings in the tooth veneer may also be used to no longer veneer tooth surfaces that have reached their final position, but to arrange them so that they are visible from the front.

The devices may comprise pairs of devices. Alternatively, several separate devices may be used for a lower jaw or for an upper jaw, for example a left device and a right device. In this case, the dental veneer may be arranged in the canine region, for example.

In particular, the following veneers or anterior replicas are available:
A first upper anterior veneer or anterior tooth replica (tooth body that is not rooted in the jaw), e.g. of the upper left anterior tooth, e.g. as seen from the person, and/or
A first lower anterior veneer or anterior tooth replica (tooth body that is not rooted in the jaw), e.g. of the lower left anterior tooth, e.g. as seen from the person, and/or
A second upper anterior veneer or anterior tooth replica (tooth body that is not rooted in the jaw), e.g. of the upper right anterior tooth, e.g. seen from the person, and/or
A lower anterior veneer or anterior tooth replica (tooth body that is not rooted in the jaw), e.g. of the lower left anterior tooth, e.g. viewed from the person.

The front side of the at least one dental veneer/veneering element may have the same position in all devices of the series or in at least half of the devices or pairs of devices of the series with respect to a cranial (skull) and/or facial (face) feature of the person, in particular a facial feature defined by a cranial feature, i.e. in particular a feature that has been used to determine the target arrangement.

According to a further embodiment, when changing the pairs of devices in the mouth of the person, the at least one dental veneer/veneering element of the second device or of the second pair of devices may be located at the same position in the mouth at which the at least one dental veneer/veneering element of the first device or of the first pair of devices was located.

A third device/device pair of the series may be located in the sequence after the second device/device pair. The third device/device pair may also include at least one tooth veneer/veneering element, which is designed like the at least one tooth veneer/veneering element on the first device/device pair and/or like the at least one tooth veneer/veneering element on the second device/device pair.

The order of the devices may be predetermined by a treatment plan, in particular a digital treatment plan stored on a computer. At the end of the treatment, for example, only one device may be used instead of a pair of devices.

The tooth veneer/veneering element may cover a tooth or a tooth element behind it and/or may preferably have a color and/or shape of a tooth, i.e. the tooth veneer/veneering element may consist of non-transparent material or comprise a non-transparent material layer, e.g. of yellowish or whitish material.

In particular, the dental veneer/veneering element may be made of a material other than a thermoforming sheet. I.e. from a material that has areas of different layer thicknesses, e.g. with thickness differences of more than 1 mm or more than 2 mm. In contrast, a device or a dental veneer/veneering element made from a thermoforming sheet has essentially the same layer thickness. Subtractive processes, e.g. milling, or additive processes may be used as an alternative manufacturing process to deep drawing.

According to one embodiment, the first device or the first pair of devices and/or the second device or the second pair of devices or at least one further device or a further pair of devices of the series may comprise functional elements which perform an alignment function or alignment functions of teeth/tooth elements or on teeth/tooth elements and/or which perform a shifting function of teeth/tooth elements or on teeth/tooth elements in relation to at least one dental arch (arch-shaped tooth element structure) of the person in order to bring the at least one dental arch of the person into a new constellation, e.g. in order to widen it.

The new constellation may in particular be a widening of the dental arch (arch-shaped tooth element structure) in the upper jaw and/or in the lower jaw, for example to create space for the reconstruction of the teeth or for dental implants.

In particular, in cooperation with the aforementioned tooth veneer/veneering function, the at least one tooth veneer or the veneering element may cause alignment functions of teeth and shifting functions to be applied to the teeth of the person in an region concealed from the front in relation to at least one dental arch of the person, in order to bring the at least one dental arch of the person into a new constellation, while the position of the at least one tooth veneer or the veneering element visible from the front remains the same or changes only insignificantly, preferably in the course of the entire series or in a partial area of the series comprising at least 20 percent of the devices of the series.

According to one embodiment, at least one subset of the devices or the pairs of devices may be designed in such a way that in the molar (tooth) region of the person a height superstructure (build-up) is first carried out by means of a height function that uses the height element, for example. The height superstructure (build-up) may be suitable for increasing the distance of the lower jaw from the upper jaw in the contact bite and thereby lead to an unblocking of previously blocked tooth displacements. Additionally or alternatively, the chewing plane may be displaced or changed by the height function. At least one further subset of the devices/device pairs may be configured such that this unblocking achieved by the height functions is followed by a tooth displacement of the person's teeth by alignment functions as part of the subsequent devices/device pairs and/or a change in the person's dental arch by shifting functions as an additional part of the subsequent devices/device pairs.

The first device or the first pair of devices and/or the second device or the second pair of devices may belong to the devices/pairs of devices that perform a height superstructure (build-up) by means of the height function, which is extended, for example, by the function for setting the chewing plane or corresponds to this function and/or may be supplemented by a sliding function. Thus, according to one embodiment, a height build-up may take place first, whereby familiarization and/or training for preferably neuromuscular relearning of the chewing plane may take place. Only then may devices with an alignment function be used in the previously blocked region. In one embodiment, blockages may be released in at least one region, whereby alignment functions and/or shifting functions are already carried out in at least one other region, in particular in an unblocked region./

According to one embodiment, a roughness depth Rz (roughness, roughness number) on the at least one contact, preferably when forming a sliding area or sliding surface area, may be less than 5 micrometers or the average roughness value Ra on the at least one contact/sliding area region may be less than 1.5 micrometers or less than 1.3 micrometers.

The so-called average roughness depth (also ten-point height), formerly represented by the symbol Rz (up to DIN (German industrial standard) EN (European standard) ISO (International Organization for Standardization) 4287:1984), is no longer valid as an ISO characteristic value (from DIN EN ISO 4287:1997).

However, the average roughness depth Rz may still be output by older measuring devices and may be determined as follows:
A defined measuring section on the surface of the workpiece is divided into seven individual measuring sections, whereby the middle five measuring sections are of equal size. The evaluation is only carried out over these five measuring sections, as the Gaussian filter to be applied requires half an individual measuring section before or after or a convolution has a run-in and run-out behavior that cannot be neglected.
The difference between the maximum and minimum value is determined for each of these individual measuring sections of the profile.
The mean value is calculated from the five individual roughness depths thus obtained.

The average roughness value Ra, on the other hand, may be calculated as follows according to DIN EN ISO 4287:2010:

$${R}_{a} = \frac{1}{M N} {\sum }_{m = 1}^{M} {\sum }_{n = 1}^{N} \vert z ( {x}_{m} , {y}_{n} ) - 〈 z 〉 \vert$$

Wherein the mean value (z) may be calculated as follows:

$$〈 z 〉 = \frac{1}{M N} {\sum }_{m = 1}^{M} {\sum }_{n = 1}^{N} z ( {x}_{m} , {y}_{n} )$$

The average roughness depth Rz may be converted into a mean roughness value, e.g. 5 micrometers Rz may correspond to a mean roughness value Ra in the range of 1.3 micrometers to 0.25 micrometers, whereby a mean estimated value may be 0.812 micrometers, see e.g. https://www.facturee.de/online-tools/rz-ra-rechner/. This corresponds to roughness class N equal to 7, which may be achieved by finishing, for example. Roughness classes smaller than 8 or smaller than 7 may therefore be used.

According to one embodiment, at least a subset of the devices or pairs of devices or all of the devices or pairs of devices may homogeneously comprise a single material. This may enable simple production, which is particularly cost-effective.

According to one embodiment, in particular according to an alternative embodiment, at least a subset of the devices or pairs of devices or all of the devices or pairs of devices may comprise at least two different materials, preferably a first material in an outer region and a second material in an inner region enclosed by the outer region. The first material may have a greater hardness than the second material. Alternatively, the second material may have a greater hardness than the first material.

If the harder material is used for the outer region (first material), abrasion may be reduced, for example, and the wearing comfort may be increased by the inner material.

The materials that may be used include plastics that are not harmful to health, e.g. synthetic resins such as acrylic resin, epoxy resin or vinyl ester resin, polyurethane PU, PMMA (poly(methyl methacrylate)), multilayer PMMA, etc.

According to another embodiment, the device/device pair or those devices or device pairs which effect a change in the position of the chewing plane, in particular the inclination of the chewing plane, and/or which enable or facilitate a preferably neuromuscular relearning of the chewing plane, may be designed in such a way that a sideways movement and/or forward-backward movement of the modules relative to each other and relative to the teeth or other tooth element structures is possible. Additional degrees of freedom in the relative movement may accelerate relearning. Combined movements consisting of a sideways movement and a forward-backward movement may also be helpful, i.e. diagonal movements or circular movements, for example. Other directions of relative movement are, for example, front-back, right-left or a combination of front-back and right-left.

The receiving regions may be dimensioned in such a way that a lateral marginal gap is formed, preferably an edge gap running laterally around at least one tooth or around at least one tooth element. Preferably, an occlusal marginal gap may also be formed, possibly only interrupted by small contact surfaces compared to the occlusal edge gap, e.g. punctiform contact surfaces, which may be adapted to the tooth profile. The lateral edge gap or the occlusal edge gap may have a width in the range of, for example, 0.3 mm to 1.4 mm or in the range of 0.4 mm to 1.4 mm. The lateral edge gap or the occlusal edge gap may be larger than 0.3 mm. The upper limit for the lateral edge gap or the occlusal edge gap may be less than 3 mm, less than 2 mm or less than 1.75 mm.

The biomechanical and neurophysiological effect, or the improved effect, of the pairs of devices that may be used as training devices may also occur with a restricted transversal range of movement of teeth or tooth elements in the optional edge gap, because the training effect may build on the mobility that exists in the equilibrium position, which is provided, for example, by the edge gap. However, good to very good training results may also be achieved without an edge gap. Training may take place consciously or unconsciously, for example when chewing or by chewing while eating a meal.

If no edge gap is used, it may be easier to apply alignment functions at the same time.

Training or familiarization with the new chewing plane may take place without additional exercises. In another embodiment, the training may involve the active conscious participation of the person, for example in the form of exercises that train, for example, conscious biting and release of the chewing/masticatory muscles. The release may take place as soon as the sliding begins, e.g. as soon as the upper jaw device or the lower jaw device moves relative to the teeth in the edge gap. Alternatively, as already mentioned, training may also take place without a edge gap. In this case, sliding may occur due to the sliding function. Training may also take place without a sliding plane and sliding movements.

The two modules/devices of a pair of devices may be designed in such a way that they lie against each other in the area of a separating sliding plane, in particular in an inserted state but possibly also outside the oral cavity if they are placed on top of each other accordingly. In particular, the modules/devices of a pair of devices may lie against each other in such a way that lateral movement of the modules relative to each other and/or relative to the teeth is possible or permitted.

Thus, a lateral movement of the modules/devices relative to the teeth/tooth element structure(s) may be possible, in particular without the teeth or the dental fissures preventing this lateral movement. However, both the sliding and possibly also the edge gap are optional, as an adjustment or displacement of the chewing plane, in particular the inclination of the chewing plane, may also be carried out without sliding and/or marginal gap.

Another aspect of the invention relates to a method for designing dental devices, in particular for designing or designing and manufacturing a series according to one of the above embodiments, comprising:
Recording/Capturing up a starting tooth arrangement of the teeth or tooth elements or a tooth element structure of a person in their upper jaw and/or of the teeth or the tooth element structure of the person in their lower jaw,
Determining at least one reference structure of the person before, during or after the recording,
Determining a target tooth arrangement of the teeth/tooth elements or the tooth element structure of the person's upper jaw with respect to the person's upper jaw or a target upper jaw involving reference structure, and/or
Determining a target tooth arrangement of the teeth/tooth elements or the tooth element structure of the person's lower jaw with respect to the person's lower jaw or a target lower jaw, considering the reference structure,
Based on the start tooth arrangement and the at least one target tooth arrangement or an intermediate tooth arrangement, providing digital data following one another in a sequence, for example each with a data set for the teeth/tooth elements or for the tooth element structure of the upper jaw and/or a data set for the teeth/tooth elements or for the tooth element structure of the lower jaw,
Designing, based on the digital data, a series of devices, in particular for assisting in the displacement of the chewing plane of a person, comprising at least two devices, at least five devices, at least 10 devices, etc.

The devices may each include at least one jaw device. The at least one jaw device may comprise an upper jaw device and/or a lower jaw device. The devices may be designed to be worn by the person according to the predetermined sequence.

In at least one device, the at least one jaw device may comprise at least one height element on a first side. At least two contact areas may be formed on the at least one height element at mutually different positions of molar elements. At least one further contact area may be formed on a second side of the at least one jaw device.

In one embodiment, the at least three contact areas may define the plane. The plane may deviate from a starting chewing plane of the person or from a current chewing plane of the person with regard to its inclination in a frontal section or sagittal section, which is changed by the at least one height element, and/or with regard to its height position, which is changed by the at least one height element.

In one embodiment, in at least one other device of the series, a different inclination in a frontal section or sagittal section and/or a different height position of the respective plane may be set by at least one further height element, which may differ from the at least one height element in the set height.

In one embodiment, the at least one device or the at least one pair of devices may provide at least one further additional dental function, which is also provided by at least one other pair of devices in the series in the same way or in a different way. Here too, reference is made to the technical effects explained in detail above.

In one embodiment, the method may also include at least one of the following steps:
Determination of force vectors required to displace the teeth, e.g. using FEM (Finite Element Method) or FDM (Finite Difference Method) or other suitable methods, which may be computer-based,
Based on the force vectors determining the shape of recesses and/or force-transmitting elements (attachments and/or protrusions and/or active surfaces in recesses) in devices of a series comprising at least two pairs of devices.

The devices relevant to the method may also be constructed like the above-mentioned devices, i.e. each may comprise, for example, an upper jaw device and a lower jaw device. Taking into account the force vectors, the device pairs of the devices may be designed in such a way that they successively effect an incremental change in the position of the person's teeth in accordance with a sequence of the device pairs.

There may be at least 10, at least 20 or at least 30 devices in the series. There may be less than 100 devices in the series. The exact number of devices may be specified in a treatment plan, in particular in a digital treatment plan, and may depend, for example, on whether or not attachments are used or what pressure on their teeth/tooth structure the person concerned still finds acceptable.

The digital data may comprise data records or be stored and/or structured in another suitable way. For example, a database may be used, in particular a relational database. Alternatively, the data may be structured in another suitable way.

According to one embodiment, in at least two devices or pairs of devices, the upper jaw device and/or the lower jaw device may each comprise the at least one contact region on a height element, for example at least one sliding contact region in each case. In a first device or in a first device pair of the at least two devices/device pairs, first receiving regions for teeth or for a tooth element structure of the upper jaw or of the lower jaw may be arranged relative to a first plane/sliding plane of the first device or of the first device pair according to a first arrangement. In a second device or in a second pair of devices of the at least two devices or pairs of devices, second receiving regions for the teeth or for the tooth element structure of the upper jaw or of the lower jaw may be arranged relative to a second plane/sliding plane of the second device or of the second pair of devices according to a second arrangement which differs from the first arrangement.

The second arrangement, which differs from the first arrangement, may enable a relearning of the position of the chewing plane of the person, in particular the inclination of the plane/chewing plane, from a plane/chewing plane associated with the first arrangement to a plane/chewing plane associated with the second arrangement, preferably a neuromuscular relearning.

Alternatively or additionally, the height of the plane/chewing plane may also be changed, e.g. its distance to the upper jaw, e.g. this distance may be reduced or increased.

If necessary, a transversal displacement of the plane/chewing plane in the current plane/chewing plane, e.g. from back to front, from front to back, rotation, from left to right or from right to left, etc. may also be performed or enabled.

The receiving regions may have lateral walls that may be arranged laterally of teeth or tooth elements. Functional elements may be arranged on the lateral walls, which press laterally on the teeth/tooth elements or otherwise exert force on teeth/tooth elements.

Suitable methods may be used to provide the data, e.g:
Collision detection using OBB (Oriented Bounding Box) trees/graphs (Trees), and/or
Visualization of three-dimensional structures using Voroni diagrams.

The capturing/recording of the starting tooth arrangement of the teeth/tooth element structure in the jaw may also include capturing a bone image of a patient's head or skull, wherein the image may also show the location of the lower jaw in a lower jaw starting position, the upper jaw in an upper jaw starting position, and the teeth/tooth element structure of the upper jaw and the teeth/tooth element structure of the lower jaw in a starting tooth position.

Determining the reference structure may include determining at least one reference plane involving at least one cranial structure/structural feature of the bone structure of the person's (patient's) head or a structural feature of the person's face, the facial feature preferably being closely associated with a cranial structure.

Consideration of the cranial feature may be a prerequisite for long-term treatment success. The cranial structure may in particular be a structure outside the upper jaw and/or in particular also outside the person's lower jaw. The cranial structure may be:
related to a feature of the skull and/or head, e.g. the temples, the ears, the inner ear regions, the eye sockets, the zygomatic bones, etc.
be suitable for defining a sagittal plane, e.g. a medial sagittal plane through the skull, in particular at the halfway point between paired features, i.e. e.g. exactly between the determined inner ear regions or between other above-mentioned features or other suitable features, etc.
be suitable for defining an essentially transverse plane, e.g. a target chewing plane, see e.g. EP 3 332 731 A1 (“CranioPlan” (may be a registered trademark)), which is hereby incorporated by reference for all legal purposes.

The reference structure may alternatively include, for example, the Cartesian reference plane system proposed in WO 2020/141134 (3D structure marking or 3D ruler) for defining the separation slip plane of a training device, but which may also be used for other purposes, e.g. for the proposed method. Document WO 2020/141134 A1 is hereby incorporated by reference into the present text for all legal purposes.

If, for example, the sagittal plane or only one axis transverse to it is known, the planes orthogonal to it may be defined, e.g. at least one frontal plane or a frontal plane package and/or at least one transverse plane or a transverse plane package.

According to one embodiment (CranioPlan—may be trademarked or otherwise protected), the determination of the reference structure may comprise:
i) Determining an inner ear axis, preferably using digital 3D image data,
ii) Determining the position of at least one eye,
iii) Determining at least one skull plane comprising the inner ear axis and the position of at least one eye,
iv) Using the cranial plane as an auxiliary plane or for the calculation of an auxiliary plane, e.g. by determining the mean value of two planes, each comprising one eye position,
v) Using the auxiliary plane to set the chewing plane by:
A1) Determining an axis of rotation which is parallel to the inner ear axis and which lies on the other side of the inner ear axis compared to the eye axis,
A2) Using the rotation axis to rotate the auxiliary plane downward by a predetermined angle, e.g. by an angle in the range of 11 degrees to 17 degrees or in the range of 13 degrees to 15 degrees, so as to obtain the target chewing plane or a plane parallel to the target chewing plane, or
B1) Rotation of the auxiliary plane around the inner ear axis to obtain a second auxiliary plane, and
B2) Shifting (Translation) of the second auxiliary level downwards.

Step B2) may be performed to obtain the target chewing plane or a plane parallel to the target chewing plane,

In step B2) the auxiliary plane may be shifted, for example, by a distance by which the shifted second auxiliary plane would correspond to the target chewing plane obtained according to alternative A.

The exact angle of rotation may be determined, for example, with the help of a sphere that is digitally fitted into the digital data describing the foramen magnum, i.e. a large oval opening of the occipital bone of the skull, i.e. the back of the head.

The position of the axis of rotation may be determined, for example, by:
Determine a first center point of the inner ear axis between the two inner ear points,
Determine a second center point of the eye axis between the two eye points,
Determine the distance between the first center point and the second center point,
Determine a straight line connecting the first center point and the second center point,
Extending the connecting line to the rear by a distance that has a length that is approximately the length of the determined distance increased by a factor of 2 in order to obtain the point through which the axis of rotation runs, e.g. a factor in the range from 1.5 to 2.5 or in the range from 1.75 to 2.25 or in the range from 1.9 to 2.1, e.g. 2, i.e. the original length of the distance between the two centers is tripled, for example.

Deviating from planes, the so-called Spee's curve of the occlusal surfaces of the teeth may still be determined and/or taken into account in the method referred to below as “CranioPlan” (may be a registered trademark). In this case, for example, there are deviations in the position of teeth in the middle of the right jaw bone (upper jaw or lower jaw) or in the middle of the left jaw bone (upper jaw or lower jaw) where the respective teeth may be arranged below the chewing plane.

The “CranioPlan” method (may be a registered trademark) or the Hornung method is described in more detail in EP 3 332 731 A1. This document is hereby incorporated by reference for all legal purposes.

According to another method, facial features may be used, in particular facial features that correspond to the aforementioned bony features of the facial skull. As a result, radiation exposure from X-rays may be reduced or avoided altogether.

The procedure called “CranioPlan” (may be a registered trademark) may be performed manually, semi-automatically or automatically, in particular computer-assisted.

According to another embodiment (3D structure marker/3D marker/3D ruler), in particular an alternative embodiment, the determining of the reference structure may comprise:
3D imaging and generation of digital data,
manual identification or automatic identification of anatomical landmarks using the digital data,
Definition of a transversal direction using the identified anatomical landmarks, which also defines the direction of a sagittal plane Sm,
Determine the center point between the anatomical landmarks,
Use a digital 3D structure marker that comprises at least three plane packages:
1) A transversal plane package that comprises several transversal planes parallel to each other,
2) A frontal plane package comprising several frontal planes to each other, and
3) At least one sagittal plane package comprising several sagittal planes parallel to each other,
Insertion of the 3D structure marker into the 3D image space to which the digital data refers,
Aligning the 3D structure marker with the determined center point while defining a medial sagittal plane Sm. Or wherein a sagittal plane is first placed at the determined center point and then a central plane of the at least one sagittal plane package is aligned in a separate step with the previously placed sagittal plane, e.g. congruently.
Translation of the 3D structure marker to a first anchor point, which is preferably located in the median sagittal plane Sm.
Rotation of the 3D structure marker using a second anchor point, up to which it is rotated, for example.
Scaling of the 3D structure marking using a third anchor point, in particular isotropic scaling,
Determining the ideal chewing plane using the 3D structure marking.

The following describes a preferred method for first determining the transverse direction using anatomical landmarks (part A) and then performing the further fitting steps (part B). The user may either create an axis in an image plane on an anatomical landmark, such as zygomatic arches, orbits or inner ear regions, or a plane that is perpendicular to the image plane, as this plane appears as a line in the sectional image.

### Part A:

1) 3D imaging: The first step may be to generate a 3D image of a body part, e.g. a patient's head.
2) Generation of digital data: By processing the images, a digital or virtual 3D body may be generated in a second step. Steps 1 and 2 may also be carried out in one step.
3) Visualization: In a third step, sectional images of this 3D body may be displayed.
4) Identification of anatomical landmarks: In a fourth step, landmarks of bony structures may be identified in appropriately selected sectional images.
5) Definition of the transversal direction: In a fifth step, at least one transversal direction may be defined that connects, for example, two symmetrical landmarks. This may be done by an axis or by a plane and a second plane crossed to it.
6) Definition of the direction of the sagittal plane: In a sixth step, the position of the mean sagittal plane Sm may be defined, whose orthogonal normal is the transversal axis or is parallel to it.
7) Determine the center point: In a seventh step, the center between appropriate landmarks may be determined to accurately define the median sagittal plane Sm of the upper cranium. This may not be completely unambiguous or offer certain degrees of freedom because the skull in the posterior region may often have an orientation that is up to 2 degrees different from the anterior upper cranium. This is where averaging methods or pragmatic solutions based on previous experience may be used.
8) Determining the position of the median (middle) sagittal plane Sm: In an eighth step, the median sagittal plane Sm may be determined by the center determined in the seventh step and the orthogonality resulting from the already determined transversal direction.
9) Check other views: In an optional ninth step or a number of such steps, other sectional views may be taken to check positions and directions or to complete other tasks and questions.

The order of the steps in part A may be changed as long as the result is that the orientation of the sagittal plane is defined using the anatomical landmarks.

The following 3D (three-dimensional) structure marker (marker or ruler for short) may be used for part B, which may comprise at least three level packages:
1) A set of planes comprising several transversal planes parallel to each other,
2) A set of planes comprising several frontal planes parallel to each other, and
3) At least one plane package comprising several sagittal planes parallel to each other, e.g. a left sagittal plane package and a right sagittal plane package.

The well-known Fibonacci sequence or Fibonacci series is: 3, 5, 8, 13, 21 etc., i.e. the next member of the series is the sum of the two previous members. This sequence may be used to define the spacing of the respective planes in the three plane packets, for example by setting the first two planes at a distance of, for example, 3 mm from each other, the second plane and the third plane at a distance of, for example, 5 mm, the third plane and the fourth plane at a distance of, for example, 8 mm, and so on. Alternatively, the layer spacing may also be selected in a different way, e.g. equal spacing between adjacent layers. Using the scaling mentioned above, the distances may then be scaled in the same way, e.g. enlarged.

The 3D structure marker may also be used directly to determine the central sagittal plane or a plane parallel to it.

### Part B:

1) Adding the 3D marker: In a first step, the 3D structure marker may be added to the 3D image space and/or faded in so that it may be seen in the display. The layer packages may now appear as parallel lines.
2) Aligning the 3D marker to the medial sagittal plane Sm: In a second step, the structure marker may be aligned with its inner sagittal plane structure perpendicular to the transverse axis of the bony structures.
3) Translation of the 3D marker: In an independent third step, the 3D structural marker may be placed on an anchor point in the median sagittal plane, for example in one embodiment with the crossing point of the lines or planes T3 (third transverse plane) and F5 (fifth frontal plane) in the median sagittal plane Sm on the basion point BP of the foramen magnum.
4) Rotation of the 3D marker: In a fourth step, the 3D structural marker may be oriented by rotation around an axis parallel to the transversal axis so that the transversal planes in the sagittal section run in the direction of a connecting line that follows, for example, the direction of the BP-GP axis (palatal point). In the embodiment example, the rotation may take place around a fixed point on which the intersection point T3 and F5 lies. The rotation brings the line T3 into such a position that it runs through the two anchor points, e.g. basion point BP and palatal point (GP). This aligns the 3D structure marker at an angle.
5) Scaling the 3D marker: In a fifth step, the size of the 3D structure marker may be adjusted by linear scaling of the marker or the 3D structure marker so that a frontal line runs through a suitably selected third anchor point. In an embodiment example, this may be the nose point NP (nasion point). The individually correct scaling size is achieved in the embodiment example when the frontal line F1 and thus the frontal plane runs through the nose point or nasion point NP.
6) Analysis of symmetry: In a subsequent optional sixth step, the symmetry and harmony of the proportions in the body part may now be analyzed. This may often reveal tilting or tilting displacements, e.g. of the jaw and the current chewing plane.
7) Determining the ideal chewing plane: In a further seventh step, the first transversal plane, which is called T1, for example, may be used as an idealized occlusal plane or idealized chewing plane, e.g. to align dentures or devices accordingly. The first transversal plane may run through the incisal point IP, i.e. the point of contact of the cutting edges of the two lower central incisors, which may be achieved in particular by using the Fibonacci sequence.

The sequence of steps in part B may be changed.

In a part C following the determination of the idealized chewing/masticatory plane, the following procedure may be used to produce a training device or several training devices in a series of devices, regardless of the method used to determine the masticatory plane, e.g. CranioPlan (may be a registered trademark) or 3D structure marking according to Saxler/Hornung:
In an eighth step following the seventh step of the procedure, the space for the teeth and/or dental implants of the upper and lower dental arches may be created in the digital data space so that the device later fits precisely on the individual dental arches without jamming or damaging the gums. Subtraction operations may be used, in particular Boolean operations. A edge gap, if used, may also be taken into account.
In an optional eighth step, the digital completion of the digital shape defined in the eighth step may result in a planned form fit only at certain support points or, for example, small support surfaces between the device and the dental arch compared to dental fissures for an exact definition of the position of the device with its two parts in the mouth. Alternatively, no edge gap is used and larger contact surfaces may be used.
In a subsequent ninth step, the device may be manufactured in its parts and for precisely this individual case and may then be used for this patient.

The method using the 3D structure marking (3D marker or 3D ruler) according to Saxler and Hornung is described in WO 2020/141134 A1, whereby no series of devices is mentioned there, in particular no series of aligners or devices with alignment functions. This document is hereby incorporated by reference for all legal purposes.

Another method may use facial features, in particular facial features that correspond to the aforementioned bony features of the facial skull. This may reduce or eliminate radiation exposure from X-rays.

The process using the 3D structure marking (marker/ruler) may be carried out manually, semi-automatically or automatically, in particular computer-aided.

The determined chewing/masticatory plane may be the same for both methods (CranioPlan (may be a registered trademark), 3D Marker/Ruler), but does not have to be. With both methods, three spatial angles of the normal of the masticatory plane to three coordinate axes of a Cartesian coordinate system and three position coordinates with respect to the three coordinate axes may be taken into account, i.e. a total of 6 parameters.

Deviating from planes, the so-called Spee curve of the occlusal surfaces of the teeth may still be determined and/or taken into account in the “3D Marker/Ruler” method mentioned above. In this case, for example, there are deviations in the position of teeth in the middle of the right jaw bone (upper jaw or lower jaw) or in the middle of the left jawbone (upper jaw or lower jaw) where the respective teeth may be arranged below the chewing plane.

In other embodiments, the chewing plane may be determined using a different method compared to the “CranioPlan” method (may be a registered trademark) according to Hornung (EP 3 332 731 A1) or according to Saxler, Hornung (3D structure marking, 3D marker, 3D ruler, WO 2020/141134 A1).

Alternatively, other suitable methods may be used to determine the target occlusal plane.

According to one embodiment, after wearing the last device or the last pair of devices according to a treatment plan, a final restoration of the person's teeth and/or tooth stumps may be performed. The final restoration may create a permanent chewing surface that may match a planned chewing surface.

According to a further aspect, a manufacturing method is disclosed, in particular for manufacturing a series according to one of the above-mentioned embodiments or based on the devices of the series designed according to one of the above-mentioned methods. In the manufacturing method, a subtractive manufacturing process may be used for manufacturing the series of devices or pairs of devices or at least for manufacturing a part of the devices, preferably a machining process, in particular milling.

Alternatively, an additive manufacturing process may be used to produce the series of devices or pairs of devices or at least to produce part of the devices, in particular 3D printing (three-dimensional printing).

The method of manufacture may concern individually designed devices for insertion into the mouth, in particular of a person. The devices may comprise or include at least one upper jaw module and/or at least one lower jaw module. A digital 3D model of the device may be positioned as a blank with its orthogonal axes in a 3D model of the head with its orthogonal axes in such a way that the axes of the device (blank) are parallel to the axes of the head. The axes of the head may be determined primarily on the basis of landmarks in the area of the facial skull or an inner region of the skull. Positioning may result in the position of the indentations that are created for the teeth of the dental arches of the upper jaw and the lower jaw in the blank in the 3D digital model, e.g. in particular by subtraction or other subtraction of digital shapes, in order to then additively or subtractively produce the modules with these indentations using manufacturing technology.

The device(s) may be designed in one country (first country) and manufactured in the same country or in another country (second country). The device(s) may be worn or used in the first country, the second country or a third country. At least the first part of the series may be manufactured quickly in the same country in which the associated devices are also used, e.g. to avoid long and/or time-consuming transportation routes. Another part of the same series may be manufactured in a different country, as it is only needed later, so that longer transportation routes become less important and reduced manufacturing costs may be decisive for the production location.

Another aspect relates to a computer system comprising:
at least one memory unit configured to store instructions of a program, and
a control unit adapted to execute instructions of the program that cause the computer to execute at least part of a method described above, in particular the steps related to the design of the devices of the series. Thus, the above-mentioned technical effects may also apply to the computer system.

A further aspect relates to a computer program comprising machine-readable instructions which, when executed by a control unit, cause the control unit to execute at least part of the method according to one of the aspects or embodiments explained above. Thus, the above-mentioned technical effects may also apply to the computer program.

A further aspect relates to a computer program product comprising machine-readable instructions which, when executed by a control unit, cause the control unit to execute at least part of the method according to one of the aspects or embodiments explained above. Thus, the above-mentioned technical effects may also apply to the computer program product.

A further aspect relates to digital data generated by a method according to one of the above-described aspects or according to one of the above-described embodiments or required by the above-described manufacturing method, in particular design data and/or manufacturing data for manufacturing the devices of the series or pairs of devices of the devices of the series with a manufacturing machine. Thus, the above-mentioned technical effects may also apply to the digital data.

The digital data may describe a series of devices for displacing the chewing plane of a person. The digital data may describe at least two devices or at least two pairs of devices, each comprising a jaw device, for example an upper jaw device and/or a lower jaw device, and designed to be worn by the person in succession according to a predetermined sequence of the devices/pairs of devices.

The upper jaw devices may be designed to be placed on the dental arch in the person's upper jaw. The lower jaw devices may be designed so that they may be placed on the dental arch in the person's lower jaw.

In at least one device, the at least one jaw device may comprise at least one height element on a first side. At least two contact areas may be formed on the at least one height element at mutually different positions of molar elements. At least one further contact area may be formed on a second side of the at least one jaw device. The at least three contact areas may define the plane. The plane may deviate from a starting chewing plane of the person or from a current chewing plane of the person with respect to its inclination in a frontal section or sagittal section, which is changed by the at least one height element, and/or with respect to its height position, which is changed by the at least one height element. In at least one other device of the series, a different inclination in a frontal section or sagittal section and/or a different height position of the respective plane may be adjusted/set by at least one further height element, which differs from the at least one height element in the set height. The at least one height element or the height elements may adjust/set a height that is at least twice as high or at least three times as high as a height of the at least one device above the at least one receiving region for the anterior tooth element or for the canine tooth element.

The digital data may comprise data records. Additionally or alternatively, a database structure may be used to structure the digital data, in particular to facilitate access (reading and/or writing), e.g. when changing the digital data. Furthermore, a relational database may be used, for example, or the digital data may be described and/or stored in another suitable manner.

The above-mentioned embodiments and further developments may also apply to the digital data.

A further aspect relates to a treatment plan, in particular a digital treatment plan for shifting the chewing plane of a person, in particular using a series according to one of the above-mentioned aspects or according to one of the above-mentioned embodiments or using a method according to one of the above-mentioned aspects or according to one of the above-mentioned embodiments. The treatment plan may describe the course of dental and dental-related treatment of the person. The treatment plan may specify the following data in at least a portion or throughout the treatment plan:
Number of a device pair of the series or a series,
Identification of the tooth position within the respective pair of devices, and
Determination of the treatment function for the respective tooth position of the respective pair of devices.

This means that determinations are made in at least three “dimensions”, i.e. three parameters in each case. On the one hand, this may make it necessary to deal with larger amounts of data and, on the other hand, increase flexibility in treatment planning.

The series referenced in the treatment plan, i.e. the basis of the treatment plan, may be used, for example, to support the shifting of a person's chewing plane and/or to perform other functions, in particular alignment functions and/or shifting operations.

The series mentioned in the treatment plan may comprise at least two, at least five or at least ten devices. The devices may each comprise at least one jaw device. The at least one jaw device may each comprise an upper jaw device and/or a lower jaw device. The devices may be designed to be worn by the person according to the order specified in the treatment plan.

In at least one device, the at least one jaw device may comprise at least one height element on a first side. At least two contact areas may be formed on the at least one height element at mutually different positions of molar elements. At least one further contact area may be formed on a second side of the at least one jaw device. The at least three contact areas may define the plane. The plane may deviate from a starting chewing plane of the person or from a current chewing plane of the person with respect to its inclination in a frontal section or sagittal section, which is changed by the at least one height element, and/or with respect to its height position, which is changed by the at least one height element. In at least one other device of the series, a different inclination in a frontal section or sagittal section and/or a different height position of the respective plane may be adjusted/set by at least one further height element, which differs from the at least one height element in the set height. The at least one height element or the height elements may adjust/set a height which is at least twice as high or at least three times as high as a height of the at least one device above the at least one receiving region for the anterior tooth element or for the canine tooth element.

This means that the treatment plan may allow a combination of shifting the chewing/masticatory plane and, for example, alignment functions. The technical effects mentioned above may therefore also apply to the digital treatment plan.

The above-mentioned embodiments and further developments may also apply to the treatment plan.

The digital treatment plan may comprise data records. Additionally or alternatively, a database structure may be used to structure the digital treatment plan, in particular to facilitate access (reading and/or writing), e.g. when changing the digital data. Furthermore, a relational database may be used, for example, or the digital treatment plan may be described and/or stored in another suitable manner.

The digital treatment plan may, for example, be suitable and adapted to be submitted to a dental insurance company or another medical insurance company, e.g. before the treatment in order to obtain approval and/or during or at the end of the treatment in order to obtain reimbursement from the insurance company.

In particular, the digital treatment plan may comprise the following features:
an optional rapid approach to the target chewing plane or to a training chewing plane deviating therefrom, e.g. with only one device or with fewer than five devices or fewer than six devices, preferably with a significant displacement of the chewing plane, e.g. by at least 1 mm, at least 2 mm or at least 3 mm at at least one tooth position according to a tooth scheme, e.g. according to the quadrant scheme, and/or
an optional “overshoot” of the change, e.g. to a training chewing plane that deviates more from the starting chewing plane compared to a deviation of the starting chewing plane to the target chewing plane with a subsequent return to the target chewing plane, and/or
another “overshoot” in a different or opposite direction, e.g. to an intermediate chewing plane that deviates less from the starting chewing plane compared to a deviation of the starting chewing plane from the target chewing plane.

A further aspect of the invention may relate to a training method in which a new chewing plane is learned as explained above.

Although the invention has been illustrated and described in more detail by the preferred embodiment, the invention is not limited by the disclosed examples and other variations may be derived by the person skilled in the art without departing from the scope of protection of the invention.

Identical reference signs refer to identical technical features, unless otherwise stated. Where “may” is used in this application, it means both the possibility of realization and the actual technical implementation. The concepts of the disclosure are described with reference to preferred embodiments below in a specific context, namely aligners. However, the disclosed concepts may also be applied to other situations and/or arrangements, in particular to situations where no alignment is required.

The foregoing has broadly explained the features and technical effects of the invention. Additional features and technical effects of embodiments of the present disclosure are explained below, e.g. the subject matter of the claims. It should be recognized by those skilled in the art that the concept and specific embodiments may be used as a basis for modifying or designing other structures or processes having the same or similar purposes as the concept specifically disclosed herein. It should also be recognized by those skilled in the art that equivalent constructions do not depart from the spirit or scope of the disclosure as defined, for example, in the appended claims.

For a more complete understanding of the disclosed concepts and their technical effects and advantages, reference is now made to the following description in conjunction with the accompanying figures. The following figures are roughly schematic representations of complex polydimensional processes and polyfunctional devices. In principle, these illustrations may only represent a partial aspect of the illustrated reality of the devices and processes.

The illustrations (FIG.) are not drawn for scaling. The drawings show:

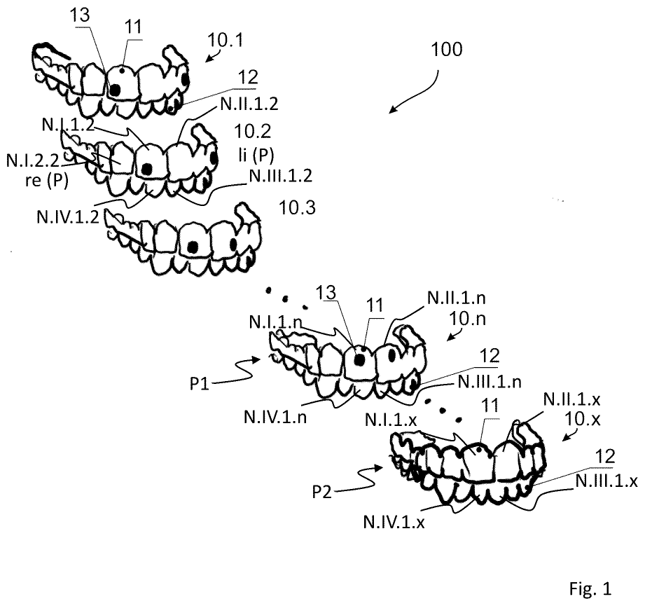

FIG. 1 A simple combination of aligner functions with a shape function and/or an optional color function,

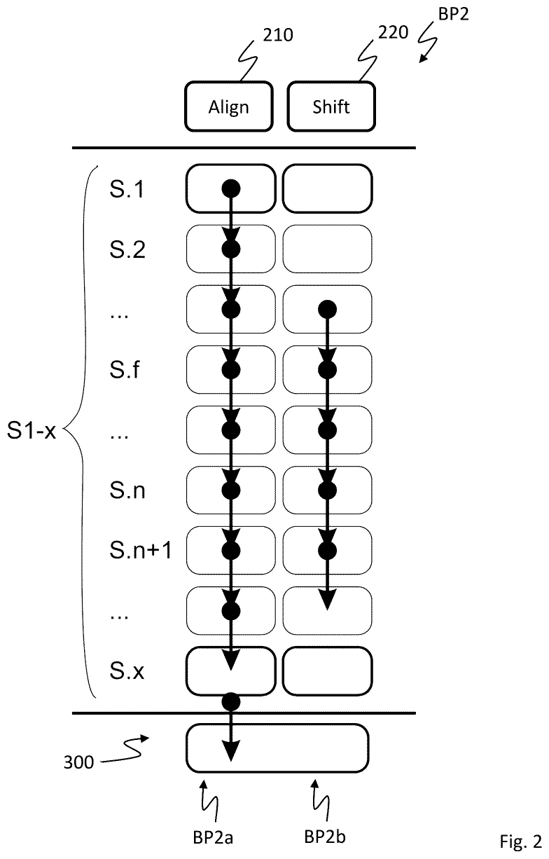

FIG. 2 For comparison, a two-dimensional treatment plan composed of alignment function and shifting function,

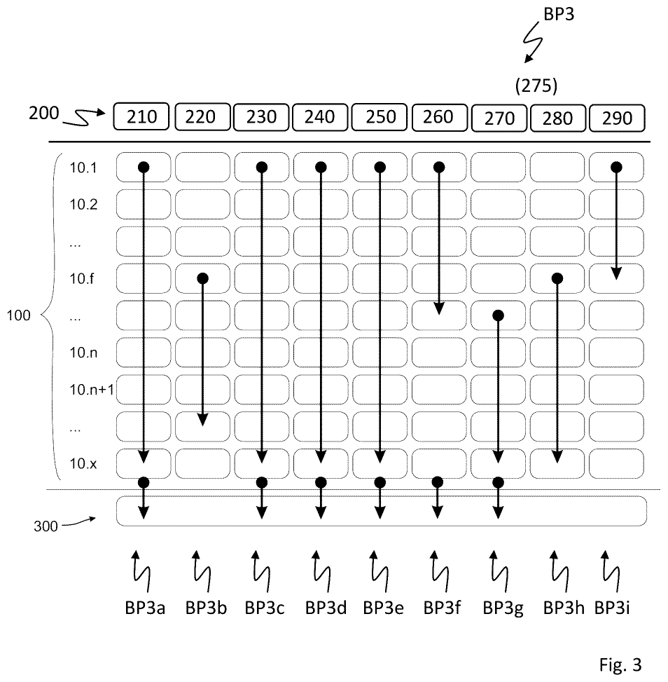

FIG. 3 A complex multifunctional treatment plan with 9 function types,

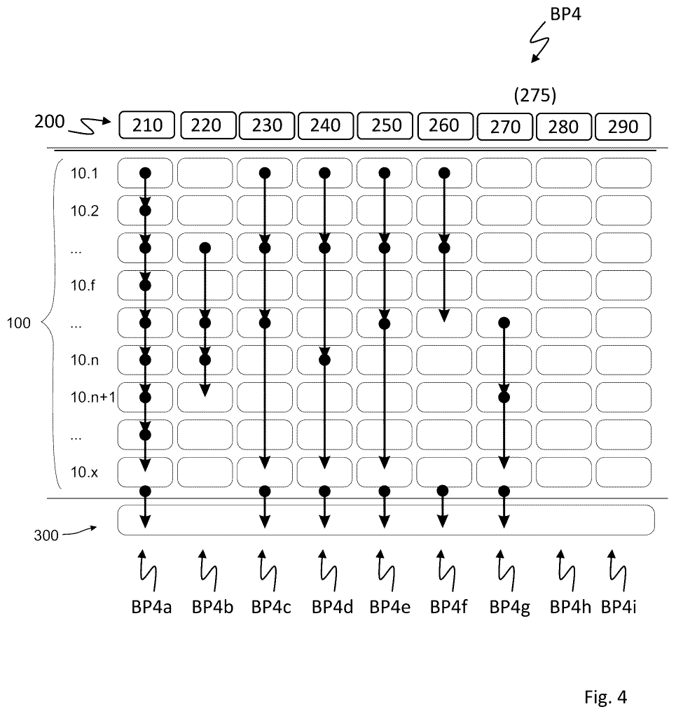

FIG. 4 The polyfunctional “staging” in the polyfunctional treatment plan,

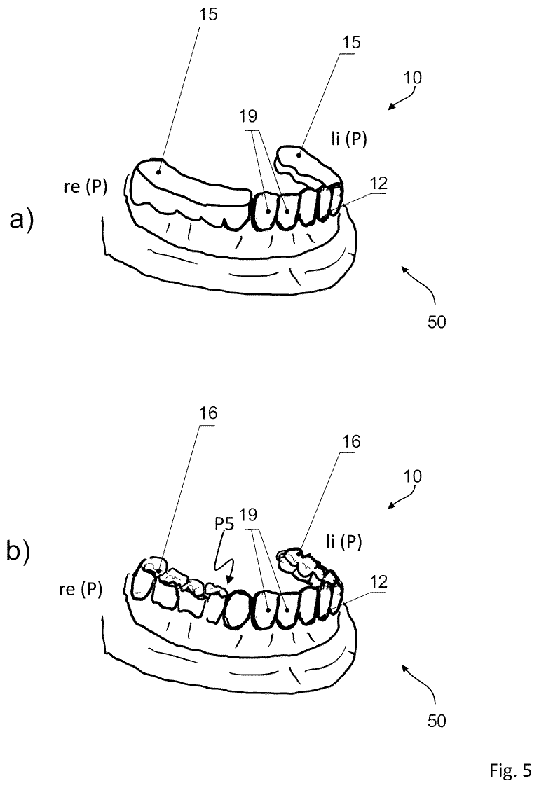

FIG. 5 An embodiment with sliding function in combination with height function on the molar regions and shape function on the anterior regions,

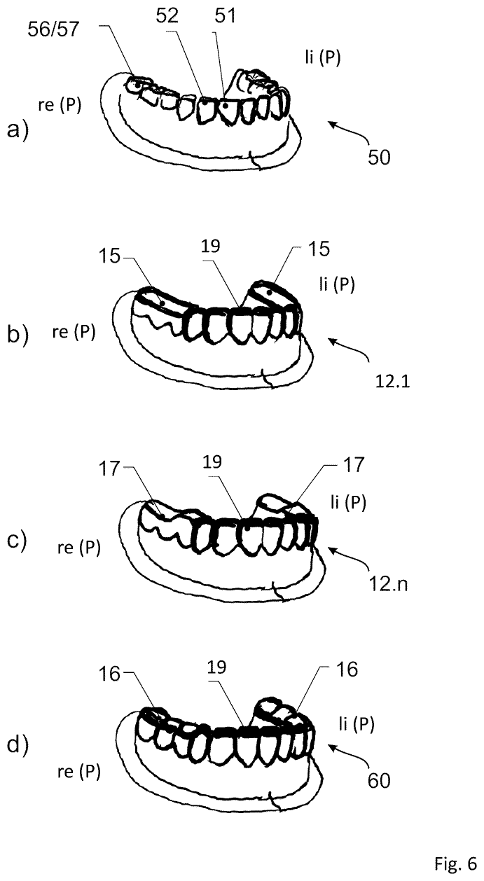

FIG. 6 The incremental transition with sliding function, ramp function and height function in the molar region and form function in the anterior region,

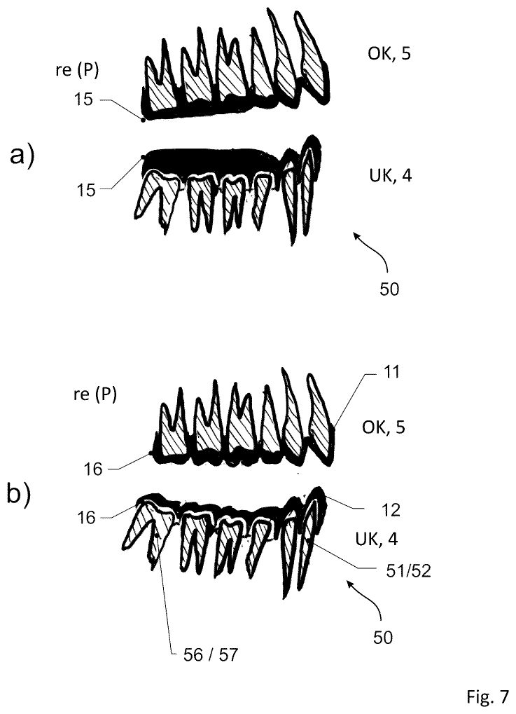

FIG. 7 The height function in an asymmetrical form, for example,

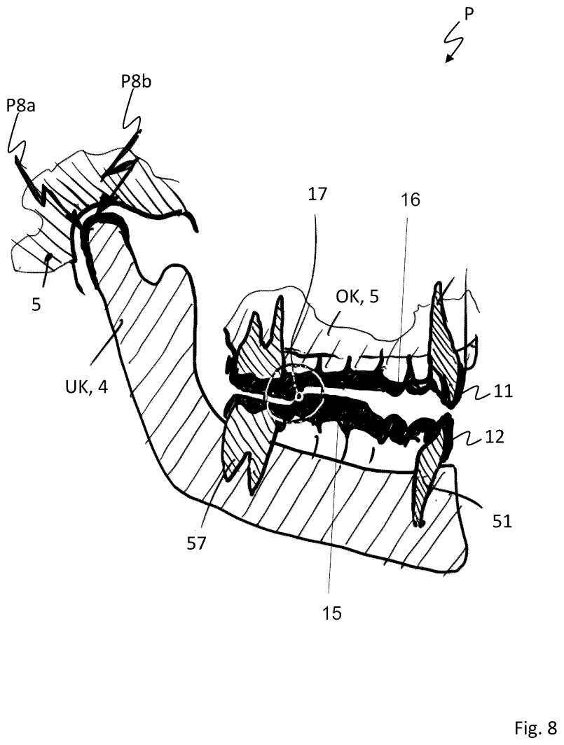

FIG. 8 A height function combined with a ramp function for craniomandibular dysfunction CMD,

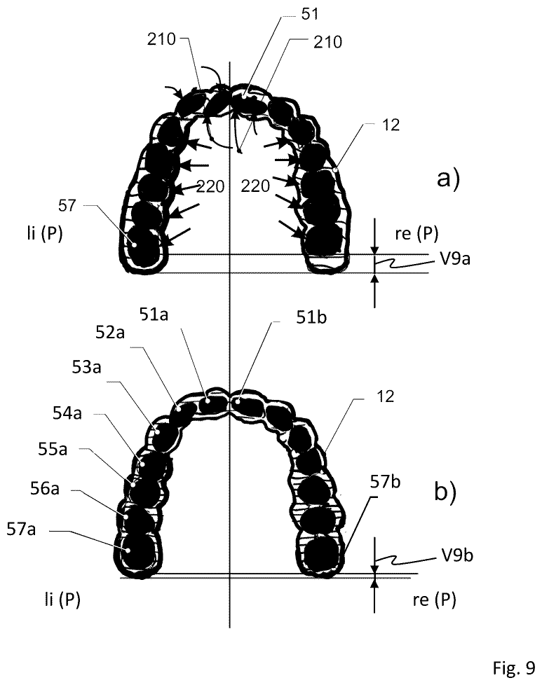

FIG. 9 An example of the hidden alignment function and move function,

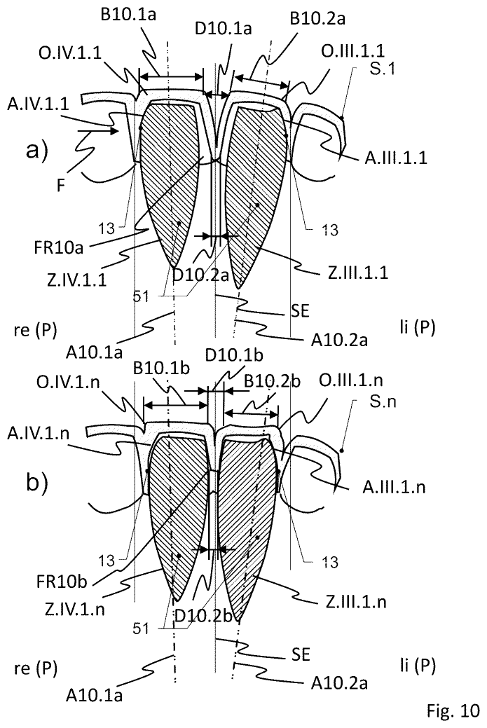

FIG. 10 For comparison, an alignment function on anterior teeth that may be observed through a transparent aligner splint using a shape function (tooth veneer(s)),

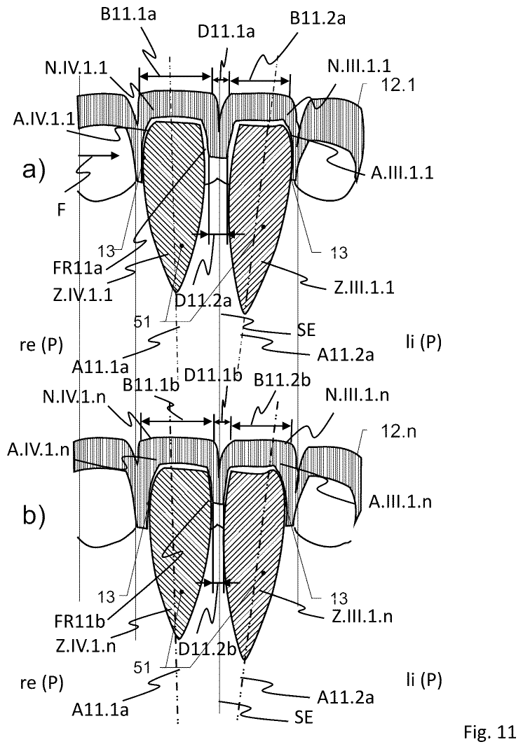

FIG. 11 In the sectional view, the concealed alignment function in the case of two separated anterior teeth,

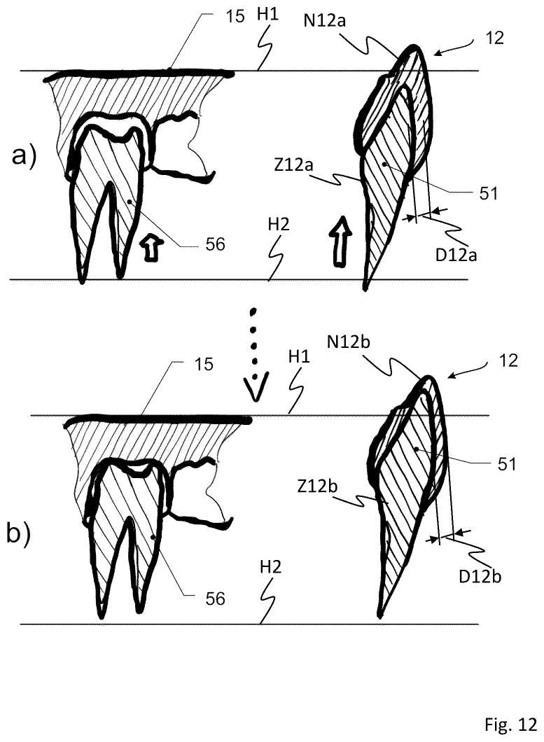

FIG. 12 The concealed distal outgrowth of natural teeth,

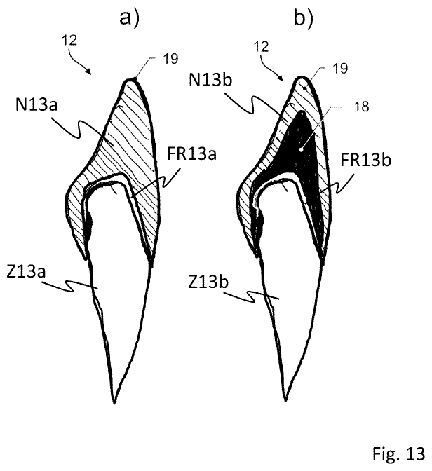

FIG. 13 A multi-layer structure of a lower jaw device in sectional view,

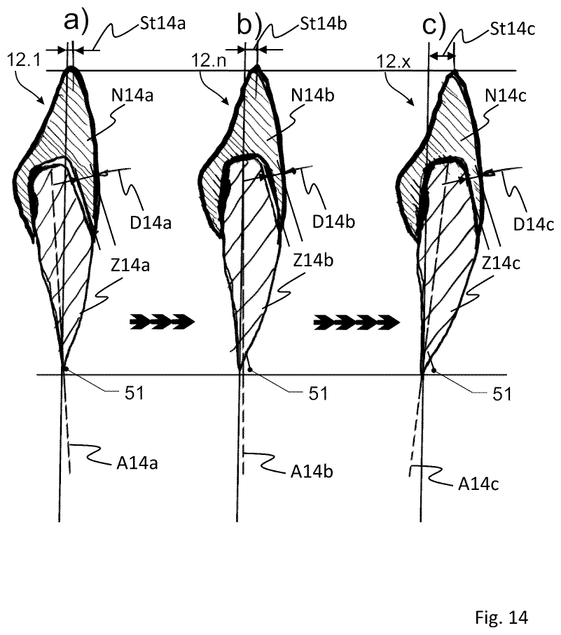

FIG. 14 The shifting function in combination with the shape function (tooth veneer veneer(s)) in the sense of displacement of the visible tooth regions towards a larger dental arch in the sectional view,

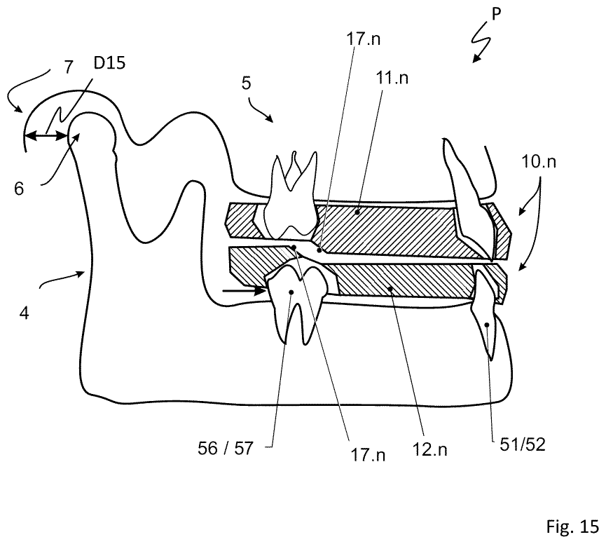

FIG. 15 A device with height function and ramp function and slide function and alignment function and shape function,

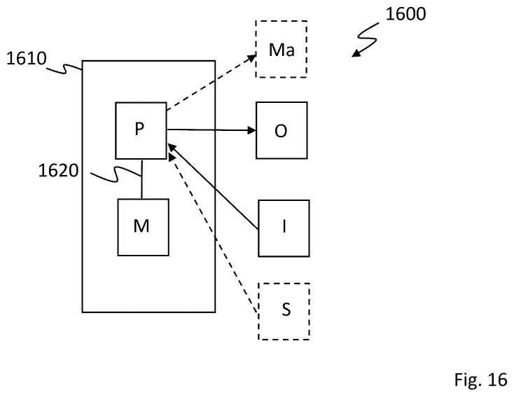

FIG. 16 A computer system,

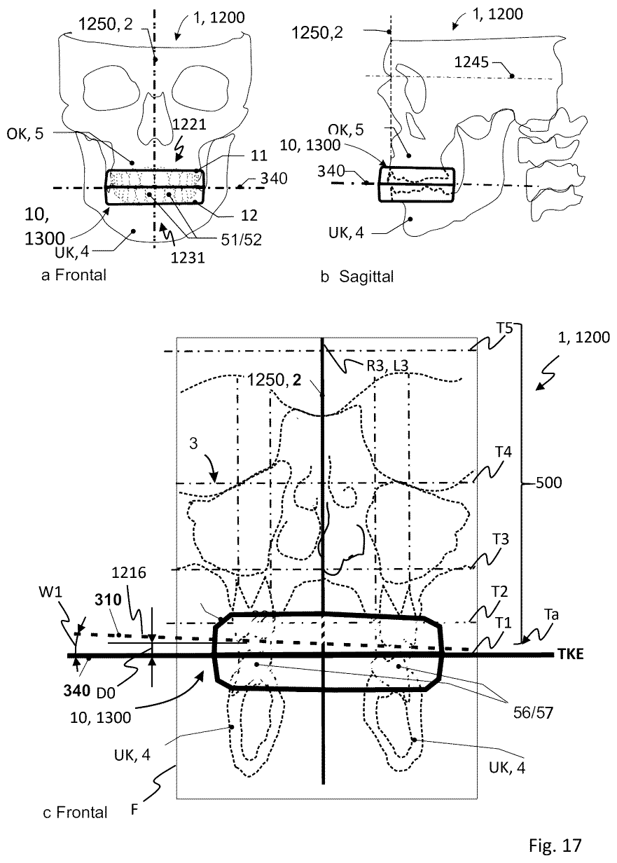

FIG. 17 A device for shifting the chewing plane with a training function for relearning the position of the chewing plane,

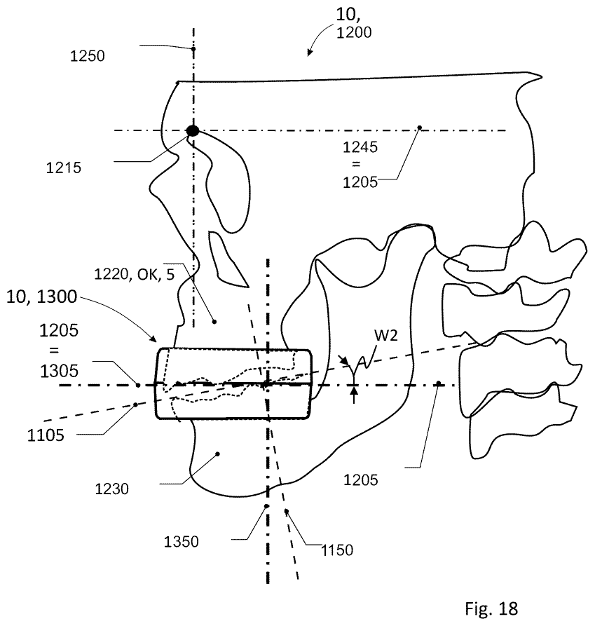

FIG. 18 A schematic illustration of a digital image of a head from the side with a digital device inserted to displace the chewing plane,

FIG. 19 Part of a treatment plan concerning the staging (sequence) for functions for displacing the chewing/masticatory plane or functions that enable preferably neuromuscular relearning of the chewing/masticatory plane,

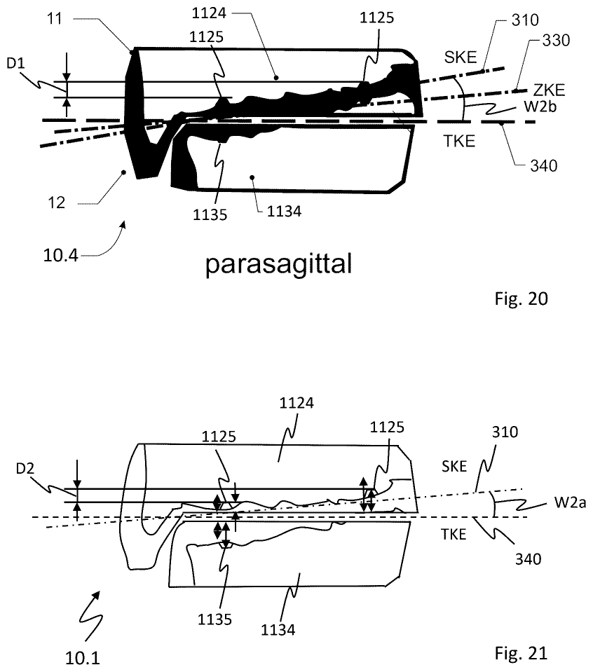

FIG. 20 A para-sagittal section through a device for shifting the chewing plane,

FIG. 21 A para-sagittal section through a device for displacing the chewing plane, whereby the device lies in the sequence of the devices of a series, for example, before the device shown in FIG. 20,

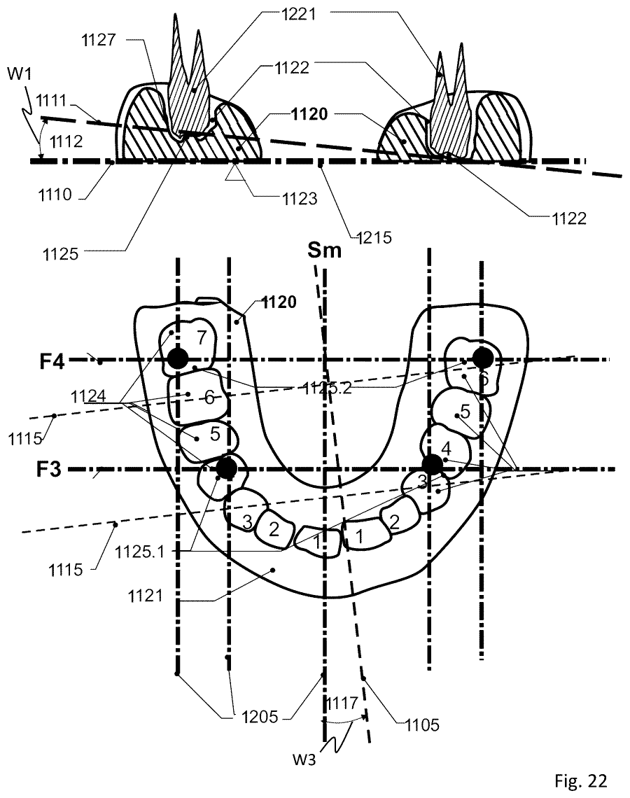

FIG. 22 In its upper part a sectional view of a sliding surface of a device for displacing the chewing plane and in its lower part a top view of the device for displacing the chewing plane,

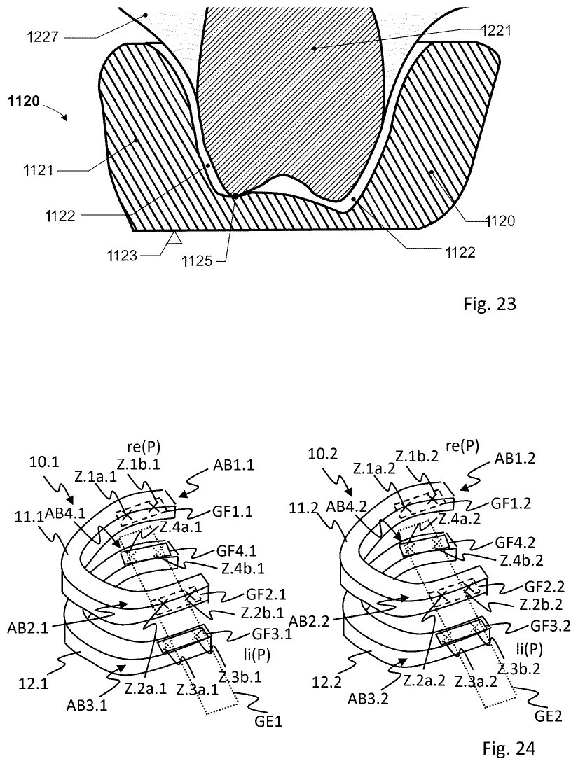

FIG. 23 Details of a support/carrier region of a tooth in the device for displacing the chewing/masticatory plane,

FIG. 24 Schematic of a first device for displacing the chewing plane and a second device for displacing the chewing plane,

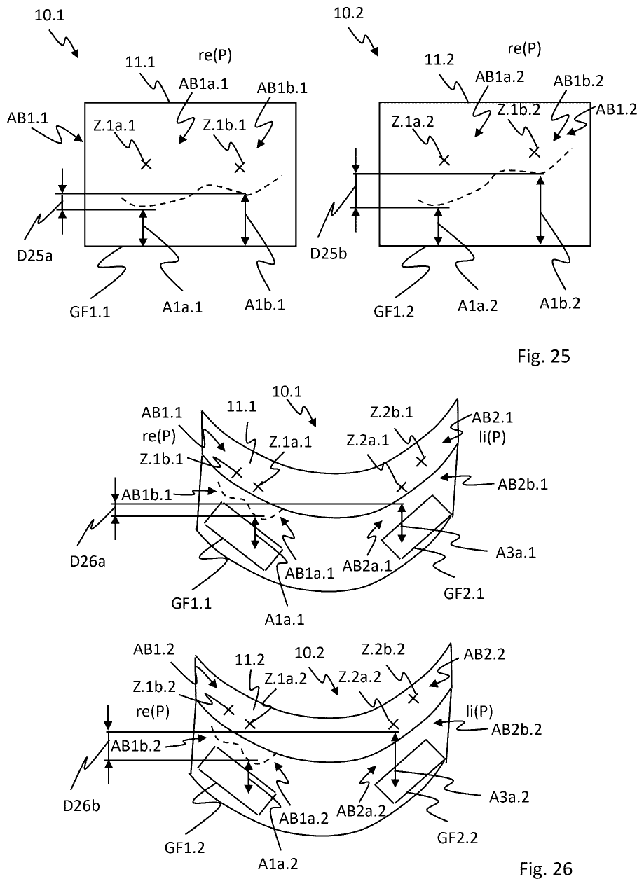

FIG. 25 Arrangements of recess regions for teeth relative to sliding planes in a right part of the upper jaw device of the first device and in a right part of the upper jaw device of the second device,

FIG. 26 Arrangements of recess regions for teeth relative to sliding planes in the upper jaw device of the first device and in the upper jaw device of the second device, and

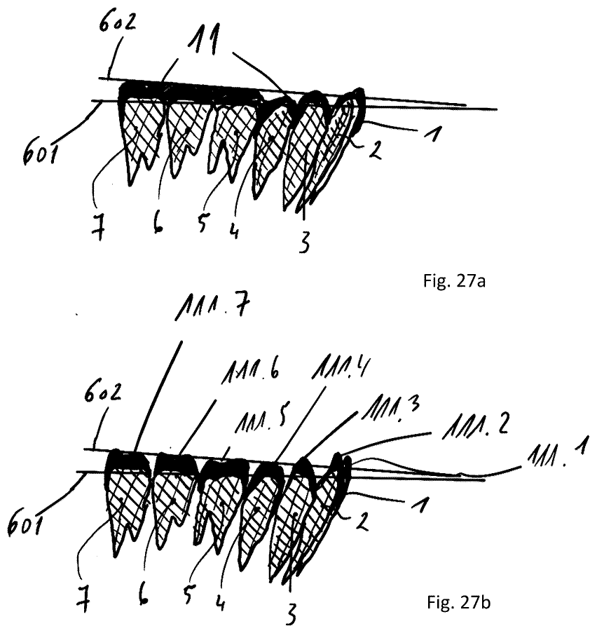

FIG. 27 Elevating elements in a lower jaw device and a corresponding final restoration.

FIG. 1 shows a roughly schematic and very simplified representation of a series 100 of devices 10, wherein the devices 10 each comprise an upper jaw splint (rail) 11 and a lower jaw splint 12. The series 100 of devices 10 comprises x devices 10.1 to 10.x, where x is a natural number, for example in the range from 10 to 50.

The devices of a series may comprise a combination of functions, in the embodiment example shown here at least a) alignment function 210, b) shifting function 220 and c) shape function 230 (tooth veneer, veneering element). The functions may occur together in combination in one device, or successively in different phases of the series 100 in an individual number of devices, or only in individual devices.

The alignment function 210 may be shown in contact elements 13, which may be suitable or adapted to transmit forces and moments of force to the teeth or tooth stumps in order to better align the teeth next to each other. Optionally, the teeth may be provided with attachments for this purpose.

The shifting function 220 may be shown in a device in that the devices are suitable or adapted for displacing the teeth according to a large plan, preferably in the sense of a larger and more widely constructed dental arch or arcuately arranged tooth elements.

The shape function 230 may be shown on a device 10 in that at least some tooth veneers have an independent shape that differs from the shape of the real teeth or tooth stumps that may be restored, for example:
by reconstructing the shape, and/or
in that the tooth veneer, which covers the actual or the underlying tooth/tooth element, is larger and/or more voluminous than the underlying tooth, and/or
in that the tooth veneer is longer, and/or
in that the tooth veneers have a more suitable shape than the tooth.

As shown in FIG. 1, the reproduction visible from the outside may arise from or consist of the shape of the visible tooth veneers. It may be characteristic of the proposed technology that the shape of the device 10, insofar as it is visible from the outside, changes little or not at all over the devices of the series 100 or over some of the devices, while the changes are made in the concealed area and in particular on the concealed teeth.

Experts may recognize the differences between the devices 10 in the course of a series by the faintly visible attachment points of aligner elements 13 when the devices are outside the mouth of the person P. However, the changes to person P's dentition may occur either in the region of the actual teeth of the dentition hidden by the dental veneer(s) or in the molar region, which cannot be seen directly from the outside.

The treatment plan may generally comprise x steps, where x is the natural number mentioned above. The series 100 may comprise a number of x devices, one each for upper jaw OK, 5 and lower jaw UK, 4, i.e. a pair. The points of application for interaction forces between devices and teeth may change from device to device. As a result, teeth may be displaced step by step. The concealed force-functional elements 13 are systematically indicated in FIG. 1.

It may be of particular importance that the devices 10 are already optimized in shape and optionally also in color in the integrated technology. From the external geometry and/or color, for example, no difference may be seen between the devices 10 of the series 100 at a cursory glance. The differences between the successive devices 10 may lie in particular in the front teeth concealed by the tooth veneer(s), in particular in the exact position of the recesses in which the teeth engage, i.e. for example in the functional elements 13 that may exert forces on the teeth and in the free spaces that are given to the teeth for a reaction movement to these forces F.

The movement of the teeth may take place in the background following the treatment plan BP and may not be immediately visible from the outside. The last device 10 concludes the polyfunctional aligner treatment. The dentition with the teeth and tooth stumps in the new position may then be fitted with a final dental restoration 300. The tactile and visual impression may change only slightly during the transition from the last device to a final restoration. With the final restoration 300, the teeth may be blocked as little as possible, as otherwise the bony integration could suffer.

The devices or pairs of devices 10 of the 100 series may be worn by one person P (see, for example, FIGS. 8 and 10) one after the other. All or some of the pairs of devices may comprise tooth veneers. The tooth veneers are labeled N.I.1.2, N.II.1.2, N.III.1.2, N.IV.1.2, N.I.1.2, etc. according to their position. The designation here follows the designation of tooth positions as used by dentists and orthodontists, i.e. four quadrants or sectors I, II, III and IV are used and the teeth in a quadrant are numbered from 1 to n from front to back in relation to the reference system of the person P. Seen from the observer, quadrant I may be at the top left, quadrant II at the top right, quadrant Ill at the bottom right and quadrant IV at the bottom left. This means that the order of the quadrants may be clockwise or to the reight. The following may apply to the designation of the tooth veneers:
the first letter is an N (replica, tooth veneer) as opposed to a Z for teeth or an A for recesses,
the Roman numeral in the second position indicates the quadrant, as indicated above,
the number in the third position indicates the position within the quadrant, and
the number in the fourth position indicates the number of the device concerned in the sequence of devices 10 in the 100 series.

For example, the tooth veneers N.I.1.2, N.II.1.2, N.III.1.2, N.IV.1.2 are located in this order in the first quadrant I, in the second quadrant II, in the third quadrant Ill and in the fourth quadrant IV at the first or front position respectively. As shown in FIG. 1, the veneer positions mentioned are in the second device, which is indicated by the last digit in each case. Corresponding tooth positions of corresponding anterior teeth behind the tooth veneers in the inserted state of the device 10.2 are Z.I.1.2, Z.II.1.2, Z.III.1.2 and Z.IV.1.1. The second tooth at the top left as seen from the observer has the designation Z.I.2.2, i.e. it is located in quadrant I at the second position in the device 10.2. Thus, the corresponding tooth veneer or tooth replica is designated N.I.2.2.

The number n may refer to a device or to a pair of devices 10 in the middle part of the sequence or series 100, see for example tooth veneer N.I.2.n, which is located at the same position as the tooth veneer N.I.1.2 and which may be designed on its outer surfaces, in particular on its front surfaces, like the tooth veneer N.I.1.2. Three points indicate that between a third pair of devices 10.3 and the pair of devices 10.n there may be at least one further pair of devices of the series 100 in the sequence, typically several pairs of devices.

The number x may refer to the last device or the last pair of devices 10.x in the sequence or series, see for example dental veneer N.I.1.x, which may correspond to the dental veneers N.I.1.2, N.I.1.n, i.e. may have the same external shape and/or be arranged at the same position in relation to the upper dental arch of the devices, in particular the maxillary devices 11. Three dots again indicate that between the pair of devices 10.n and the pair of devices 10.x there may be at least one further pair of devices of the series 100 in the sequence, typically several pairs of devices.

Device parts that are located in the device on the right “right” as seen from the observer (dentist, technician, orthodontist) are located on the left with respect to the person (P) carrying the device (the device pair), which is indicated by “Ii (P)” in the figures. Similarly, parts of the device that are located in the device on the left “Ii” as seen from the observer are located on the right with respect to the person (P) carrying the device (the pair of devices 10.1, etc.), which is shown with “re (P)” in the FIGS.

Thus, FIG. 1 clearly shows that the front region of the devices 10.1 to 10.x may remain unchanged while the alignment functions 210 of the devices change. Additionally or alternatively, the front region of the devices 10.1 to 10.x may remain unchanged, while superstructures in the molar region change, e.g. superstructures with height function 250 and/or with sliding function 260 and/or with ramp function 270, see for example the molar regions in the first quadrant I, which may be different in the first device 10.1 than in the second device 10.2 and which may be different in the last device 10.x than in the middle device 10.n, see arrows P1 and P2.

FIG. 2 shows a roughly schematic functional representation of a comparative aligner treatment plan BP2 for a number of x aligner splints S.1 to S.x. The functions comprised therein may be divided into alignment function 210 and shifting function 220. Alignment function 210 is used, for example, to improve the integration of individual teeth or groups of teeth into an existing dental arch.

The shifting function 220 is used, for example, for large-scale displacement or modification of the dental arch, e.g. in the sense of widening the dental arch to create more space. In many cases, such a widening may be carried out with shifting functions 220 in order to be able to carry out an alignment of existing teeth in the first place, i.e. to create the space required for this.

Since aligner splints may also press against the teeth from the inside and consequently tilt them outwards, there may be a certain overlap between the alignment function 210 and the shifting function 220. So-called attachments may often correspond to the alignment elements on the recesses in the splints that hold the teeth, but these are not attached to the splint but to the respective tooth. The region for holding the tooth in the splint may often allow a certain degree of movement in the desired direction of tooth displacement. Therefore, alignment functions 210 in combination with shifting functions 220 alone may achieve success up to certain limits.

The sequence of splints (aligners) may guide the teeth into a new constellation, whereby especially those teeth that originally deviated greatly from the target state may be shifted and/or rotated. After aligner treatment with the last aligner 10.x, the teeth are in a new formation, but still look the same as before. Only now may the teeth be further restored with esthetic and dental technologies in a final treatment 300, e.g. with veneers and/or crowns and/or table tops. In this case, the appearance of the teeth may change only now, but now abruptly. This type of aligner treatment may have considerable weaknesses and only a very limited effect, especially in adult patients or people with abraded teeth and misalignments.

In the comparative example, the treatment plan BP2 may include only two partial treatment plans BP2a, BP2b, which illustrates the use of only a few function within a comparative series S1-x of devices or pairs of devices. In particular, the comparison series S1-x may not include a shape function 230, i.e. no tooth veneers. On the contrary, the devices or pairs of devices S1, . . . , S.n, . . . S.x of the comparative series S1-x may be designed with a transparent or at least translucent material.

FIG. 3 schematically shows a proposed polyfunctional treatment plan BP3. The series 100 comprises a number of x devices 10. The series 100 is based on the initial state 200 of the dentition. The first device of the series 100 is device 10.1, the last device is device 10.x. In the series 100 of polyfunctional treatment steps, the state 10.x is reached with device 10.x, i.e. the end of treatment with splints or devices. A final treatment 300 may then take place.

This polyfunctional combination of the functional elements, which are realized in a fully integrated combination in a series 100 of devices 10, may create the multidisciplinary effect that is not possible with simple aligner splints, e.g. with the comparative aligner splints S.1 to S.x according to FIG. 2. Starting from the state achieved with the devices 10, the final restoration 300 with table tops, veneers, etc., may then be carried out, i.e. only after the last splint 10.x has been removed.

If the color function 240 is activated, the color selection may have already been tested in advance during the polyfunctional treatment. In the embodiment shown, the alignment function 210 with displacement of the teeth relative to their neighbors may extend over a large part of the series 100 or, as shown, over the entire series 100. The devices 10.1 to 10.x then carry suitable alignment elements or a suitable position or shape of the recesses for the teeth throughout at selected recesses in order to displace selected teeth by contact forces and rotational or tilting moments in combination with the required freedom of movement.

In the embodiment shown, the polyfunctional variety may comprise the alignment function 210, the displacement function 220, the shape function 230, the color function 240, the height function 250, the sliding function 260, the ramp function 270 as well as the implant function 280 and the support/carrier function 290. The arrows along the function columns indicate that a function may be optionally activated, but need not be continuously activated on all devices. In general (not shown here), some of the functions in the present series 100 may not be activated at all, for example because a patient (person P) does not require that function. The implant function 280 may be activated particularly rarely, namely only if implants are present.

It is clearly visible that the shape function 230 may be used from the outset, i.e. already in the first device 10.1 and/or in all devices 10.1 to 10.x, e.g. using tooth veneers or tooth replicas. This may be comparatively unproblematic in some treatment cases. In other cases, this may be supported or enabled by other suitable functions of functions 210, 220, 240 to 290.

The use of the dental veneers or veneering elements may have a technical relationship to the color function 240 in that transparent materials without coloring and/or without white or other non-transparent coatings may not be suitable for providing the visual veneer function. However, transparent materials may be used, for example, if the stabilization function and/or the tactile function of the dental veneer or the veneering element are sufficient or offer sufficient other advantages.

The color function 240 may optionally also be used right from the start, i.e. in the first device 10.1 and/or in all devices 10.1 to 10.x. The color function 240 may optionally be changed within the series in order to find a suitable color tone or suitable color gradations. The color function 240 may implement a color that is different from transparent and/or translucent material. In the context of this understanding, the color white is also considered a color here, as it may also perform a masking or veneer function.

For example, the arrow in the shifting function 220, which starts later, indicates that an alignment is carried out first before the shifting function 220 is started at device 10f.

The initially activated sliding function 260 means, for example, that the first devices in the molars may support sliding devices, while the later ones no longer do. The height function 250 (Height) in the molar regions, on the other hand, is present throughout the example because, for example, the teeth were abraded and the bite that was previously too deep needs to be corrected. In general, the functional elements realized in the devices 10 may differ between successive devices. Device 10.n therefore not only looks different from the subsequent device 10.n+1 in terms of the geometry of the force-transmitting elements 13, it may also comprise a different combination of functional elements and functional types, although the exterior of the tooth veneers may remain the same or unchanged.

An important feature may be that the shape function 230 as a mechanical stabilization function, possibly also as a function with, for example, a biomechanical effect or as an aesthetic function, may also start very early, while no tooth veneers are used in the comparative aligner treatments according to FIG. 2, and thus the shape and/or the position of recesses behind or in the tooth veneers is also not changed relative to a tooth veneer that is unchanged towards the front. The change in shape is proposed by the design of the tooth veneers, which together belong to the device 10, i.e. not by simple material reshaping around receptacles or recesses for receiving the teeth.

In the compressed polyfunctional representation of the treatment plan BP3 selected here, it should be noted that each of the columns for each of the functions may refer to the pattern of the generally maximum 32 teeth of the dentition. The view shown is therefore a sum of the teeth of the dentition. Activation of a function means that it is activated for at least one tooth or at least one group of teeth in the device in question. In addition to the multifunctional “staging” shown here in FIGS. 3 and 4, a complete multifunctional treatment plan BP3 or BP4 also includes the tooth/dental “staging” in relation to the individual up to 32 tooth positions. However, this distribution of activation to individual teeth is not shown here.

The treatment plan BP3 may be completed with a final restoration 300, i.e. e.g. by veneers and/or crowns or table tops, preferably oriented to the final or target tooth condition, i.e. in accordance with the labial shape of the tooth veneers N.I.1.1, etc., which is also oriented to the final or target tooth condition.

Treatment plan BP3, for example, comprises nine sub-treatment plans BP3a to BP3i, which correspond in this order to the functions 210 to 290 mentioned above.

Further functions may optionally be added, e.g. an orthosis function 275, e.g. an orthosis according to Saxler, see WO2020141134A1, which is hereby incorporated by reference for all legal purposes. The separation slip plane of the orthosis may be determined according to Saxler (3D structure marking or 3D marker or 3D ruler) or according to another method. The orthosis may or may not comprise a marginal gap.

FIG. 4 shows a treatment plan BP4 for a special, but also frequently occurring case without implant function 280 and without support/carrier function 290, but with pronounced shape functions 230, i.e., for example, shape function of the anterior visible tooth veneers of the splint, and/or color functions 240, i.e., for example, color/shade design of the anterior visible tooth veneers of the splint, in particular deviating from transparent and/or translucent.

In this case, the upper jaw splints 11 are directly clamped on the teeth of the upper jaw OK, 5 and the lower jaw splints 12 are seated on the teeth of the lower jaw UK, 4. The step-by-step alignment function 210 with displacement and alignment of teeth ends in a position that is then available for the final restoration 300. At the same time, depending on requirements in the case shown, a phase of the shifting function 220 takes place in the middle of the sequence, in which the teeth are moved outwards, for example. This shifting function 220 may be much more pronounced in other cases. It may often be the prerequisite for having sufficient space to be able to shape and size the teeth individually after the polyfunctional treatment by series 100 in the final phase 300 (final restoration).

The step-by-step alignment function 210 is illustrated by several arrows to show the increased complexity of the alignment compared to FIG. 3. For example, the alignment may affect different teeth in the course of the BP4 treatment plan.

The shape functions 230 may also be graduated, as indicated by several arrows, e.g. in order not to move too abruptly from the initial state to a final state, i.e. that, for example, an enlargement of the dental arch is not carried out immediately and thus obviously visible to all, but in stages and thus more inconspicuously for third parties and possibly also for the person P. This means that the shape function 230 (veneering) does not have to be based on the final target tooth condition from the outset. Intermediate target tooth states may be used. Alternatively, a constant or only slightly changing shape function 230 may also be used in treatment plan BP4 using associated tooth veneers and/or tooth replicas.

Also in the embodiment example shown in FIG. 4, further functions may optionally be added, e.g. an orthosis function 275, e.g. an orthosis according to Saxler, see WO2020141134A1, which is hereby incorporated by reference for all legal purposes. The separation slip plane of the orthosis may be determined according to Saxler (3D structure marking or 3D marker or 3D ruler) or according to another method. The orthosis may or may not comprise an edge gap.

In FIG. 4, the optional color function 240 is shown activated in stages with a sequence of arrows in order to move from the initial state not too abruptly to an optimized brighter state, e.g. from a more yellowish color to a more whitish or white color. Alternatively, a constant or essentially constant color function 240 may also be used in treatment plan BP4, e.g. the color may only change within the scope of the manufacturing possibilities and/or manufacturing tolerances.

Here in FIG. 4, as in FIG. 3, the height function 250 is active throughout because the teeth were abraded in the initial state 200. The sequence of arrows along the function column 250 indicates that successively different heights of the abutments are used in the molar regions.

The sliding function 260 is shown in phases on the devices or on the pairs of devices 10.1 to 10.x, for example by sliding areas in the molar tooth region.

The ramp function 270 is additionally activated in phases, especially if the biomechanics of the temporomandibular joint make this necessary, e.g. in the second half of the 100 series.

Functions 280 (implant) and 290 (support) may not be used, e.g. because the dentition still comprises all teeth or only a few teeth are missing. Alternatively, functions 280 (implant) and 290 (support) may also be used in the BP4 treatment plan and therefore also in the 100 series devices.

The sequence shown here is intended purely as an explanatory aid. The correct sequence for a given patient or person P may be determined on the basis of the initial condition and with the help of the planned target condition. In any case, polyfunctional treatment offers many times more treatment options, even for complex misalignments and wear and tear conditions, than was previously possible. The target group may range from 30 to 80 years of age, i.e. it may be very large. The willingness to invest may be high because the functional advantages, particularly in terms of aesthetics and/or tactile properties, are perceived as decisive. Particularly in patients aged 50 and over, and especially in persons aged 60 and over, a pure aligner therapy, which for example only uses aligner functions 210 and possibly also shifting functions 220, may not usually make sense due to wear and tear.

Treatment plan BP4 comprises sub-treatment plans BP4a to BP4i, which correspond in this order to functions 210 to 290 above.

FIG. 5 shows in the upper picture a lower jaw part 12 as part of a device or a pair of devices 10. FIG. 5a shows a first device part 12 from a first phase of the series 100 and FIG. 5b shows a second device part 12 from a second phase or a second partial section of the series 100.

FIG. 5a shows a sliding surface 15 in the molar region with number 15. This may be a feature of an activated height function 250 in combination with an activated sliding function 260.

In FIG. 5b, the height function 250 is still activated, but the sliding function 260 is deactivated. Instead, the ramp function 270 is activated in the form of small but effective slopes on the teeth in the molar region. This may be seen in the hump-shaped contact surface 16 with sloping flanks and small ramps, see arrow P5. These shifts the lower jaw UK, 4 transversely forwards during contact bite, i.e. they have a completely different effect than the sliding function 260 at the same bite height.

In both FIG. 5a and FIG. 5b, the anterior teeth are covered and concealed by tooth veneers 19, which belong to the lower jaw splint 12. The displacement of the actual teeth is thus concealed. In the anterior region, the esthetically designed tooth veneers 19 form a cover. The alignment functions 210 and the shifting functions 220 are installed underneath in the recesses for the teeth, according to individual and phased requirements. However, this may only be seen when the splints are removed from the mouth. The superstructures 15 and 16 cover the teeth in the molar region. However, these may only be seen from the outside when the mouth is wide open, for example.

FIG. 6 shows schematically different states of devices 10, which are taken as an example from a series 100, in each case only the lower jaw splint 12. The upper jaw splint is omitted in each case for better representation of the molar regions.

FIG. 6a shows the initial state 50 of the teeth of person P or the patient. FIG. 6a shows an anomaly in the dentition that often occurs as a result of classic orthodontic measures, for example after extraction of two teeth in the lower jaw. The dental arch in the lower jaw, which was too small, had not been widened, for example. This promoted abrasion of the teeth. The condition of the temporomandibular joint is now often suboptimal and craniomandibular dysfunction CMD may often be present. The temporomandibular joint and the chewing plane may then also require treatment.

According to FIG. 6b, the first mandibular splint 12.1 sits on the dentition in the initial state 50, but it already shows the form function 230 on the large tooth veneers 19, behind and/or under which the anterior teeth are located. In contrast to FIG. 6a, the anterior teeth thus appear at first glance to no longer require treatment, even if they are in need of treatment and even if they are currently being treated.

Starting from the splint 12.1 in the initial state 50, there may be a phase in the polyfunctional treatment plan BP and an associated number of devices in which raised sliding surfaces 15 are provided on the right and or left in the molar region 56/57. The sliding surfaces may be predominantly flat or part of a hyper-surface. They may thus build up a sliding function 260. The extent of the elevation results in the heights for the height function 250. The contact surfaces in the molar region may also comprise ramps of a ramp function 270 and steps or different slopes.

According to the vectorial force decomposition, the contact at ramps and/or slopes may cause a force component of the chewing/masticatory muscles to act on the lower jaw UK, 4 in such a way that a lateral or anterior-posterior force component is produced. As a result, changes in the contact forces in the jaw joint may be achieved and the lower jaw UK, 4 may be displaced or twisted/rotated relative to the upper jaw OK, 5.

In a particular embodiment, an asymmetrical arrangement of sliding surfaces 15 and ramps 17 in the molar regions on the right and left may be selected in such a way that complex position corrections are possible, composed of translation and rotation in, for example, a total of 6 degrees of freedom, see in particular FIG. 6c.

An intermediate or final goal of polyfunctional treatment may be the state 60 shown in FIG. 6d with a wider dental arch and larger tooth veneers 19. At the same time, for example, the chewing plane may be biomechanically correctly adjusted, particularly in the molar region, and malpositions in the temporomandibular joint may be corrected. All these different treatment objectives may be combined in a series 100 of devices 10, whereby the series of devices 10 each consist of an upper jaw splint 11 and a lower jaw splint 12.

FIG. 7 shows roughly schematically that a comparatively high superstructure/abutment 15 as in FIG. 7a may be used, particularly in the molar region, firstly to achieve a release of the lateral mobility of the lower jaw and/or secondly to form a sliding surface with functional type 260 (slide). The superstructure 15 may also be referred to as a thickening or a height element. The abutment 15 may be completely filled with material in its interior, i.e. it is solid. Alternatively, the superstructure 15 may also comprise cavities in its interior, in particular if mechanical stability is ensured. Cavities may, for example, reduce the weight of the device.

The lateral mobility of the teeth in the contact state may be necessary in order to be able to move the teeth better and/or without collision using the alignment function 210 (alignment function) and/or the shifting function 220. If, on the other hand, the chewing/occlusal surfaces were coated with a layer of comparatively homogeneous thickness, as in the comparative aligners shown in FIG. 2, neither a sliding surface would be formed nor would mobility be released.

FIG. 7b shows a special variant that initially uses thinner superstructures if high superstructures inserted very quickly, as shown in FIG. 7a, for example, would lead to discomfort. The height of the superstructures required for treatment may therefore be gradually increased from the state shown in FIG. 7b to the state shown in FIG. 7a if necessary. The condition shown in FIG. 7b may already lead to a certain relief of the jaw (temporomandibular) joints.

The direction in which the lower jaw is displaced may be set, for example, by the slopes/bevels in the detailed design of the contact surfaces 16 between the upper jaw OK, 5 and the lower jaw UK, 4. In the meantime, alignment functions 210 and shifting functions 220 may already be possible and applied within a narrower framework.

In the case shown in FIG. 7a, it may be necessary to make the superstructures in the upper jaw OK, 5 on the side shown less pronounced than in the lower jaw UK, 4. This may be useful, for example, if the chewing/masticatory plane is unphysiologically inclined and/or is to be shifted according to a cranial or cranial analysis of the cranial symmetry conditions in the patient's skull P. Such complex shapes of the devices for the upper jaw OK, 5 and lower jaw UK, 4 cannot be produced by deep drawing, for example. However, they may be produced using additive manufacturing, e.g. 3D printing, or subtractive manufacturing, e.g. milling.

The superstructures 15 may be symmetrical or asymmetrical to each other on the left and right.

FIG. 8 clearly and schematically shows a section through the jaw and also through the temporomandibular joint of a patient P wearing a device consisting of two parts 11 and 12, which may be characterized by special features. The device may comprise or include a bite ramp 17 in the molar region and a sliding surface 15 also in the molar region. When the lower jaw UK, 4 and its sliding surface 15 move backwards along an anterior-posterior (front-back) axis, contact occurs at the bite ramp 17 in the dotted circle. This impedes the posterior movement of the lower jaw UK, 4 and thus prevents the posterior compression of the temporomandibular joint 5, see arrow P8a.

The height of the bite ramp 17 and the sliding surfaces 15 is adjusted, for example, in such a way that upward compression of the temporomandibular joint 5 is also prevented, see arrow P8b. This allows the muscles to stretch and the temporomandibular joint apparatus to relax. If the sliding surfaces 15 are of different heights and the position and type of the ramps 17 on the right and left are asymmetrical, this may cause a shift in the chewing plane as long as the device is worn, in particular a change in the inclination of the chewing plane.

Since it may be planned to apply a final restoration 300 after the last device 10, this optimized position of the chewing/masticatory plane may be prepared with the aid of the polyfunctional treatment and the device from the series 100 so that this physiologically favorable position may subsequently be realized with the final restoration 300.

If the use of conventional aligners, i.e. aligners without height abutments, meant that it would not be possible to perform the superstructures and correction functions 250, 260, 270, he/she would be forced to perform the complex final restoration 300 in the old non-physiological position of the chewing/masticatory plane. Or the patient would now be burdened with an abruptly changed chewing/masticatory plane, which may also be detrimental to the final restoration 300 that has already been carried out because the new position of the chewing/masticatory plane could not be learned. This may, for example, lead to destruction of or damage to the final restoration 300, i.e. dental crowns, etc. The gradual change of the masticatory plane and/or the cranial optimization with the help of superstructures, on the other hand, enable a successful treatment that was previously not possible or only possible in or with a considerably longer treatment time.

In detail, FIG. 8 shows a schematic diagram of a typical case that may occur as a late consequence after the extraction of four premolars as part of orthodontic treatment, for example. The misalignment may lead to severe abrasion and even loss of the normal arrangement of the teeth in the sense of a Spee's curve. In such a case, the teeth must or may not only be displaced by tilting moments, but also elongated, i.e. moved upwards or downwards, for example, so that the section protruding from the gums is “extended”. This may be achieved, for example, by corresponding relief areas for the teeth in the upper jaw with clearance to the solidly constructed upper jaw splint (not shown, see FIG. 12 for the lower jaw device 12).

FIG. 9 shows the transverse section through a lower jaw device 12 for the lower jaw UK, 4 in two successive situations as shown in FIG. 9a and FIG. 9b. In FIG. 9a, the incisors 51 in particular are twisted and not optimally positioned. While the outer contours of the device 12 remain largely the same, the teeth 51a, 52a, 53a, etc. on the left side of the lower tooth/dental arch of the person P and the teeth 51b, 52b, 53b, etc. on the right side of the lower dental arch of the person P are moved hidden by the dental veneers of the device inside or behind the dental veneers by the alignment function 210. In the process, the free space in which a tooth may be positioned gradually shifts from device to device relative to the externally visible tooth veneers.

This makes it possible to reproduce the final shape or final appearance of the dentition very quickly or very early on when viewed from the outside, while the alignment may continue to progress hidden by the veneering regions of the device. The molars in FIG. 9a are too close together, especially on the right, and are too far forward, see offset V9a. This may be due, for example, to the fact that a lower left molar was extracted at a young age and that a wisdom tooth on the left subsequently closed the tooth gap, while the lower right wisdom tooth was extracted.

FIG. 9b shows the situation after successful displacement of the anterior teeth by alignment functions 210 in combination with a successful large-scale displacement of the molars by shifting functions 220, which widen the tooth/dental arch. In addition, a reduction of the right-left offset of the proximal molars 57a and 57b may take place, i.e. an offset V9b is considerably smaller than the offset V9a, for example smaller than half of the offset V9a or even smaller than a quarter of the offset V9a.

As may be clearly seen from the hatched contour of the splint in the sectional view, the shape of the tooth veneers of the splints 12 visible from the outside, especially from the front, does not change significantly. The displacement of the teeth may typically be concealed. The height functions 250 and/or sliding functions 260 and/or ramp functions 270 that may be required at the same time are not shown or cannot be shown in the sectional view.

FIG. 10 shows a comparative example of an aligner splint, e.g. made of thermoformed, predominantly transparent thermoplastic film material. It shows the frontal section through the incisors of the lower jaw with a splint sitting on it. FIG. 10a shows an initial state S.1 with incisors 51 that are too far apart, i.e. more precisely a right anterior tooth Z.IV.1.1 as seen from person P and a left anterior tooth Z.III.1.1 as seen from person P, the last digit here indicating the position of the respective tooth, for example at the time when the device with the same number is first placed on the teeth. It may be seen how the predominantly transparent coating follows the contours of the teeth, whereby a small space for movement is provided in each case for the intended displacement of the incisors 51 shown towards the center, see e.g. free space FR10a. A force-transmitting contact area 13 is provided on the pressure side in each case. The force-transmitting element 13 may be an active surface that acts directly on the tooth 51 or that acts indirectly on the tooth 51 via an attachment (not shown) on the tooth 51. A resulting force vector F points from left to right in FIG. 10a to indicate the direction of the left-right displacement of tooth 51, Z.IV.1.1.

FIG. 10b shows the condition Z.n of the same teeth Z.IV.1.n, Z.III.1.n after advanced displacement towards the mid-sagittal plane SE. The gap between the incisors 51 or anterior teeth is closing. The predominantly transparent splint envelops the teeth step by step and also follows the migrating incisors 51 shown here. Characteristic of this comparative aligner technology is the largely identical layer thickness of the thermoforming foil, which partially envelops the teeth and/or the comparatively conforming reproduction of the shape of the recesses on the outer shape of the devices.

FIG. 10a also shows an occlusal region O.IV.1.1 above the tooth Z.IV.1.1 and an occlusal region O.III.1.1 above the tooth Z.III.1.1. The occlusal region O.IV.1.1 forms the upper ceiling of a recess A.IV.1.1 for the tooth Z.IV.1.1. The occlusal region O.III.1.1, on the other hand, forms the ceiling of a recess A.III.1.1 for the tooth Z.III.1.1.

FIG. 10b also shows an occlusal region O.IV.1.n above tooth Z.IV.1.n, which is identical to tooth Z.IV.1.1 but has a different position and/or inclination, and an occlusal region O.III.1.n above tooth Z.III.1.n, which is identical to tooth Z.III.1.1 but has a different position and/or inclination.

In FIG. 10a, an axis A10.1a shows the original position of tooth Z.IV.1.1. An axis A10.2a shows the original position of tooth Z.III.1.1. The occlusal area O.IV.1.1, for example, has a maximum width B10.1a. The occlusal area O.IV.1.1 has, for example, a maximum width B10.2a. Labial outer surfaces or lingually directed surfaces of the device on the walls of the recesses A.IV.1.1 or A.III.1.1 may also have similar maximum widths. A distance D10.1a (distance) lies, for example, between the occlusal areas O.IV.1.1 and O.III.1.1. A distance D10.2a lies between the recesses A.IV.1.1 and A.III.1.1.

The axes A10.1a and A10.2a are also shown in FIG. 10b to illustrate the change in the position of teeth 51. Tooth Z.IV.1.n is shifted to the right from the viewer's perspective compared to the position of the same tooth Z.IV.1.1 in FIG. 10a. Tooth Z.III.1.n, on the other hand, is shifted to the left from the viewer's perspective compared to the position of the same tooth Z.III.1.1 in FIG. 10a.

The occlusal area O.IV.1.n, for example, has a maximum width B10.1b, which is approximately equal to the width B.10.1a. The occlusal area O.III.1.n, for example, has a maximum width B10.2b, which is approximately equal to the width B.10.2a. The labial surfaces (outwards) or lingual surfaces (inwards) of the device in the region of the recesses A.IV.1.n or A.III.1.n may also have similar maximum widths. The widths B10.1b and B10.2b may be unchanged because the device S.n has also been manufactured using the deep-drawing process and the width of the teeth 51 has not changed and therefore neither have the tooth replicas in the shape used for deep-drawing.

A distance D10.1b (distance) lies, for example, between the occlusal areas O.IV.1.n and O.III.1.n. The distance D10.1b is smaller than the distance D10.1a, which is due to the thermoforming process, which now depicts the smaller distance between the teeth 51. The same may also apply to the distance between labial surfaces on the walls of the recesses A.IV.1.n and A.III.1.n.

A distance D10.2b (distance) between the recesses A.IV.1.n and A.III.1.n may be the same size as the distance D10.2a, again due to the deep-drawing process. A free space FR10b in the recess A.IV.1.n is much smaller than the corresponding free space FR10a in the recess A.IV.1.1. It should be noted here that the deep-drawing process is carried out around a model (deep-drawing mold) of the teeth 51, whereby the model (deep-drawing mold) has been extended by regions in which the free spaces FR10a, FR10b etc. will later be located.

FIG. 11 shows an embodiment with the differences to the comparative example (see FIG. 10), especially in the anterior tooth region. The lower jaw (mandibular) splints 12.1 and 12.n consist, for example, of a polymer or comprise a polymer which preferably has an aesthetically high-quality appearance similar to tooth substance and tooth enamel, i.e. is also glossy, for example, but preferably not transparent. The anterior teeth 51, which are still too far apart in FIG. 11a, should be moved so that they are closer together, but only to the extent that the distance is not required for the larger tooth veneers or for the restoration of the anterior teeth in the final completion phase or in the final restoration phase 300. The tooth veneers are already formed early during the treatment by the splint(s) 12.

In FIG. 11a, the bodies (tooth veneers, tooth replicas) of the incisors or anterior teeth 51 are already significantly larger than the partially abraded teeth 51, particularly in the occlusal direction. This is achieved by the fact that the bodies or tooth veneers of the teeth 51 extend further beyond the incisors than the regions of the splint S.1 or S.n in the comparative example according to FIG. 10. The incisors 51 are largely or completely covered by the tooth veneers in the visible area.

The splint 12.1 shows force-transmitting contact areas 13 between or at the recesses in the splint and the teeth 51. As a result, the teeth 51 are displaced in such a way that they are increasingly closer together, see for example the force vector F. Viewed in detail, the recesses for the teeth to be displaced move relative to the predominantly unchanged tooth veneers that form the splint 12.1 or are comprised in the splint 12.1. During this gradual movement of the recesses for the teeth, the wall thickness of the splint changes in the direct vicinity of the teeth to be displaced, see distance D11.2a versus distance D11.2b. The freedom of movement in the direction of the progressive displacement is created anew each time and the contact area 13 is readjusted each time in order to be able to apply force moments/torques to the teeth again with the subsequent splint.

FIG. 11b shows the displaced teeth 51 at a smaller distance. Here, the tooth veneers, e.g. N.IV.1.n and N.III.1.n, are larger than the teeth 51 or Z.IV.1.n and Z.III.1.n, in particular larger than the regions of these teeth 51 not located in the gums. However, the tooth veneers or tooth replicas, e.g. N.IV.1.n and N.III.1.n, preferably look like teeth.

The spacing of the teeth 51 may preferably be somewhat larger compared to FIG. 10b, because more space will or may be required for the larger tooth veneers. It may be characteristic of the proposed embodiment that tooth veneers which are larger than the teeth form a frontal section of the splint and that, concealed within the splint, the recesses which receive or accommodate the teeth and supply them with contact forces move stepwise relative to these tooth veneers, in the direction in which the tooth is to be displaced, so that the tooth follows the displacement relative to the tooth veneers of the splint. Furthermore, it may be characteristic that the tooth veneers may be significantly longer in relation to the comparative example in FIG. 10, for example in order to reproduce the original length for abraded teeth or to reproduce a length that extends beyond this. Neither of these features occur in the comparative aligner splints.

Thus, a free space FR11a may be much narrower than a free space FR10a, e.g. because a different manufacturing technology is used, e.g. subtractive or additive manufacturing technology versus thermoforming (pressure, vacuum and/or temperature).

A resulting force vector F points from left to right in FIG. 11a to indicate the direction of the left-right displacement of tooth 51, Z.IV.1.1.

FIG. 11a also shows an occlusal area of a dental veneer N.IV.1.1 above tooth Z.IV.1.1 and an occlusal area of a dental veneer N.III.1.1 above tooth Z.III.1.1. The occlusal area of the dental veneer N.IV.1.1 forms the upper cover of a recess A.IV.1.1 for the tooth Z.IV.1.1. The occlusal area of the tooth veneer N.III.1.1, on the other hand, forms the cover of a recess A.III.1.1 for the tooth Z.III.1.1.

FIG. 11b also shows an occlusal region of a dental veneer N.IV.1.n above tooth Z.IV.1.n, which is identical to tooth Z.IV.1.1 but has a different position and/or inclination, and an occlusal region of a dental veneer N.III.1.n above tooth Z.III.1.n, which is identical to tooth Z.III.1.1 but has a different position and/or inclination.

In FIG. 11a, an axis A11.1a shows the original position of tooth Z.IV.1.1. An axis A11.2a shows the original position of tooth Z.III.1.1. For example, the occlusal area of the tooth veneer N.IV.1.1 has a maximum width B11.1a. The occlusal area of the tooth veneer N.IV.1.1 has, for example, a maximum width B11.2a. Similar maximum widths may also have labial outer surfaces (outwards) or lingual (inwards) surfaces of the device on the walls of the recesses A.IV.1.1 or A.III.1.1. A distance D11.1a (distance) lies, for example, between the occlusal areas of the tooth veneers N.IV.1.1 and N.III.1.1. A distance D11.2a lies between the recesses A.IV.1.1 and A.III.1.1.

The axes A11.1a and A11.2a are also shown in FIG. 11b to illustrate the change in the position of teeth 51. Tooth Z.IV.1.n is shifted to the right from the viewer's perspective compared to the position of the same tooth Z.IV.1.1 in FIG. 11a. Tooth Z.III.1.n, on the other hand, is shifted to the left from the viewer's perspective compared to the position of the same tooth Z.III.1.1 in FIG. 11a.

The occlusal area of the tooth veneer N.IV.1.n has, for example, a maximum width B11.1b, which is approximately equal to the width B.11.1a. The occlusal area of the tooth veneer N.III.1.n has, for example, a maximum width B11.2b, which is approximately equal to the width B.11.2a. Labial surfaces or lingually directed surfaces of the device 12.n in the region of the recesses A.IV.1.n or A.III.1.n may also have similar maximum widths. The widths B11.1b and B11.2b may be unchanged because the tooth veneers already have the target shape or an enlarged shape.

A distance D11.1b (distance) lies, for example, between the occlusal areas of the tooth veneers N.IV.1.n and N.III.1.n. The distance D11.1b is the same size as the distance D11.1a, because the tooth veneers or tooth replicas N.IV.1.1, N.III.1.1, N.IV.1.n and N.III.1.n already have their target shape and are no longer changed in the anterior region and/or in the occlusal region and/or in the lingual region. The same may therefore also apply to the distance between labial surfaces and/or lingual surfaces on the walls of the recesses A.IV.1.1, A.III.1.1, A.IV.1.n and A.III.1.n.

A distance D11.2b (distance) between the recesses A.IV.1.n and A.111.1.n may be smaller than the distance D11.2a, as already mentioned above, e.g. due to a more precise manufacturing process that is not a deep-drawing process. A free space FR11b in the recess A.IV.1.n may be smaller than the corresponding free space FR11a in the recess A.IV.1.1 or the same size.

The devices 12.1 and 12.n shown in FIG. 11, and preferably also all other devices of the same series 100, may have been produced by subtractive manufacturing processes, e.g. milling, or by additive printing processes, e.g. 3D printing, which, compared to deep-drawing processes, allows in particular the production of greater variations in the layer thickness of occlusal surfaces or other surfaces (e.g. labial, lingual) and/or allows undercuts to be produced, for example with respect to an up-down direction of the teeth of the person P.

FIG. 12 shows sectional views through molars and anterior teeth in two different successive stages of treatment with the proposed splints using the example of the mandible mandibular, 4th stage.

FIG. 12a shows a splint with a high superstructure (e.g. with sliding surface 15) in the molar region of a lower jaw (UK not shown), which encloses a molar 56 that is too low. This molar should move upwards. In FIG. 12a, there is an unfilled cavity above the molar 56 in the recess into which the molar 56 may migrate. In the region of the anterior tooth 51, outgrowth is also possible if the forces are applied accordingly.

Accordingly, FIG. 12b shows a later state still with sliding surface 15, in which the molar tooth 56 has grown into the recess in the splint 12. The anterior tooth 51, which has also grown out, may require that the splint 12 has a deeper recess into which the tooth 51, which is now further up and therefore larger above the gum, fits. It may be characteristic that in FIG. 12 the teeth are displaced without the outer contours of the device 10 or the lower jaw (mandibular) splint 12 shown here changing. The different required wall thicknesses of the splint 12 or the device 10 are realized by suitable manufacturing processes, e.g. by precise machining of polymer materials or by 3D printing. FIG. 12 does not show that the position of the teeth may also shift sideways during treatment and that the axis of the teeth may be tilted, e.g. at the same time as or alternatively to the lifting.

The same tooth Z12a, Z12b is shifted upwards in FIG. 12b compared to FIG. 12a, see horizontal lines H1, H2. The outer contour of the devices 12 may remain unchanged, see tooth veneer N12a, N12b in the front region of the devices 12 and/or also the position of the sliding surface 15 with respect to the lines H1 in the molar region of the devices 12.

In this way, a distance D12a or D12b corresponding to the layer thickness of the tooth/dental veneer N12a or N12b in the front region may be reduced, whereby the position of the tooth veneers N12a or N12b with respect to the horizontal lines H1, H2 is unchanged and/or the outer shape/contour of the tooth veneers N12a or N12b does not change or changes only insignificantly, in particular in the front region.

FIG. 13 shows two variants of an abutment of tooth veneers 19, N13a, N13b in the anterior region that look the same when viewed from the outside. FIG. 13a shows a structure made of a solid material, whereby the outer contour is formed from the material of the visible tooth veneers N13a, while the inner contour of the material forms the receiving region for the tooth Z13a. The inner surfaces of the recess may exert forces and moments locally on the tooth Z13a as a movement stimulus.

FIG. 13b shows an arrangement that looks the same from the outside. Here, however, the device consists of two materials in two regions when viewed locally. The sectional view of FIG. 13b shows the tooth veneer 19, N13b in the outer region, preferably made of aesthetically pleasing material, in particular of non-transparent material. The region19, N13b made of this material has a larger recess on the inside than the tooth Z13b requires. This larger recess is partially filled with a second material so that a suitable recess remains for the tooth Z13b. This inner filling 18 may be softer or harder than the shell of the tooth veneer 19. In a particular embodiment, the outer tooth veneer regions remain the same over several successive devices 10.n, 10.n+1 etc. and only the shape of the recesses for the teeth in the filling region 18 of the device changes. In each case, a section through a lower jaw device 12 is shown, but the same variants may apply to the upper jaw device 11.

A narrow free space FR13a may be located between the tooth Z13a and the bottom of the tooth veneer 19, N13a, which may also be referred to as a tooth replica/veneering element. Similarly, a narrow free space FR13b may be located between the tooth Z13b and the bottom of the dental veneer 18, 19, N13b, in particular the bottom of the inner material of the dental veneer 18, 19, N13b. The tooth veneer N13b may also be referred to as a tooth replica/veneering element because, together with the tooth Z13b, it replicates the target tooth condition of this tooth Z13b.

FIG. 14 shows three selected steps in the series 100 of devices or pairs of devices 10, in particular the lower jaw devices 12.1, 12.n and 12.x, specifically an incisor tooth Z14a, Z14b and Z14c in section in three successive steps of a displacement, which may be proposed to be referred to as shifting function 220. The purpose of this displacement may be, for example, to enlarge the tooth/dental arch by pushing the teeth further outwards. Since the teeth are fixed with roots in the jawbone, the displacement referred to as shift may be, in detail, a tilting of the tooth about a low-lying tilt axis with accompanying adjustment of the tooth arch in its dimension (expansion) and/or alignment. With the proposed shifting function 220, the tooth is no longer merely tilted, but the tooth veneer or the veneering element is displaced and adjusted in size. The recess for the actual tooth 51 may be changed in the sense of tilting by applying the forces clearly above the tilting axis. With the splint in place, the replica N14a, N14b, N14c of the later restored tooth 51 appears displaced, although the actual tooth 51 is tilted in the concealed region. The displacement of the replica N14a, N14b, N14c and a corresponding restoration such as the last replica N14c may be optically or functionally more suitable for teeth that are too far inwards than a purely directly visible tilting of the teeth outwards, unless the teeth were tilted too far inwards in the initial state.

The same tooth Z14a to Z14c is shown in three different positions in which tooth veneers N14a to N14c are used, the outer contour of which, in particular the frontal outer contour, may be unchanged or constant. Axes A14a to A14c illustrate the above-mentioned tilting about a tilting axis, which is perpendicular to the plane of the blade in FIG. 14.

A distance St14a, St14b or St14c from a center line of the tooth veneers (tooth replicas) N14a to N14b to a vertical reference line, which may lie, for example, in the tilting axis, increases continuously and corresponds to the forward expansion or displacement of the tooth veneers N14a to N14b achieved in each case.

Material layer thicknesses D14a, D14b, D14c show the layer thickness of the tooth veneers (veneering elements) N14a, N14b and N14c in their anterior region. The layer thickness D14b is reduced compared to the layer thickness D14c, e.g. because the reduction in layer thickness due to the tilting of the tooth Z14b is greater than the increase in layer thickness due to the displacement of the tooth veneer N14b. The layer thickness D14c is the same as the layer thickness D14c, e.g. because the reduction in layer thickness due to the tilting of the tooth Z14c is equal to the increase in layer thickness due to the displacement of the tooth veneer N14c in relation to the vertical reference line.

FIG. 15 roughly schematically shows a special case in an intermediate phase with device 10.n consisting of maxillary splint 11.n and mandibular splint 12.n. Ramp-like functional elements 17.n develop a laterally and/or anterior-posteriorly directed force component as a ramp function 270 on contact between the lower jaw UK, 4 and upper jaw OK, 5. In the example shown, movement of the lower jaw UK, 4 too far forward in the sense of a malposition known as a Sunday bite is specifically prevented. The ramp 17.n in the device 10.n may be gradually positioned and oriented differently relative to the molars 56, 57 in order to carefully move the lower jaw UK, 4 backwards step by step into a new rest position. At the same time, a massive elevation with height function 250 and a pronounced sliding surface with sliding function 260 may be integrated. The high superstructures in the molar region may be so massive or so high that the lower jaw UK, 4 must remain below the actual resting floating position even in the contact bite. In the temporomandibular joint head 6 you may see that it is far enough away from the rear wall 7 of the temporomandibular joint in the upper jaw, see distance D15. This means that the backward displacement of the lower jaw through the ramp function 270 is a target-oriented measure. Only by shifting the lower jaw backwards in combination with the clear height function 250 with solid or hollow superstructures in the molar region may it be possible to deblock a severe crossbite, for example.

FIG. 15 shows a situation in the middle phase of a series 100 in which the lower incisors 51, 52 have already been moved behind the upper incisors. This is an example in which it may make sense to initially leave the teeth in the lower jaw UK, 4 small and only then rebuild them as part of the splint(s) using suitably large and suitably shaped tooth veneers once they have arrived in the correct position. In the shortest possible state, the anterior teeth 51/52 of the lower jaw UK, 4 may be shifted backwards more easily from the malocclusion under the upper incisors. In the upper jaw OK, 5, on the other hand, the treatment with the shape function 230 and optionally with the color function 240 is or may be applied from the very beginning. At the end of the polyfunctional treatment with x devices, the last device 10.x may also be removed according to treatment plan BP. It may then be planned to carry out a final restoration 300 of the teeth or tooth stumps with veneers, table tops, etc., whereby the position of the chewing/masticatory plane has now preferably been optimized cranially and the abutment heights above the remaining teeth may be retained.

FIG. 16 illustrates a computer system 1600 that may perform the method steps mentioned in this document, particularly in an automated or semi-automated manner. The computer system 1600 may include:
a computer 1610,
an optional input device I, e.g. one or more buttons, an alphanumeric keyboard, a computer mouse, a trackball, a data receiving unit (e.g. for receiving data via the Internet or an intranet), and/or
an optional output device O, e.g. a screen (e.g. a touch-sensitive screen), or a data transmission unit (e.g. for sending digital data via the Internet or an intranet).

The input device may be used, for example, to “move” digital representations of the person's teeth on the screen. Alternatively or cumulatively, calculation processes may be started to calculate the device pairs 10.

The 1610 computer may comprise:
one or more processors P configured to execute program instructions, e.g. program instructions of an operating system (Windows (may be a trademark), IOS (Input Output System) (may be a trademark), Linux (may be a trademark), etc.), in particular program instructions of a user program for executing the method steps mentioned in this document or a part thereof, and/or
a memory unit M designed to store program instructions and/or data, e.g. data generated during the execution of the program instructions. The memory unit M may comprise volatile memory (e.g. RAM (Random Access Memory, DRAM (Dynamic RAM), etc.) or non-volatile memory (SSD (Solid State Device, EPROM (Electrical Erasable Read Only Memory), etc.), and/or
at least one computer program or computer program product, e.g. a BIOS (Basic Input Output System), which may be a stand-alone program or part of an operating system OS (Operating System), and/or
an optional data bus 1620 between the processor(s) P and the memory unit M or other units of the computer 1610 or the computer system 1600.

There may be other units that are known to the skilled person, e.g. power supply, Internet or intranet connection, e.g. based on the Internet Protocol IP, etc.

A manufacturing machine Ma, e.g. a CAM Computer Aided Manufacturing machine or a CNC (Computerized Numerical Control) milling machine or a 3D (3 dimensional) printer, may be coupled to the computer system 1600, e.g. locally or via a data transmission network. A scanning device S (scanner) may also be coupled to the computer system 1600, for example to scan the teeth of the person P or a dental model of the teeth of the person P, in particular electronically and/or in the optical domain.

In the following, further embodiments of a series of devices are explained, which enable a preferably neuromuscular relearning of the position of the chewing plane. The further embodiments may be combined with the embodiment(s) of FIGS. 1 to 16. Alternatively, the further embodiments may also be used separately from the embodiments of FIGS. 1 to 16.

A method for manufacturing polyfunctional dental devices is explained. In a preferred embodiment, the polyfunctional devices 10.n may not only have an aligner function 210, optionally with or without attachments. They may also additionally or alternatively have the function of setting a new chewing plane or enabling neuromuscular learning of a new position of the chewing plane. The devices may therefore have recognizable features that enable relearning of the new position of the chewing plane.

The aim of the series 100 of devices 10 may be to arrange the teeth more beautifully and/or medically more appropriately in the arch, to control misalignments, to enlarge the tooth bodies where necessary and/or to set a physiologically cranially optimized chewing plane or a target denture plane or target dentition plane as far as possible, e.g. according to “CranioPlan” (may be a registered trademark) or according to Hornung. For this purpose, contact planes may be used which form the systematic separation plane between the upper jaw part 11 and the lower jaw part 12 of the devices 10.

The position of the new contact plane may be determined, for example, by determining an ideal position of a contact plane or chewing/masticatory plane from the digital data of the skull in a first step. Several optional methods are available for this purpose. In this document, for example, the methods “CranioPlan” (may be a registered trademark) (EP 3 332 731 A1) according to Hornung and 3D Marker or 3D Ruler (WO 2020/141134 A1) according to Saxler-Hornung are explained in more detail.

Document EP 3 332 731 A1 is hereby incorporated by reference into this document for all legal purposes. Further, document WO 2020/141134 A1 is hereby incorporated by reference for all legal purposes.

However, this ideal position may no longer be completely achievable due to the anatomical limitations of the temporomandibular joint, e.g. because the temporomandibular joint would be levered out on one side. In such a case, the best possible approximation to the ideal position of the upper jaw-lower jaw contact plane (upper jaw-lower jaw) may be achieved, whereby the temporomandibular joint may be stressed as anatomically correctly as possible.

The process may be represented or realized by a computer-implemented technology.
1. the input or input data may be the following digital data:
   3D (three-dimensional) image recordings, preferably voxel data (voxel−volume element) of the material density of the head, e.g. with teeth, eye sockets and inner ear on the right and left.
   In addition, 3D reconstructed scans (scans) of an intraoral scanner may be possible but may not be sufficient, which may be important for the reproduction of the gums.
2. The ideal target contact plane/chewing plane may be determined as follows:
   2a) The X-ray data may be segmented into teeth, bones and gums,
   2b) The teeth of the upper jaw (maxilla) OK and lower jaw (mandible) UK may form a dentition in the initial state,
   2c) A starting contact plane 310, SKE for the upper jaw/lower jaw OK-UK contact (occlusion) may be assigned to the dentition in the initial state. For example, a pentagonal plane virtual/digital surface may be suitable for this purpose,
   2d) An idealized position of the ideal contact plane 350, IKE may be derived from the cranial digital data of the anatomy of the skull, i.e. it may be determined where the ideal contact plane 350, IKE should be located if it were possible. For this purpose, for example, a virtual/digital 3D CranioPlan (may be a registered trademark) construction according to Hornung (EP 3 332 731 A1) may be carried out or a virtual/digital 3D Ruler according to Saxler-Hornung (WO 2020/141134 A1) may be fitted into the digital data of the cranial skeleton.
3. The real target contact level 330, ZKE may be determined as follows:
   3a) The freedom of movement of the mandible lower jaw relative to the maxilla upper jaw in the temporomandibular joint may be determined,
   3b) The start contact plane 310, SKE may be shifted by interpolation in the direction of the ideal contact plane until at least one stop criterion is reached in the temporomandibular joint,
   3c) This stop contact plane or an approximation thereof may be used as the target contact plane 330, ZKE for the construction of the series 100 of devices 10.
4 The devices 10.1 . . . 10.x may be calculated as follows:
   4a) The transition from the start contact level 310 to the target contact level 330, ZKE may take place quite quickly, e.g. in less than 40 percent of the x stages or steps, preferably within a maximum of 5 stages until the target contact level 330, ZKE is reached, particularly preferably a maximum of 3 stages.
   4b) Optionally, an exaggeration for a number of y stages towards a position of a training contact plane 340, TKE may initially take place in the further stages. The training contact plane 340, TKE may be suitable for performing a special stretching and movement training of the temporomandibular joint and/or for facilitating the relearning of the position of the chewing plane, e.g. in comparison to using the target contact plane 330, ZKE for training. During training, the person P may tense the chewing/masticatory muscles around an unstable equilibrium position until lateral eruption or lateral movement of the lower jaw relative to the upper jaw occurs. Alternatively or additionally, the training may take place implicitly during chewing if the device(s) 10 remain in the mouth during meals.
   4c) The individual target contact plane 330, ZKE for the devices 10.n consisting, for example, of upper jaw device 11 and lower jaw device 12 may then be adjusted or set, for example, by an arrangement of bodies or tooth veneers (veneering element(s)) which are replaced by the person's remaining teeth at the end of treatment or which are replaced by corresponding dentures in a final restoration 300, e.g. dental prostheses. The target contact plane 330. ZKE for devices 10.n consisting of, for example, each upper jaw device 11 and lower jaw device 12 may be set, for example, by an arrangement of molded bodies or tooth veneers (veneering element(s) which are replaced by the person's remaining teeth at the end of the treatment or which are replaced in a final restoration 300 by corresponding dentures, e.g. dental prostheses such as model casting prosthesis, telescopic prosthesis, attachment prosthesis, implant-supported prosthesis (e.g. bar prosthesis, push-button prosthesis), veneers, inlay, dental crown, artificial tooth, dental implant, etc.).
5 The transition to the subsequent restoration, e.g. final restoration 300, of the dentition may take place as follows:
   5a) At the end of the treatment, a dental and/or esthetic restoration of the single teeth, bridges or implants may preferably be carried out, whereby the target contact plane 330, ZKE is set as far as possible or, if possible in the meantime, even a better plane, which may, for example, be closer to the ideal contact plane 350, IKE or to a new ideal contact plane 360, IKE II.
   5b) Another cranial analysis may be performed for this purpose. This may lead to new results and a new ideal contact level 360, IKE II, because the cranial situation and/or the anatomy of the temporomandibular joints may also change, even slightly, over the course of several months under altered loading.

Methods and devices or programs (software) may be used, as explained, for example, in DE 10 2012 002 817 B4 (Knorr, Hornung). This document is incorporated by reference for all legal issues and purposes. For example, the following digital volume tomographs (DVT, Digital Volume Tomography) may be used for imaging:
Acetone Whitefox—patient positioning seated or standing: volume cylinder, 599 images, FOV (Field of View) 60 mm (millimeters)×60 mm, 80 mm×80 mm, resolution 0.15 μm (micrometers), 105 kV (kilovolts), 9 mA (milliamperes), pulsed, dental scan 3600 (degrees), 25 seconds (sec.), effective 6.8 sec., focal spot 0.5, manufacturer: Satelec (Acetone Group)—de Götzen—Milano.
NewTom 5G—supine patient positioning: volume cylinder, 659 images, FOV 60 mm×60 mm, 80 mm×80 mm, resolution 0.125 μm, 110 kV, 16 mA, pulsed, dental scan 360°, 36 sec, effective 7.3 sec, focal spot 0.3, manufacturer: QR srl—Verona IT.

Digital DICOM (Digital Imaging and Communications in Medicine, may be a trademark) data may be generated during image acquisition.

3D software may be used for segmentation (object masking) of the 3D DICOM data set, e.g. the OnDemand3DTMApp program (version 1.0 or higher). OnDemand3DTMApp enables, for example, the management of 2D (two-dimensional) and 3D (three-dimensional) medical images. Extensive 2D and 3D tools for analyzing, formatting and segmenting the data are provided.

In order to perform segmentation (object masking) of data representing tissue structures and the like (e.g. air, fatty tissue, water, bone, root cement, dentine, enamel and other materials in the dentition based on their Hounsfield densities), it may be necessary to calibrate the CBCT/DVT device according to the Hounsfield scale. Each voxel may then be clearly assigned to values between −1000 and +3000 Hounsfield. For example, air has a value of −1000 Hounsfield, fatty tissue of −100 Hounsfield, water of 0 Hounsfield, bone 500 Hounsfield to 1500 Hounsfield; implants and tooth enamel of 3000 Hounsfield. Different values may be indicated by different colors.

Subsequently, individual STL files (originally stereolithography, today also other assignments) or files with another suitable format (e.g. VRML (Virtual Reality Modeling Language), SLP, OBJ, etc.) may be read or imported into another software, e.g. into the 3D-Tool Version 10 Basic software or another program. The 3D-Tool software or the other program may be used for professional data preparation for subsequent rapid manufacturing, in particular rapid prototyping. An alternative CAD program is, for example, the Blender program.

The applicable processes for rapid manufacturing, also known as rapid prototyping, may include processes that start directly from the virtual (digital), computer-generated model and produce the corresponding real model. Examples of such processes are milling processes (e.g. contour milling processes) or generative or additive manufacturing processes (3D printers, laser sintering, stereolithography processes or methods).

The final data set may be transferred to a milling machine Ma, e.g. a Girrbach (may be a registered trademark) milling machine, to produce the dental prosthesis.

Details of the procedure for generating the digital data for describing the devices using the digital tooth and/or skull data are described above or below, e.g. Boolean subtraction, forming intersection sets, etc. These methods are generally known to the skilled person and are therefore only mentioned here but not described in detail.

The difference between start contact level 310, SKE, target contact level 330, ZKE and ideal contact level 350, IKE may be described as follows. The start contact plane 310, SKE may be given by the current contact between the upper jaw OK and the lower jaw UK in the start state. The first device of the series may include the start contact plane 310, SKE. In another embodiment, the first device of the series may already include a contact plane that differs from the start contact plane 310, SKE.

If the occlusion shows clear misalignments, the starting contact plane 310, SKE may be unphysiologically displaced, i.e. not corresponding to normal life processes. The bite may be maldeveloped or dysgnathic, e.g. overbite or underbite. The temporomandibular joints may have experienced incorrect loading, may have adapted and may no longer be optimally developed.

The ideal contact plane 350, IKE may be adjusted in view of the existing cranium and its biomechanics. This would also be possible if the lower jaw were not in the adjusted and therefore not ideal state.

The target contact level 330, ZKE may be as close to the ideal contact level as possible without impairing the temporomandibular joint. The training contact plane 340, TKE may be temporarily adjusted. This results in the effect of a large-volume orthosis.

Some of the following figures are already known from WO 202/141134 A1. This document is incorporated by reference into this application for all legal purposes. There, too, the training contact plane is tilted in two dimensions relative to the start contact plane, but only a single orthosis is produced and not a series of devices with any additional functions and further displaced planes/chewing planes. The following illustrations may be a little too clear. In practice, it is often only possible to shift a few millimeters or even less.

A fairly rapid displacement of at least a few millimeters, e.g. in the range of 2 mm to 5 mm, into the training contact plane may be performed in order to achieve myofunctional and neurophysiological relearning during training. Therefore, it may be functionally important to displace the chewing/masticatory plane quickly and almost somewhat excessively in order to set the target position after n=19 devices 10, for example, and maintain it until the last device, e.g. 10.24 or 10.25, see, for example, the explanations for FIG. 19.

FIG. 17 shows a device 10 for displacing the chewing/masticatory plane with a training function for relearning the position of the chewing/masticatory plane. FIG. 17 shows in its upper part two small schematic views and below a larger sectional view of a skull 1, 1200 with lower jaw mandible, 4 and upper jaw maxilla, 5 and inserted device 10, 1300 roughly schematically, i.e. without details of the design of the device 10 itself, because the focus is primarily on the orientation of the contact planes. The device 10, 1300 may comprise sliding contacts which enable lateral sliding, for example of an upper jaw device 11 of the device 10, 1300 relative to a lower jaw device 12 of the device 10, 1300. In addition, the device 10, 1300 may also comprise at least one further additional dental function or several additional dental functions, see for example functions 210 to 290 as explained above with reference to FIG. 1.

In FIG. 17c, i.e. in the lower part of FIG. 17, the original contact plane 310 may be seen on the sectional view of teeth 56/57. The section through the mandible UK, 4 and through the skull 1, 1200 with nasal cavity may be recognized. A symmetry plane 2, 1250 of the cranium and a symmetry structure 3 are shown, which may depend in particular on the position of the eyes/eye sockets (orbita) and/or the zygomatic arches and/or the position of the inner ear regions on the right and left. Suitable features of the inner ear regions are, for example, bones of the inner ear and/or parts of the vestibular organ, the accelerometer organ, the eardrum, the cochlea or other prominent areas/regions or anatomical landmarks.

In this example, the adjusted or set training contact plane 340, TKE is identical to the ideal contact plane 350, IKE, which is perpendicular to the sagittal symmetry plane and the vertical symmetry axis 2, 1250. If you look at the position of the mandibular bones in FIG. 17c, you may see that they are at approximately the same height in the ideal contact plane, while the starting contact plane 310, SKE is at an angle to it.

If, for example, the training contact level 340, TKE deviates so much from the start contact level 310, SKE that the “jump”, i.e. the necessary change to a device 10 with a contact level in the position of level 340, 350 causes discomfort to the patient or if there are other reasons, a less deviating contact level 330 (not shown) may also be set, which lies between the start contact level 310, SKE and the training contact level 340, TKE.

In detail, FIG. 17 shows a training device 10, 1300 with separating sliding plane 1301, TGE or with training contact plane 340, TGE in the position of the ideal occlusal plane in a rough schematic representation. FIG. 17a schematically shows the bony structures of the cranium 1, 1200 with the upper jaw OK, 5, 1220 and the lower jaw UK, 4, 1230, which does not belong to the cranium 1, 1200. A dental arch 1221 of the upper jaw OK, 5, 1220 and a dental arch 1231 of the lower jaw UK, 4, 1230 is covered here by the device 10, 1300. The bony structures 1200a of the cranium 1200, particularly in the area around the eyes, i.e. not those in the upper jaw itself, may be analyzed to define the position and directional orientation of the main axes of the training device 10, 1300. The transverse axis 1215, see e.g. FIG. 18, and the vertical axis 1250 as well as the anterior-posterior axis 1205, which is not visible from the front, may be decisive, see e.g. also FIG. 18.

FIG. 17b schematically shows the lateral view of the bony structures of a cranium (skull) 1, 1200 in virtual 3D space, whereby here the head is tilted so far forward that the anterior-posterior axis 1205 of the cranium 1200 runs horizontally in the image. In FIG. 17b, the transverse right-left axis 1215 runs perpendicular to the image, i.e. vertically out of the image plane or vertically into the image plane. The idealized occlusal plane 1201 is defined by these two axes 1205 and 1215 and is perpendicular to the vertical axis 1250 and comprises the axis 1205. The separating sliding plane 1301, TGE or the training contact plane 340 of the device 10, 1300 may be positioned exactly such that it coincides with the idealized occlusal plane 1201.

In the sectional view or in the side view, the anterior-posterior axis 1305 of the device 10, 1300 thus lies on the anterior-posterior axis 1205 of the cranium 2, 1200. The vertical axis 1350 of the device 10, 1300 runs parallel to the vertical axis 1250 of the cranium 2, 1200.

FIG. 17c shows the frontal view with superimposition of the contours of the device 10, 1300 with separating sliding plane 1301, TGE or with training contact plane 340, TKE over the frontal section shown in FIG. 17c. The separating sliding plane 1301 or the training contact plane 340 lies as precisely as possible on the idealized occlusal plane 1201 or the ideal contact plane 350, IKE. This FIG. 17c clarifies the positioning of the biomechanically and neurophysiologically important position and orientation of the separating sliding plane 1301 or training contact plane 340, TKE between the upper part 11, 1320 and the lower part 12, 1330 of the device 10, 1300. In practice, this separating sliding plane 1301 or training contact plane 340, TKE results individually from the form fit of the device parts 11, 1320 and 12, 1330 used, if these are manufactured precisely in accordance with the dental arches. The device 10, 1300 may, for example, be a training device or an orthosis which has, for example, further dental functions 210 to 290. The device 10, 1300 with the at least two parts 11, 1320 and 12, 330 may also be constructed asymmetrically on one side and/or in several parts. The device 10, 1300 with the at least two parts 11, 1320 and 12, 330 may also be a device of a series 100, which may include at least one training device or several training devices. Several devices 10 of the series 100 may also have sliding contact areas which enable a sliding movement, in particular flat sliding surface areas or other sliding contact areas.

In contrast to the current chewing plane with the transverse direction 1216, the transverse plane T1 of a 3D structural marker (3D marker) 500, which is aligned with the transverse direction 1215, may serve as a reference plane for planning and manufacturing the device 10, 1300, in particular for training the temporomandibular joint muscles or for treating the temporomandibular joint. The direction of the anterior-posterior axis 1205 may also lie in the transverse plane T1. This may be the idealized occlusal plane T1a or the reference plane T1a and thus the plane in which the lateral sliding movement of the lower jaw UK, 4, 1230 with inserted device 10, 1300 relative to the upper jaw OK, 5, 1220 is possible.

In two-part devices 10, 1300 with separating sliding plane 1301 or training contact plane 340, TKE, digital or virtual preforms for the manufacture of parts 11, 1320 and 12, 1330 are oriented for this purpose during planning in digital or virtual 3D space in a preferred procedure, or the device 10, 1300 is virtually oriented with its separating sliding plane 1301 or training contact plane 340, TKE so that this separating sliding plane 1301 or training contact plane 340, TKE lies in the orientation of the idealized occlusal plane 340, 1201, IKE. In the particularly preferred embodiment, the angular orientation and vertical position of the separating sliding plane 1301, 340, TGE, TKE is identical to the transverse plane T1 or the reference plane T1a, which was determined using the 3D structure marking 500.

FIG. 18 shows an image of a digital image of a head or skull 1, 1200 schematically from the side with a digital device 10, 1300 inserted to displace the chewing plane. FIG. 18 shows the head schematically from the side with a spatial orientation in which the coordinate system of the skull 1, 1200 is vertical. In this spatial orientation, the anterior-posterior main direction 1105 of the chewing/masticatory plane 110 appears obliquely inclined with respect to the transverse main direction 1205 of the skull 1, 1200, along which the separating gliding plane 1301, 340, TGE, TKE is oriented. The transverse main direction 1305 of the device 10, 1300 has thus been placed exactly in the orientation of the main direction 1205 of the skull by suitable positioning of the blanks or the entire blank in 3D image space, in order to generate the training device as a superimposition of the contours of the blanks and the contours of the dental arches together with the air gap, for example by Boolean operations using the digital data of the teeth and the digital data of the blank. Such operations are common in 3D programs and are called, for example, subtraction, intersection (intersect), etc. The same applies to the alignment in the other 2 spatial angles, which may be seen from the front and from above, but not from the side. The role of the optional air gap has already been explained above. The gap is shown in more detail below in FIG. 23. Optional, essentially point-shaped contact points of the device 10, 1300 on the teeth may be added manually, semi-automatically or automatically with the aid of CAD (Computer Aided Design) programs if an occlusal gap is also required.

FIG. 19 shows a partial treatment plan BP19 concerning the staging (sequence) for functions for shifting of the chewing/masticatory plane or functions that enable neuromuscular relearning of the chewing/masticatory plane. FIG. 19 shows the staging for the series 100 of devices 10. to 10.x starting from a start state to a target state, which is to be achieved with device 10.x.

The downward-pointing axis of the coordinate system shown in FIG. 19 indicates the devices 10 of the series 100 according to their order. In the embodiment example, there are 24 devices 10.1 to 10.24. In other embodiments, there are x devices in the series 100, where x may be greater than or equal to 25, for example. Series with less than 20 or less than 24 devices may also be used. The dimension to the right or the axis pointing to the right of the coordinate system shown in FIG. 19 is a measure of how far the inclination of the contact plane deviates from the start contact plane 310. For example, only one (room) angle may be included in this measure, e.g. angle W1 or angle W2 or angle W3. Alternatively, this measurement may also cover several of these angles, e.g. angle W1 and angle W2. In other examples, the measurement may additionally or alternatively relate to position coordinates of the chewing plane or chewing surface and/or a rotation about a surface normal of the chewing plane, for example in order to change the position of a center line of the teeth of a dental arch.

The position of the contact plane in the start state is shown by a start contact plane 310, SKE. The position of the ideal contact plane 350, IKE is also shown. The position of the ideal contact plane 350, IKE may be derived from the cranial symmetry, see e.g. FIG. 17. The contact plane 320.1, 320.2, 320.3, 320.4 set in the devices 10.1, 10.2, 10.3 and 10.4 is quickly adjusted to the angular inclination or position 340, i.e. to the training contact plane 340, TKE to effectively reprogram the neuromuscular functions that actuate the masticatory muscles. The devices 10.1, 10.2, 10.3 and 10.4 may have sliding contact areas and possibly other additional dental functions.

This allows a movement pattern corresponding to the target contact plane 330, ZKE to be learned, especially quickly. In the embodiment example shown in FIG. 19, the ideal contact plane 350, IKE is not adjusted or set because this would overload the temporomandibular joint in its fiber structures and cartilage. After the training phase, a target contact plane 330, ZKE is set from device 10.n, where n is, for example, 19, which is clearly different from the start contact plane 310, SKE but is not quite as ideal as the ideal contact plane 350, IKE when viewed cranially. This may be due to the already severely deformed temporomandibular joint region. The devices 10.n to 10.x may no longer comprise optional sliding contact areas.

There are also cases in which the target contact plane ZKE may be adjusted or set to the ideal contact plane 350, IKE, especially if the deviation from the starting chewing plane 310, SKE is not so great. In another embodiment, the ideal contact plane 350, IKE is set because the temporomandibular joint allows this in its fiber structures and cartilage.

In detail, the process shown in FIG. 19 is as follows:

1) In a first phase PH1: From an arrangement AOA (device 10.1) or contact plane 320.1 via an arrangement AOB (device 10.2) or contact plane 320.2 via an arrangement AOC (device 10.3) or contact plane 320.3 to the training contact plane 340, TKE in an arrangement AOD (device 10.4), whereby the deviation from a start chewing plane or start contact plane increases continuously and changes rapidly in comparison to the entire course shown in FIG. 19. In addition, the curve shown in FIG. 19 is set to a training contact plane 340, TKE, which is closer to the ideal contact plane 350 than the target contact plane 330, ZKE, which is visible as overshoot US1. In another embodiment example, the target contact plane 330, ZKE may be set directly, whereby there may then be a training phase which, for example, has the same length as the training phase PH2 shown in FIG. 19 or may even be longer. It is assumed that the devices 10.1, 10.2 etc. are worn according to a predetermined time sequence, e.g. with a weekly or fortnightly change. The devices 10.1, 10.2, 10.3 and 10.4 may have sliding contact areas and possibly other additional dental functions, but do not have to. The contact areas or the sliding contact areas may change, in particular with regard to their arrangement relative to the receiving areas for the teeth or tooth elements in the devices 10.1, 10.2, 10.3 and 10.4, since the training sliding plane TGE or TKE is intended to change. Alternatively, no sliding contact areas may be used in the devices 10.1, 10.2, 10.3 and 10.4 or in some of these devices, whereby the chewing plane or contact plane may nevertheless be displaced as described because contact areas are used which are uneven, for example.

2) In a second phase PH2: The AOD arrangement is retained, e.g. also in the devices 10.5 to 10.13. In the second phase, the training contact level TKE is thus available for neuromuscular (re)training of the chewing/masticatory muscles. Training may take place implicitly during chewing if the devices 10.5 to 10.13 remain in the mouth during meals. Conscious training may also be carried out in addition or as an alternative. The duration of training is, for example, between 10 minutes per day and one hour per day, whereby the training time may also be divided into several training phases per day. During training, exercises may be carried out according to an exercise plan.

The devices 10.5 to 10.13 may have sliding contact areas and, if necessary, other additional dental functions. The sliding contact areas may remain unchanged, since the training sliding plane TGE or TKE should remain unchanged. In contrast, the additional dental functions 210 to 290 or at least some of the additional dental functions 210 to 290 of the devices 10.5 to 10.13 may differ from each other. On the other hand, there may also be additional dental functions 210 to 290 on these devices that remain unchanged, e.g. shape function 230 (dental veneer/veneering element) and/or color function 240. The unchanged functions may already be present in the devices 10.1 to 10.4, but do not have to be. There may be a marginal gap in the devices 10.5 to 10.13 or in some of these devices 10.5 to 10.13, which may favor, for example, neuromuscular relearning of the position of the chewing plane.

Alternatively, instead of sliding contact areas, contact areas may also be used in the training phase that do not allow sliding or only allow comparatively limited sliding, i.e., for example, uneven contact areas between the upper jaw and lower jaw or upper jaw device and lower jaw device or one of these devices and teeth/tooth element of the opposite side that are anchored directly in the jaw.

3) In a third phase PH3: The contact plane is shifted back again, whereby the target contact plane 330, ZKE may be set immediately or, as shown in FIG. 19, an overshoot US2 may occur in the other direction in relation to the position of the target contact plane 330, ZKE and to the overshoot US1. The overshoot US2 is, for example, smaller than the overshoot US1 but may also be just as large or larger. There may be medical or other reasons for using the overshoot US2, e.g. to release blockages in the teeth or similar. The shifting back may take place via an arrangement AOE (device 10.14) to an arrangement AOF (device 10.15), whereby the arrangement AOF may also be retained for the devices 10.16 and 10.17, for example. Finally, the arrangement AOF may be changed to an arrangement AOG which corresponds to the position of the target contact plane 330, ZKE, e.g. using two devices 10.18 and 10.19. The devices 10.13 to 10.19 may comprise sliding contact areas, but do not have to. Sliding may facilitate, for example, neuromuscular relearning of the position of the chewing plane. An optional edge gap may also promote neuromuscular relearning, particularly in connection with sliding planes.

Alternatively, in the third phase PH3, instead of sliding contact areas, contact areas may also be used that do not allow sliding or only allow comparatively limited sliding, i.e., for example, uneven contact areas between the upper jaw and lower jaw or upper jaw device and lower jaw device or one of these devices and teeth/tooth element of the opposite side that are anchored directly in the jaw.

4) In a fourth phase PH4: The contact level of the arrangement AOg may be retained, see for example devices 10.20 to 10.24, whereby device 10.24 may be the last device 10.x of the series 100. In the fourth phase, for example, training may no longer be required. Thus, the devices 10.19 to 10.24 may, for example, implement or realize alignment functions 210 or other functions 220 to 290. The devices 10.19 to 10.24 may be free of sliding contact areas. Alternatively, the devices 10.19 to 10.24 or a part of these devices may include sliding contact areas.

Accordingly, FIG. 19 shows a chronological sequence of planes/chewing planes that were first created digitally and then in combination with dental arches and devices 11, 12. The graphic shows the planned planes/chewing planes used in the 3D design to the right and the consecutive numbers of the devices 11, 12 to the bottom. It should be noted that the chewing plane that actually becomes effective may only result from the fact that the devices 11, 12 are placed on the dental arches, e.g. if, contrary to the planning, only the lower jaw device is used and the upper jaw device is not, the biomechanical and neurophysiological effect of the currently generated chewing plane is not as planned. The thick black curve shows the planned course, i.e. the chewing/masticatory plane is initially displaced strongly and quickly in the first pairs of devices, whereby the teeth should not or cannot follow so quickly.

In the first phase PH1, for example, the occlusal surfaces of the device are raised on the side facing the opposite side and the devices become thicker, preferably in the molar region, i.e. height elements are used here. At the same time, the veneers in the incisor and canine region may be made larger and longer, as long as this does not hinder the rearrangement of the tooth bodies. This very quickly creates an esthetic visual impression that resembles the treatment result. The device is comfortable to wear—especially as long as the temporomandibular joints are not injured—and is very well accepted by patients due to the esthetic advantages and is not taken out of plan. This seemingly minor point is very important for the correct sequence. After all, if the device is removed off schedule, progress is considerably delayed and relapses and disorders may even occur. It has been shown that the aesthetic and functional design of the front teeth and canines also offers great advantages when eating, because biting is also greatly improved with the optimized shape of the teeth. In contrast to orthoses, the devices do not have to be removed for food intake. However, cleaning as with third teeth is necessary.

If a therapy with displacement of the tooth bodies deviates from the plan of the tooth body positions in the real course, the pre-calculated 3D contours of the devices 11, 12 would no longer fit. In such a case, a new 3D calculation of the devices 11, 12 may be carried out as soon as the real positions of the tooth bodies have been correctly recorded again. These may then serve as a new starting point for the rest of the process. In such a case, the chewing/mastication plane was not quite right before, but this will not cause any significant disturbances compared to before, but at most a delay.

FIG. 20 shows a para-sagittal section through a device, e.g. the device 10.4 for displacing the chewing plane, i.e. a section which lies, for example, parallel to a mean or median sagittal plane Sm. The device 10.4 comprises an upper jaw part 11 and a lower jaw part 12 as a pair of devices as well as a receiving region 1124 for teeth of the upper jaw OK, 5, 1220 and a receiving region 1134 for teeth of the lower jaw UK, 4, 1230.

The beads shown in FIG. 22 above may be optional.

The adjusted/set contact plane in the device 10.4 is a training sliding plane 340 and the contact surface in this case shown is smooth and sliding without ramp functions. This is a particular case where the device 10.4 is given a pronounced orthotic function 275. This is a training state in which the contact plane 340 deviates very strongly from the start contact plane 310. The target contact plane 330 deviates less from the start contact plane in the embodiment example shown. The black area is the section through the material of the device 10.4. In special cases, the teeth of the lower jaw may protrude into the material of the upper part.

FIG. 20 shows the training device 10.4 from the side on the dentition with a strong inclination, see for example FIG. 18. It is shown from the side that the separating sliding plane 110 of the device 10.4 does not lie exactly in the chewing plane 111, e.g. in the starting chewing plane 310, SKE. Compared to the chewing plane 111, 310, SKE, the separating and sliding plane 110 is lower at the back (on the right in the picture) at the molars.

The molars of the lower jaw may extend far into the area of the upper jaw section 11. A correction of the training device may therefore optionally be necessary. The correction may be a parallel shift of the transversal plane or separating-sliding plane 110, TGE, TKE upwards or downwards, parallel to plane T1, in order to bring the wall thicknesses on the remaining remnants of the milled blank/preform to a feasible minimum value or so that the opening of the teeth on the opposite side is not too large or so that the wall thicknesses on the training device are suitably thick. The sliding direction seen from the front and from the side does not change when the transverse plane is shifted upwards or downwards. Alternatively, no additional displacement may be necessary.

Cusp-like (plateau-like) projections 1125 may serve as a support point or support region in the upper jaw device 11 and may be in contact with teeth or tooth elements of the upper jaw OK, 5. Cusp-like (plateau-like) projections 1135 may serve as a support point or support region in the lower jaw device 12 and may be in contact with teeth or tooth elements of the lower jaw UK, 4. The projections 1125, 1135 may have approximately the same heights and thus also reflect the profile of the receiving regions 1124, 1125.

Distances between contact surfaces on the protrusions 1125 and the training glide plane TGK may define a difference D1.

If no lateral edge gap 1122, see for example FIG. 22 or FIG. 23, and thus for example also no occlusal gap is used, the protrusions 1125, 1135 may be omitted, because then in the case of the protrusions 1125 material of the upper jaw device 11 and in the case of the protrusions 1135 material of the lower jaw device extends in the entire occlusal region up to the teeth/tooth elements. However, the aforementioned arrangements of the receiving regions 1124, 1125 with respect to the training sliding plane TGK may remain essentially unchanged.

FIG. 21 shows a para-sagittal section through a device, e.g. 10.1, for displacing the chewing plane, wherein the device, e.g. 10.1, may be located in the order of the devices 10 of a series, e.g. 100, for example before the device 10.4 shown in FIG. 20.

The device 10.1 comprises projections 1125 which correspond to the projections 1125 of the device 10.4 and are located, for example, at the same tooth positions as these projections 1125 of the device 10.4. Likewise, the device 10.1 also comprises projections 1135 which correspond to the projections 1135 of the device 10.4 and may, for example, be located at the same tooth positions as these projections 1125 of the device 10.4.

Distances, see double arrows in FIG. 21, between contact surfaces on the protrusions 1125 and the training sliding plane TGK may define a difference D2. The difference D2 may be different from the difference D1 due to the displacement of the chewing plane and in the embodiment example is somewhat smaller than the difference D1, for example smaller by at least 10 percent of the difference D1. The differences in the values of the differences D1 and D2 may clearly show the different arrangement of the receiving regions 1124, 1125 relative to the training sliding plane TGK shown in FIG. 21. In particular, an angle W2a between the starting chewing plane 310, SKE and the training sliding plane TGK shown in FIG. 21 may be smaller than an angle W2b between the starting chewing plane 310, SKE and the training sliding plane TGK shown in FIG. 20, for example by at least 10 percent of the value of the angle W2b.

In other embodiments, the angle W2b may be smaller than the angle W2a. The angles W2a, W2b may change equally on the right and left or also differently on the right side of the teeth/tooth elements compared to the left side.

If no lateral edge gap 1122, see for example FIG. 22 or FIG. 23, and thus for example also no occlusal gap is used, the protrusions 1125, 1135 may be omitted, because then in the case of the protrusions 1125 material of the upper jaw device 11 and in the case of the protrusions 1135 material of the lower jaw device extends in the entire occlusal region up to the teeth/tooth elements. However, the aforementioned arrangements of the receiving regions 1124, 1125 with respect to the training sliding plane TGK may remain essentially unchanged.

FIG. 22 shows in its upper part a sectional view through a sliding surface of a device for displacing the chewing/masticatory plane and in its lower part a top view of the device for displacing the chewing/masticatory plane. FIG. 22 schematically shows a first smooth sliding surface 1123 which may coincide as precisely as possible with a cranially oriented transverse plane which lies parallel to the axes 1110 and 1115. FIG. 22 also shows the chewing/masticatory plane 1111, e.g. the starting masticatory plane 310, SKE as seen in section from the front inclined obliquely to the direction of the transverse axis 1110. The starting chewing/masticatory plane may also be inclined obliquely to the first smooth sliding surface 1123 as seen from the side in sagittal section (not shown in FIG. 22, see e.g. FIG. 21). However, this does not have to be the case.

If you look at the teeth with the usual dental numbering 1 to 7 starting from the central incisor, you may see the clear asymmetry, which in the example may be due to the fact that molar 7 is missing on the right in the picture. The contact points 1125 may still be oriented to cranial symmetry planes. A connecting line between the support points 1125.1 right tooth 3 and left tooth 3 may therefore not be symmetrical to the dental arch, but may be positioned differently according to the cranial symmetry. Similarly, the posterior connecting line right-left between the supporting points 1125.2 right tooth 6 and left tooth 7 cannot be symmetrical to the dental arch, but symmetrical to the cranial symmetry, see for example line or plane 1205.

The cranial symmetry may in particular determine the attachment points of the musculature and may be decisive for the neuromuscular function. Looking at the mechanical contact points and the force transmission, the sectional view AB shows the edge gaps 1122 of preferably 0.4 mm width, which prevent a direct force transmission laterally to the teeth 1221 if an optional edge gap 1122 is used. Due to the edge gap 1122 with its partially arcuate shape and the free spaces 1124 for the teeth, the device 10 cannot be a tight-fitting splint, but rather a loose-fitting device, which in the embodiment example may only rest on the support regions 1125.1 and 1125.2.

Alternatively, if the edge gap 1122 were omitted and the splint 1120 were allowed to rest directly against the teeth, the teeth would be contacted laterally with force and the resulting forces on the teeth would no longer be perpendicular to the separating sliding plane. This may reduce the training effect, but does not have to, provided, for example, the sliding surface 1123 is present and corresponding counter sliding contact areas, for example also flat sliding surfaces or other elements, e.g. protrusions of teeth/tooth elements or protrusions on the lower jaw device of the device in question, e.g. 10.1, 10.4, etc., are present.

As mentioned several times above, chewing planes may also be learned without using the or thesis function 275, whereby sliding surfaces, in particular planar sliding surfaces are optional, i.e., in particular also the above-mentioned edge gaps 1122.

In the following, theoretical relationships of the relearning process are presented using the example of an orthotic function 275, which are not intended to limit the scope of protection, but rather to facilitate an understanding of the device. Since the occlusal surfaces of the teeth 1221 would also represent a laterally acting interlock with the splint 1120, they cannot be molded, but the marginal gap 1122 may extend to the support regions 1125, which preferably do not transmit lateral forces, but only compressive forces. From a neurophysiological point of view, the very low-friction transversal sliding surface 1123 may have the effect that the resulting force may only be perpendicular to it as long as there is no abutment/stop of the sliding surfaces of the maxillary part and the mandibular part. The force stimulus of this vertical compressive force may be detected via the retaining fibers (Sharpey fibers) of the teeth and reported to the sensors of the masticatory apparatus. At the same time, the muscle spindles and/or the ligament spindles may also report the strain and stretching of the muscles, ligaments and/or tendons. This may change the control of the muscles by the sensorimotor region of the brain, which may also be referred to as relearning. For this biomechanical and neurophysiological training functionality, it may be important that the separating sliding surface is not located in the current chewing plane 111, but in the cranial transverse plane 1110, 1115. The inclined position of the separating sliding plane 1123 compared to the starting chewing plane 1111 may often cause some teeth of the upper jaw to break through into the lower jaw section, which may then be performed accordingly.

Similar relationships also apply if no edge/marginal gap is used. In these cases, relearning the position of the chewing plane may take place, for example, when eating or in a separate training session or through involuntary chewing movements when wearing the devices.

For example, there may be larger recesses in the opposite device part for teeth that extend through the separating sliding plane 1100 in order to enable a sliding movement even without an edge gap or edge gaps.

The edge gap 1122 between the edge of the shallow recess 1124, 1134 and the tooth/tooth element may preferably be greater than 0.3 mm, and is particularly preferably between 0.4 mm and 1.4 mm. The freedom of movement of the lower jaw relative to the upper jaw along the separating sliding plane 1110 may be restricted to this edge gap 1122 of the shallow recesses 1124, 1134 or receiving regions 1124, 1134 as soon as penetrating recesses 1122 or 1132 are present, i.e. teeth or tooth elements of the lower jaw UK, 4 extend into the upper jaw device 11 and/or teeth or tooth elements of the upper jaw OK, 5 extend into the upper jaw device 11. The biomechanical and neurophysiological effect of the device 100 that may be used as a training device may be unaffected by the restricted transverse range of motion, because the effect may be based on the fact that there is lateral mobility in the equilibrium position, which is still present due to the edge gap 122. However, as mentioned above, measures other than small edge gaps may also be taken.

The biomechanical function of the orthotic device with training effect may be achieved, for example, after the upper jaw module/device 1120 is placed on the lower jaw module/device 1130 and both modules are brought into contact with the dental arches of the upper jaw 1221 and the lower jaw 1231 as a package in the mouth by closing the mouth. The lower jaw UK, 4, 1230 and upper jaw OK 5, 1220 may now be brought into a relative position defined by the individually fabricated 3D geometry of the modules. At the same time, however, the sliding movement right-left and back-front as well as the rotation around the axis 1160 perpendicular to the separating sliding plane may be freely given within certain limits and be possible almost without friction. This allows the effect of the orthogonality condition for the contact force between the upper jaw OK, 5, 1220 and lower jaw UK, 4, 1230 to begin.

The equilibrium or the balance may be biomechanically comparatively unstable or metastable because the retention of the teeth may be eliminated by the sliding surface 1110. And it is precisely this unstable or metastable state of force with possible transversal sliding of the mandible UK, 4, 1230 to the front or back as well as to the left or right that may mean mechanical instability in detail, which must or may be stabilized neuromuscularly in a similar way to upright gait. This may activate the sense of balance and train the neurophysiological and sensorimotor structures of the temporomandibular joint and the chewing/masticatory apparatus, including the muscles of the head and neck, for example. If no edge gap 1122 is used, similar processes may take place.

FIG. 23 shows details of a support area of a tooth of the upper jaw OK, 5, 1221 in the device for displacing the chewing/masticatory plane, see upper jaw device 1120. FIG. 23 shows the detail of a support area 1125 in the particularly preferred embodiment. The position of the support area may be aligned with the cranial symmetry of the patient's skull, as may be seen, for example, in a CBCT/DVT image of the head. The support area 1125 is keyed as little as possible laterally. There may also be an edge gap 1122. The support area 1125 does not necessarily have to be circular and may be designed in such a way that as few lateral forces as possible are exerted. A preferred embodiment supports on a hump in a small area and the edge gap 1122 may begin around it. This allows the support 1125 to transmit forces that are perpendicular to the parting plane TGE, but it does not clamp the teeth laterally, for example. The compressive force caused by the chewing pressure may only be transmitted selectively in the rather small area 1125. Preferably, the contact area 1125 may have a diameter of less than 4 mm, particularly preferably less than 2.5 mm, and the edge gap is preferably less than 1 mm, particularly preferably less than 0.5 mm.

FIG. 24 schematically shows a first device 10.1 for displacing the chewing plane and a second device 10.2 for displacing the chewing plane. As mentioned at the beginning, these devices may be located at the first position and at the second position according to the predetermined sequence, but do not have to be, as long as, for example, the second device comes after the first device in the sequence.

Instead of the flat sliding surfaces GF, other sliding contact areas may also be used, e.g. pairs of flat sliding surfaces and other counter-sliding elements or uneven surfaces. The flat sliding surfaces may be arranged in the upper jaw device 11.1 or in the lower jaw device 12.1. However, alternation within a device or between different devices 10.1, 10.2 etc. is also possible, e.g. a flat sliding surface at the top on the right and a flat sliding surface at the bottom on the left.

A device 10.1 includes an upper jaw device 11.1 and a lower jaw device 12.1, wherein:
A flat first sliding surface area GF1.1 and a flat/plane second sliding surface area GF2.1 are present on the underside of the upper jaw device 11.1,
A flat third sliding surface area GF3.1 and a flat fourth sliding surface area GF4.1 are present on the upper side of the lower jaw device 12.1, and
The first sliding surface area GF1.1 and the fourth sliding surface area GF4.1 as well as the second sliding surface area GF2.1 and the third sliding surface area GF3.1 slide against each other in a sliding plane GE1 in the inserted state of the at least one device 10.1.

A device 10.2 includes an upper jaw device 11.2 and a lower jaw device 12.2, wherein:
A flat first sliding surface area GF1.2 and a flat second sliding surface area GF2.2 are present on the underside of the upper jaw device 11.2,
A flat third sliding surface area GF3.2 and a flat fourth sliding surface area GF4.2 are present on the upper side of the lower jaw device 12.2, and
The first sliding surface area GF1.2 and the fourth sliding surface area GF4.2 as well as the second sliding surface area GF2.2 and the third sliding surface area GF3.2 slide against each other in a sliding plane GE2 in the inserted state of the at least one device 10.2, which may be different from the sliding plane GE1, for example with regard to its inclination or other parameters mentioned above.

In other embodiments, no flat sliding surfaces are used, but contact areas that are not flat. However, the geometric positional relationships mentioned may also apply to such contact areas, whereby reference may be made to a plane that corresponds to the sliding plane GE with regard to the distances.

FIG. 25 shows arrangements of recess regions for teeth relative to planes/sliding planes in a right part of the upper jaw device 11.1 of the first device 10.1 and in a right part of the upper jaw device 11.2 of the second device 10.2.

In the upper jaw device 11.1 of the first device 10.1, the following may apply:
A lowest point of a first right-hand receiving region AB1a.1 for a first right-hand tooth Z.1a.1 may have a first right-hand distance A1a.1 from the plane/sliding plane GE1 or from the sliding surface GF1.1,
A lowest point of a second right-hand receiving region AB1b.1 for a second right-hand tooth Z.1b.1 may have a second right-hand distance A1b.1 to the plane/sliding plane GE1 or to the sliding surface GF1.1, wherein a first difference D25a is given by subtracting the value of the first right distance A1a.1 from the value of the second right distance A1b.1.

In the upper jaw device 11.2, 12.2 of the second device 10.2, the following may apply:
A lowest point of a first right-hand receiving region AB11.2 for the first right-hand tooth Z.1a.2 may have a first right-hand distance A1a.2 from the plane/sliding plane GE2 or from the sliding surface GF1.2,
A lowest point of a second right-hand receiving region AB1.2 for the second right-hand tooth Z.1b.2 may have a second right-hand distance A1b.2 to the plane/sliding plane GE2 or to the sliding surface GF1.2, wherein a second difference D25b is given by subtracting the value of the first right distance A1a.2 from the value of the second right distance A1b.2.

The value of the first difference D25a may differ from the value of the second difference D25b, for example due to a shift in the chewing plane, in particular a change in the inclination of the chewing plane, for example in a sagittal section or in a para-sagittal section, in particular by at least 0.3 mm or by at least 0.5 mm and/or by a value in the range from 0.3 mm to 2 mm.

The same may also apply to the left-hand side, i.e. independently of the right-hand side. In another embodiment, the aforementioned relationships may apply both to the right-hand side of the devices 10.1, 10.2 and to the left-hand side of the devices 10.1, 10.2.

Although only upper jaw devices 11.1 and 11.2 are shown in FIG. 25, the relationships mentioned may also apply to lower jaw devices 12.1 and 12.2 independently of or in combination with them.

The above relationships may also apply if other sliding areas or “keyed” areas are used instead of the flat sliding areas GF1.1, GF1.2, which cannot slide relative to each other.

In other embodiments, no planar sliding surfaces are used, but contact areas that are not planar. However, the geometric positional relationships mentioned may also apply to such contact areas, whereby reference may be made to a plane which corresponds to the sliding plane GE or the sliding surface or the sliding surfaces GF1.1, GF1.2 with regard to the distances.

FIG. 26 shows arrangements of recess regions for teeth relative to planes/sliding planes in the upper jaw device 11.1 of the first device 10.1 and in the upper jaw device 11.2 of the second device 10.2.

In the upper jaw device 11.1 of the first device 10.1, the following may apply:
A lowest point of a right-hand receiving region AB1i.1 for a right-hand tooth Z.1a.1 may have a right-hand distance A1a.1 to the plane/sliding plane GE1 or to the sliding surface GF1.1,
A lowest point of a left receiving region AB2.1 for a left tooth Z.2a.1, may have a left distance A3a.1 to the plane/sliding plane GE1 or to the sliding surface GF2.1,
wherein a first frontal difference D26a is given by subtracting the value of the right distance A1a.1 from the value of the left distance A3a.1, and

In the at least one upper jaw device 11.2 of the second device 10.2, the following may apply:
A lowest point of a right-hand receiving region AB1i.2 for the right-hand tooth Z.1a.2 may have a right-hand distance A1a.2 to the plane/sliding plane GE2 or to the sliding surface GF1.2,
A lowest point of a left receiving region AB2.2 for the left tooth Z.2a.2 may have a left distance A3a.2 to the plane/sliding plane GE2 or to the sliding surface GF2.2,
where a second frontal difference D26b is given by subtracting the value of the right distance A1a.2 from the value of the left distance A3a.2.

The value of the first frontal difference D26a may differ from the value of the second frontal difference D26b, in particular by at least 0.3 mm or by at least 0.5 mm and/or by a value in the range from 0.3 mm to 2 mm. This may be due to a displacement of the chewing/plane, e.g. a change in the inclination of the chewing/masticatory plane and/or a change in a further position parameter or further position parameters, in particular in a frontal section or a para-frontal section.

The aforementioned relationships may also apply to the lower jaw devices 12.1 and 12.2, for example independently of the conditions in the upper jaw devices or in combination with them.

The above relationships may also apply if other sliding areas or “keyed” areas are used instead of the flat sliding areas GF1.1, GF1.2, GF2.1, GF2.2, which cannot slide relative to each other.

In particular, combinations of the embodiments of FIGS. 25 and 26 or of the embodiments mentioned in the description of these FIGS. 25 and 26 are also possible.

In other embodiments, no planar sliding surfaces are used, but contact areas that are not planar. However, the geometric positional relationships mentioned may also apply to such contact areas, whereby reference may be made to a plane which corresponds to the sliding plane GE or the sliding surface or the sliding surfaces GF1.1, GF2.1, GF1.2, GF2.2, etc. with regard to the distances.

FIG. 27 shows height elements in a lower jaw device and a corresponding final restoration 300. FIG. 27 shows a very simplified schematic representation of an device 11 in partial view in FIG. 27a above, insofar as it covers half a dental arch as indicated in FIGS. 27a and 27b, in this case with seven tooth bodies 1 to 7. In the molar region 5, 6, 7, the occlusal thickness of the device may be increased by onlay-like elements (height element(s)), so that the contact surface of the device 11 to the opposite side (not shown) may be significantly higher than the natural occlusal surface of the cross-hatched tooth bodies 1 to 7. The individual chewing plane of the patient P's dentition in the lower jaw cuts through the image plane in line 601.

A preferred calculation uses the minimization of the sum of the distance squares of the occlusal surfaces. The new individual chewing plane 602 generated by the device 11 is located further towards the opposite side (not shown), i.e. further up in FIG. 27. The two intersection lines of the chewing/masticatory planes 601 and 602 with the drawing plane are not parallel. The new chewing/masticatory plane is therefore further up and also inclined, i.e., for example, particularly in a sagittal section. In addition, there are possible displacements of the premolar centers and the molars as well as the incisors within the chewing/masticatory plane (not shown).

In a frontal section, the inclination of the chewing/masticatory plane may remain unchanged, e.g. if there is already symmetry in the dentition in this respect. Alternatively or additionally, the chewing/plane may also be shifted in the frontal section, i.e. in particular the inclination may be changed, whereby height elements may also be used.

FIG. 27b schematically shows a final restoration 300. The restoration elements 111.1 to 111.7 sit individually on the tooth bodies 1 to 7. The previously connected device 11 may therefore be replaced by 7 individual restoration elements 111.1 to 111.7. The chewing/masticatory plane created by the restoration elements 111 is the same in this schematic FIG. 27b as in FIG. 27a, because the occlusal contours are largely the same. As soon as the tooth bodies with their roots shift again after the final restoration 300, the effective occlusal plane may change accordingly, but it is still higher than before.

An important point may be the question of why it may be so important to raise the masticatory plane again, which has shifted over the course of life. In the first phase of using the series of devices 11, 12, it is necessary to raise the contact plane quickly in order to obtain the space to move the tooth bodies 1 to 7. Once the tooth bodies have been displaced, the contact plane may be lowered again slightly. The ligamentous apparatus and the muscles of the temporomandibular joint have previously been stretched due to the previous stronger elevation and now the advantageous relaxation in the temporomandibular joint follows in a new position of the masticatory plane. The differences in the position of the chewing/masticatory plane are exaggerated in FIG. 27. In addition, the inclination of the new masticatory plane 602 is often running closer together at the back compared to the old chewing/masticatory plane 601, i.e. the reverse of the situation shown in FIG. 27.

With regard to the temporomandibular joint, the new position of the chewing/masticatory plane may lead to the lower jaw UK, 4 being lowered at the back, which relaxes the temporomandibular joint. In many cases, the lower jaw UK, 4 is lowered far less than 2 mm (millimeters) at the back, but up to 8 mm at the front. Accordingly, the restorations 111 for the front teeth may be made significantly longer axially than the old front teeth. It may not be possible to lift the anterior/front teeth so far out of the jaw. Consequently, the anterior teeth and the canines, as well as the premolars in most cases, may be given an appropriately designed veneer and onlays or alternatively veneers and table tops or further alternatively an appropriately designed crown.

### Data Set

The invention may be based on a digital technique that may ultimately work with 3D enveloping surfaces and with 3D volume data sets. The 3D data sets may be obtained from three-dimensional surfaces, preferably taken with intraoral scanners and or CBCTs/DVTs. The 3D data may include the cranial region, in particular the inner ear, for defining an advantageous chewing plane 602. The inner ear may define a biomechanically important right-left transverse axis.

In a preferred embodiment, 3D data of a skull region including the jaw region may be generated using digital imaging methods and transverse axes may be defined that are parallel to the transverse axis through the inner ear regions. The advantageous position of the chewing/masticatory plane may be defined by the fact that it is parallel to the transversal axis through the inner ear regions as a plane in the right-left transversal direction. This defined, initially virtual chewing/masticatory plane may also be referred to as the Target Denture/Dentition Plane TDP. The virtual target denture/dentition plane may be realized as the chewing/masticatory plane of the device 11, 12 by designing this device in such a way that, when placed on the real dentition, it has the contact surfaces of the tooth elements of the device aligned with the target denture/dentition plane. The position of the Target Denture/Dentition Plane may be found by using a method for which a patent application was filed by Frank Hornung in 2016 (“CranioPlan” (may be a registered trademark)), published under EP 3 332 731 A1 and hereby incorporated by reference for all legal purposes. Thus, in a particularly preferred embodiment of the method, the TDP may be aligned with the transverse axis through the inner ear regions and, if necessary, with other features of the cranium or skull 1, 1200.

After the digital three-dimensional design of the surfaces, the milling data or print data may be generated. A suitable device may use these digital images of the series of the device to generate or produce the real tangible series of devices or a first number 1 . . . x thereof. The first device may fit the dentition in a very individual way and may already effect initial changes of various kinds, e.g. displacement and veneering. The next device may take over the dentition in the arrangement created by the previous devices and exert further influences and changes. In this way, an altered state may be created in the patient's dental arch. However, the currently effective chewing plane cannot be created by the patient's dental arch, but by the device that sits on the dental arch. The sequence of the adjusted chewing planes may be generated by the suitable 3D design of the sequential or successive devices 11, 12.

In other words, devices 10, in particular upper jaw devices 11 and/or lower jaw devices 12 for the upper jaw and/or for the lower jaw are proposed, which consist of device elements (e.g. replicas of teeth) which together may form an attachment on a dental arch Z1 (arched dental element structure) and/or on a dental arch Z2 (arched dental element structure) of a patient. A series 100 of devices 10 is disclosed, each of which may be individually esthetically and biomechanically and dentally adapted to fit this individual dental arch Z1, Z2. Alternatively, the devices 10 may also comprise only one of the upper jaw device 11 and/or lower jaw device 12, for example in a subset of the series 100 or also in the entire series 100. Alternating upper jaw devices 11 and/or lower jaw devices 12 in the devices 10 are also possible.

The biomechanical adaptation to the individual therapeutic requirements may particularly affect the position of the chewing/masticatory plane. The chewing/masticatory plane is a plane as a fit in the dentition in the typically slidable occlusal state. When device 10 (upper jaw device 11 and/or lower jaw device 12) is inserted in the mouth of patient P, it may be brought into contact with the opposite side (upper jaw device 11 or lower jaw device 12), whereby the contact surface is a tooth body/tooth element of the dentition or a tooth replica of the other second device (12 or 11).

Each tooth replica of the device(s) 10 (upper jaw device 11 and/or lower jaw device 12) may either have a central (at least one free end) or terminal (supported at the ends) bridge element or a receiving region for a tooth element. The tooth elements of the dental arch of the dentition may therefore all have a corresponding receptacle in the receptacle elements of the device 10, e.g. upper jaw device 11 and/or lower jaw device 12.

By placing the holding elements of the devices 10 (upper jaw device 11 and/or lower jaw device 12) in the device 10 (upper jaw device 11 and/or lower jaw device 12) slightly differently than specified by the tooth bodies in the denture, reaction forces and reaction torques may be transferred from the device 10 to the tooth element. These forces and moments on the tooth body may lead to displacement of the tooth body in the dentition. The tooth body/tooth element is preferably selected from the group: natural tooth, filled tooth, crowned tooth, veneered tooth, pin/post tooth, implant, ground tooth, etc.

Therapeutic, aesthetic and restorative treatments in dentistry may aim to ensure that teeth, jaws, joints, muscles and nerves are or become as healthy as possible. The spatial position and orientation or inclination of the chewing plane relative to the upper jaw and relative to the lower jaw may play an important role here, which is not as immediately recognizable as the visible aesthetics of the dentition. Nevertheless, the position of the biomechanically and neurophysiologically effective chewing/masticatory plane may also have an impact on the health of the neck, the masticatory muscles, the neck muscles up to the shoulder and arm region and down to the spine. Changes to the biomechanically and also neurophysiologically effective chewing/masticatory plane may often manifest themselves in very rapid changes in muscle tone, improvements in headaches and back pain. In the long term, the displacement of the chewing/masticatory plane may lead to a therapeutically desirable change in the muscle and bone structure of the skull and head region, shoulders, back, etc. The orientation of the occlusal surfaces that actually come into contact may be decisive for the biomechanical and neurophysiological effects of the masticatory plane.

Therefore, the proposed Series 100 may make it possible to adjust the biomechanically and physiologically effective masticatory plane independently of the anatomical and dental masticatory plane of the dentition seated in the jaw.

The series 100 may therefore use the individually designed 3D geometry of the devices 10 (11, 12) in direct combination with the individually existing dental element structure (dental arches) in the jaw of patient P to create an individually formed biomechanically and neurophysiologically effective chewing/masticatory plane.

Even if the individual tooth position in the jaw changes progressively, a defined chewing plane may be set independently of this step by step for a series 100 of devices 10 (11, 12), for example by a corresponding design of the 3D geometry of the device(s) 10 (11, 12).

Even if the individual tooth position in the jaw does not or hardly changes, a defined chewing plane may be set independently of this step by step for a series 100 of devices 11, 12, e.g. by designing the 3D geometry of the device 11, 12 accordingly.

To define the chewing/masticatory plane in relation to the individual head and jaw of a patient P, the direct combination of dental arches in the dentition and the 3D geometries of the devices 11, 12 may be required. A device in a non-matching set of teeth may lead not only to the jamming of the receiving regions for the tooth bodies, but also to an incorrect adjustment of the chewing/masticatory plane.

Knowledge of the relative positions of the masticatory plane to structures in the skull (cranium) may be required for the individual definition of a biomechanically and neurophysiologically advantageous chewing/masticatory plane. The relative position to the inner ear and to the cochlea may be of particular importance, especially on the right and left, e.g. far more than the outer ear region. Alternatively or additionally, the positions of the eyes may also be of great importance, because the jaw, neck and shoulder girdle may work together to stabilize the head's movements, so that, for example, biosensory sharp vision during movement is made possible in the first place.

The first goal of a truly highly effective orthodontic and/or dental treatment of the very individual dentition of a patient P may therefore be to define a very effective chewing/masticatory plane for this patient P and to carry out the dental treatment in such a way that such a chewing/masticatory plane is at least approximately achieved.

However, the acceptance of splints and dental and/or orthodontic treatment systems may depend very much on their esthetic appearance, how they feel in the mouth and how they affect speech.

The second goal of a restoration that is highly accepted by the patient groups may therefore be devices that have an aesthetically and/or functionally appealing appearance compared to brackets or orthoses, because they would otherwise not be effective and/or because they are not worn for long enough.

The second objective may be achieved by the fact that in particularly preferred embodiments in a series 100 of devices 10 (11, 12) at least a quarter of the devices or at least half of the devices 10 (11, 12) have at least one veneering element or at least two veneering elements in the front tooth region (1, 2, 3, 4).

In the event that these veneering elements are used and the tooth bodies/tooth elements underneath are still to be displaced, this may be done by displacing the receiving regions in the veneered tooth elements of the device 11, 12 relative to the device 11, 12. This results in reaction forces and moments/torques on the tooth body and root to be displaced, even if the visible and esthetic veneering elements are not moved significantly. Consequently, it may be possible to set a new individual masticatory plane in one or more but preferably a few steps. And at the same time, it may be possible to attach aesthetically advantageous veneering elements in the anterior and/or canine region, which are designed in suitable relative positions in a suitable size as part of the device 10 (11, 12). In addition, if necessary, it may be possible to carry out targeted individual displacements of tooth bodies/tooth elements concealed by the veneering elements or visible by partially moving tooth elements in order to bring the tooth bodies/tooth elements into a suitable position and spatial orientation in the jaw of patient P.

After the therapeutically and esthetically advantageous use of the devices 10 (11, 12), they may be removed. The tooth bodies/tooth elements of the dental arches Z1, Z2 of patient P may now be arranged differently than before. The aim may be that they are now better suited for the final restoration 300. In the case of abraded, worn or unfavorably shaped teeth, it may not be sufficient to achieve an alignment with the relocation because the chewing/masticatory plane is not correct. In addition, from an esthetic and geometric point of view, the teeth may be too short due to abrasion, e.g. due to heavy grinding. Following the repositioning of the tooth bodies/tooth elements, a final restoration 300 of the tooth bodies/tooth elements may be planned.

Where tooth bodies/tooth elements are missing in the individual dental arch, bridge elements may be provided or implants may be prepared and implanted. The geometry of the artificial tooth bodies/tooth elements as implant attachments may now be based on the previously esthetically and/or biomechanically effective tooth replicas of the device that the patient P already knows.

The device 10 (11, 12) may already have had the same effect and appearance as the final restoration 300 of the dentition during the step-by-step treatment/therapy of the dentition. Nevertheless, the tooth elements of the device may have been larger in at least one dimension than the final restored tooth bodies/tooth elements due to the enveloping function. In the case of ground or polished teeth, the tooth replicas/veneering elements of the device may already have had the shape of the crowns or preferably slightly larger in at least one dimension. The enlargement is preferably lingual-buccal and lingual-frontal, because otherwise the tooth body cannot be enclosed and guided.

As a temporary restoration, an individual splint that is geometrically almost identical to the last device 10 (11, 12) of the series in 3D may be placed on the prepared dental arch and temporarily bonded. A material of very high esthetic and mechanical quality may be used for this and also beforehand. Multilayer PMMA (poly (methyl methacrylate), acrylic glass), which may also be available with a color gradient so that tooth replicas lying further back may be darker than the anterior tooth replicas, is aesthetically and/or mechanically very advantageous. Several layers may form a blank, e.g. a number of layers in the range from 10 layers to 30 layers or in the range from 10 layers to 20 layers. The technical effect of the multiple layers may be to reproduce natural tooth material as accurately as possible in terms of color and/or function.

It is not only the adjustment of the biomechanically and/or neurophysiologically effective chewing/masticatory plane that may be very important for the individual patient. The displacement of some tooth bodies of the patient's dentition to the calculated target may be just as important for the subsequent final restoration. Relocation elements may be used for this purpose. In the simplest case, displacement elements may be holding elements for tooth bodies/tooth elements, which are designed in such a way that they exert physical reaction forces and reaction moments on the tooth/tooth element as soon as the device is placed on the dental arch.

Other displacement elements may be notches in combination with attachments bonded to the teeth, skid elements, rail elements, specially designed contact surfaces to the opposite side, preferably solidly constructed ramp elements, etc.

Tooth elements may be encased and displaced by the device 10 (11, 12). The dental elements may also be implants. For biomechanical reasons, implants should only be subjected to pressure and not to tilting or tilting displacement. This is because they have grown into the bone and are not anchored in the Sharpey retaining fibers of a natural tooth root environment in the bone. Bony ingrown implants may behave differently than teeth with the root in the jaw, as there are no Sharpey fibers on implants.

One particular type of displacement may be movement relative to the jaw, primarily along the axis of the tooth body. Teeth with natural roots react to a lack of load via the function of the Sharpey fibers by growing out of the jaw by a few tenths of a millimeter—even in older people. Implants cannot and should not be displaced significantly from their ingrown position.

The device 10 (11, 12) may comprise edge gap elements 1122, which enclose the tooth body/tooth element individually with an edge gap and occlusal gap so that the tooth is not loaded. A tooth that is thus relieved may move axially out of the jaw slightly at this point. However, this is often not enough to create the required height for a biomechanically and neurophysiologically favorable chewing plane. Therefore, the missing displacements are often compensated for by the fact that onlay-like abutments (height elements) as part of the device(s) 10 (11, 12) may rest on the teeth that are too short or have become too short, so to speak, in order to maintain the chewing/masticatory plane at a corresponding distance from the tooth body/tooth element behind it.

At the latest when a dentition comprises implants, the limits of the displacement of these implants/tooth elements by aligners may be reached in contrast to the devices 1 (11, 12) of series 100 proposed here, because height elements may still be used which have a greater height compared to other areas of the device and/or compared to the low height of a thermoforming sheet.

Nevertheless, the chewing/masticatory plane may and will be displaced, e.g. because this will be better neurophysiologically and biomechanically and also functionally, and thus one comes into collision with all the teeth that usually cannot be displaced in the root direction, i.e. upwards or downwards, but possibly also in other directions, as far as would be necessary. In contrast, the devices 10 (11, 12) of the 100 series use height elements for shifting the chewing/masticatory plane, in particular for changing the position of the inclination of the chewing/masticatory plane, which may cover the implants and/or possibly support onto them.

To date, in most cases, the orthodontic displacements that may be achieved are transversal migratory movements and superimposed tilts (rotations around the transverse axes) and/or rotations around the longitudinal axis of the teeth or around the axis perpendicular to the chewing/masticatory plane. Such displacements may basically be described as movements by six parameters, three translation directions may be defined for each tooth, even if the displacement may be zero. Furthermore, three directions of rotation may be defined if the tooth is to be inclined or tilted around the longitudinal axis.

Conventional methods may use brackets and wires or are the aligner method. In the aligner procedure, the teeth are tilted and shifted to create a more attractive appearance, especially when they are next to each other. Names like “Dr. Smile” speak for a more beautiful smile.

Traditionally, the series of aligners are manufactured as stepwise acting displacement devices by thermoforming and have a wall thickness resulting from the thermoforming process. If ramps or lateral attachments are attached to aligners, these local modifications to the preferably transparent aligners would be hollow as a result of deep drawing. Due to the low mechanical stability, especially if support structures are missing, it would not be possible to keep such devices in the mouth while eating, so that a significant training effect would be omitted.

As a result, only tooth displacements that could not significantly influence the position of the chewing/masticatory plane, especially not in a few steps or in a rapid transition, could be carried out. In particular, the inclination of the chewing/masticatory plane, for example, could not be changed until now. Now, however, there are new possibilities for displacing the chewing/masticatory plane with the help of aligner-like splints and/or with splints that are esthetically effective or encourage wear without having to displace the teeth analogous to the same extent when changing the chewing/masticatory plane.

The series 100 presented here describes a technology for achieving rapid therapeutically expedient displacements of the chewing/masticatory plane by technical means, even if the teeth do not follow this displacement quickly enough. The treatment may then be continued, whereby the device(s) 10 (11, 12) may be gradually modified so that the tooth bodies may be gripped in the dental arch and displaced as far as possible, preferably in at least one tooth/tooth element or in several teeth/tooth elements.

For this purpose, the devices 10 (11, 12) may have receiving regions for each of the tooth bodies/tooth elements of the tooth arch Z1 and/or the tooth arch Z2. These receiving regions may allow the device(s) (11, 12) to be placed on the dental arch Z1 and/or Z2. The device(s) (11, 12) may develop a holding force by means of a suitable design adapted to the existing tooth body/tooth element and individual tooth elements may be displaced to a greater or lesser extent by reaction forces and reaction moments/torques.

The arrangement of occlusally adjoining onlay element(s) (resting on the tooth element from above in the lower jaw UK) or at least one height element, which is designed in such a way that the contact surface to the opposite side is located further towards the opposite side than the contact surface of the occlusal surface of a tooth element covered by it, may be decisive for setting a new occlusal plane.

For example, deep-drawn aligners with an additional function that may be used to change the position of the temporomandibular joint could be used. A change in the position of the temporomandibular joint or the joint heads on the lower jaw may also represent a growth stimulus in the jaw, but this happens very slowly. The displacement in the temporomandibular joint cannot therefore directly change the position of the occlusal surfaces of the tooth elements with conventional aligners in such a way that a new position of the chewing plane is created.

However, the proposed Series 100 splints/splint packs may do this very quickly: they may change the position of the located masticatory plane by changing the abutment thickness onlay-like on the occlusal surfaces and only then may the movement of the teeth follow, e.g. as far as is possible. In older patients, abutments of up to 5 mm may be necessary. However, regardless of the age of the person P, for example, the tooth may only be displaced a maximum of 1 mm with its root out of the bone, in 50-year-olds rather less, e.g. only 0.5 mm max. Tilting or tilting displacements may be easier to realize and cause an apparent lateral displacement of several millimeters, which may be used well, for example, to shift the dental arch of the lower jaw forward or backward.

However, for biomechanical reasons, the height of the opposing occlusal surfaces in the lower jaw and upper jaw may be decisive in correcting the physiological chewing plane. The position of the lower jaw relative to the upper jaw in the contact bite may result from the adjacent row of onlay-like bite block structures (height elements). The onlay-like bite block structures (height elements) may be integrated only in the upper jaw device 11 or only in the lower jaw device 12 or in both devices 11, 12.

If, for example, a patient's teeth are abraded due to grinding etc., the abrasion may often be one-sided and asymmetrical. In this case, the temporomandibular joint may be loosened first and the ligaments may be pre-stretched. And this may be achieved by a rapid change (e.g. several mm per week)—compared to the gradual raising of the teeth from the lower jaw or, for example, the usual alignment with changes of, for example, less than 0.5 mm per week. The functional preparation for a new dentition position and for teeth that are, so to speak, youthfully longer again may be achieved by onlay-like thickening (height element) or thickening of a suitable chewing surface shape and suitable thickness for the individual tooth elements/tooth replicas, whereby these tooth elements/tooth replicas of a dental splint-like device 10 (11, 12) preferably result in a one-piece connected dental arch or a replica of a dental arch that may be placed on the dental arch of the patient P. The chewing surfaces, which are preferably geometrically designed to follow a chewing/masticatory plane design, may therefore immediately create a new masticatory plane position relative to the lower jaw mandible, 4 or upper jaw mandible, 5 when at least one device 10 (11, 12) is inserted. However, the occlusal surface structures do not necessarily have to be onlay-like (height element) in shape, they may also have other functional geometries, e.g. as flat sliding surfaces, in particular on at least one height element, or as rolling sliding surfaces, in particular on at least one height element. Several adjacent tooth elements or tooth replicas or veneering elements of a device 10 (11, 12) may be grouped together to form a functional dental arch area.

Preferably, sliding surfaces may be formed by 3 or 4 or more tooth elements or tooth replicas as part of a device 10 (11, 12). Sliding surface elements may be planar or form a hypersurface of another type in space, such as a cylinder. It may be decisive that preferably the molars are used to raise them above and/or below by the devices in such a stepped and inclined manner that a new contact state results in contact. It should again be pointed out that the new contact state between the upper jaw OK, 5 and lower jaw IK, 4 with, for example, overlying rails, at least, for example, upper jaw device 11 and/or lower jaw device 12, is not created directly by displacement of the teeth and not by ramps but, for example, by onlay-like thickenings or height elements of the devices 10 (11, 12) on the occlusal surface areas of the tooth elements.

Without further modifications, a known transparent deep-drawn aligner cannot use onlay areas of different thicknesses (height elements) on the tooth elements in order to set a new chewing plane without the teeth having already followed this direction, e.g. shifting according to the six specified parameters. Only with knowledge of this document may such modifications be possible.

In particularly preferred embodiments, the successively applicable devices 10 (11, 12) for displacing the chewing/masticatory plane are designed such that adjacent tooth elements are occlusally shaped such that a solidly filled onlay-like area (height element) is formed, for example, which may be up to 5 mm thick. One or more cavities in the onlay-like area (height element) are also possible, especially if support structures are used, e.g. according to a stable honeycomb shape, or another arrangement of bars between the various cavities.

The onlay-like areas (height element) may preferably differ from the dental arch naturally anchored in the dentition in terms of the position and inclination of the contact surface to the opposite side of the upper jaw or lower jaw, e.g. in at least one (room) angle, and there may be an occlusal distance between the occlusal surface of the tooth elements or tooth replicas as part of the device 10 (11, 4, 12) and the occlusal surface of the underlying tooth bodies/tooth elements of the dental arch, i.e. of elements that are directly anchored in the mandible mandibular, 4 or maxilla mandibular, 5, e.g. in the bone and/or with Sharpey fibers.

The onlay-like superstructures (height element) of adjacent tooth replicas as part of the device 10 (11, 12) do not necessarily have to be decreasing in its height or increasingly stepped in their thickness, as the underlying tooth bodies of the dental arch may be prepared or may stand at different heights in the dental arch. Only the new contact surface or chewing/masticatory plane created with the device in place and its biomechanical and physiological effect on the patient P may be decisive.

On the opposite side, the contact surfaces may preferably be smooth and slippery. This may help the person to learn the chewing plane.

However, the contact surfaces facing the opposite side may also be rail-like, spherical or spherical. This may ultimately influence the freedom of movement, stability or instability in the contact between the upper jaw and lower jaw when device 10 (11 and/or 12) is inserted.

The onlay-like thickness (height element) of the occlusal structure (height element) may be separately adjustable from tooth element to tooth element or from tooth replica to tooth replica. This may preferably be done digitally by designing a second enveloping surface outside the inner surface of the device 10 (11, 12) facing the teeth in digital form, in particular by using Boolean functions with which the surfaces of the teeth or tooth elements in the jaw are subtracted from digital data of the device 10 (11, 12). The freedom of the 3D design of this outer surface facing the opposite side may allow the free design of the superstructure/abutment height (height element) with simultaneously desired sliding properties, shape properties and/or kinematic movement properties of the contact surfaces that may be generated with it on contact with the opposite side.

Preferably, for a design surface of the first sub/partial device 11 or 12 pointing to the opposite side, a corresponding shaped surface of the second sub/partial device 12 or 11 pointing to the opposite side of one and the same device 10 may be designed, so that a desired relative position of the upper jaw and lower jaw results in the event of contact, as well as a movement possibility or keying dependent on the contact geometry of these designed surfaces.

As a result, the lower jaw UK, 4 may be brought very quickly into a new biomechanically and/or therapeutically desired relative position relative to the upper jaw OK, 5 in a patient for whom the devices 10 (11 and/or 12) are used. In addition, biomechanically and/or therapeutically desired relative positions may be made possible.

In the preferred embodiments, the onlay-like build-up areas (superstructures) are arranged in the region of the molars (5), (6), (7), (8), on the right and/or left, below and/or above, in the most frequent case, for example, in all four quadrants of the dentition. In the canine regions (3) and anterior regions (1), (2), on the other hand, veneering elements are preferably used/designed as part of the devices 10 (11, 12), in some cases also in the premolars (4).

In the case of bridges in the dental arch, the onlay-like superstructures (height element(s)) may at least partially span the bridge area as part of the devices 11, 12.

In the case of implants in the dental arch, care may be taken to ensure that the 3D contour and surface of the onlay-like superstructure/abutment elements (height element(s)) do not exert any tilting moments on the implant.

A series 100 with devices for supporting the displacement of the chewing plane of a person P is explained, comprising:
at least two pairs of devices 10,
wherein the pairs of devices 10 each comprise a jaw device,
wherein the jaw device comprises an upper jaw device 11 and/or a lower jaw device 12,
and wherein the devices are designed to be worn by the person P according to a predetermined sequence,
wherein in at least one device 10.1, 10.2 the at least one jaw device 11, 12 comprises at least one height element on a first side,
wherein at least two contact areas are formed on the at least one height element at mutually different positions of molar (tooth) elements,
wherein at least one further contact region is formed on a second side of the at least one jaw device 11, 12, and
where at least three contact areas define the GE level,
wherein the plane GE deviates from a starting chewing plane of the person P or from a current chewing plane of the person P with respect to its inclination changed by the at least one height element in a frontal section or sagittal section and/or deviates with respect to its height position changed by the at least one height element,
wherein in at least one other device of the series 100 a different inclination in a frontal section or sagittal section and/or a different height position of the respective plane is adjusted/set by at least one further height element, which differs from the at least one height element in the adjusted/set height.

Furthermore, a method for designing dental devices is explained, in particular for designing or for designing and manufacturing a series 100 according to one of the embodiments, further embodiments and examples of embodiments explained above, comprising:
Capturing/recording a starting tooth arrangement of the teeth or a tooth element structure of a person P in his/her upper jaw OK, 5 and/or the teeth or the tooth element structure of the person P in his/her lower jaw UK, 4,
Determining at least one reference structure of the person P before, during or after the recording,
Determining a target tooth arrangement of the teeth or the tooth element structure of the upper jaw OK, 5 of the person P with respect to the reference structure,
Determining a target tooth arrangement of the teeth or the tooth element structure of the lower jaw UK, 4 of the person P with respect to the lower jaw UK, 4 or a target lower jaw UK, 4 of the person P including the reference structure,
Based on the start arrangement and the target tooth arrangement, providing a data set series of digital data set groups following one another in a sequence, each with a data set for the teeth or the tooth element structure of the upper jaw OK, 5 and/or a data set for the teeth or the tooth element structure of the lower jaw UK, 4,
wherein in at least one device 10.1, 10.2, the at least one jaw device 11, 12 comprises at least one height element on a first side,
wherein at least two contact areas are formed on the at least one height element at mutually different positions of molar tooth elements,
wherein at least one further contact region is formed on a second side of the at least one jaw device 11, 12, and
wherein at least three contact areas define the GE plane,
wherein the plane GE deviates from a starting chewing plane of the person P or from a current chewing plane of the person P with respect to its inclination changed by the at least one height element in a frontal section or sagittal section and/or deviates with respect to its height position changed by the at least one height element,
wherein in at least one other device of the series 100 a different inclination in a frontal section or sagittal section and/or a different height position of the respective plane is adjusted/set by at least one further height element, which differs from the at least one height element in the adjusted or set height.

The embodiments are not to scale and are not restrictive. Variations within the scope of skill in the art are possible. Although the invention has been illustrated and described in detail by the preferred embodiment example, the invention is not limited by the disclosed examples and other variations may be derived by the skilled person without departing from the scope of protection of the invention.

The further developments and embodiments mentioned in the introduction may be combined with one another. The embodiments mentioned in the figure description may also be combined with one another. Furthermore, the further developments and embodiments mentioned in the introduction may be combined with the embodiments mentioned in the description of the figure.

1. Series (100) comprising devices for preparing a displacement, in particular a permanent displacement, of the chewing plane of a person (P), comprising at least two devices (10),
wherein the devices (10) each comprise at least one jaw device (11, 12),
wherein the at least one jaw device (11, 12) comprises an upper jaw device (11) or/and a lower jaw device (12),
wherein the devices (10) are designed to be worn by the person (P) according to a predetermined sequence,
wherein the jaw device (11, 12) extends from a receiving region for a left molar element via at least one receiving region for an anterior tooth element or a canine tooth element to a receiving region for a right molar element, and
wherein the jaw device (11, 12) defines a plane (GE),
characterized in that in at least one device (10.1, 10.2) the at least one jaw device (11, 12) comprises at least one height element on a first side,
that at least two preferably local contact areas are formed on the at least one height element at mutually different positions of molar elements,
that on a second side of the at least one jaw device (11, 12) at least one further preferably local contact region is formed at a further position of a molar element, and
that the at least three preferably local contact areas define the plane (GE),
wherein the plane (GE) deviates from a starting chewing plane of the person (P) or from a current chewing plane of the person (P) with respect to its inclination changed by the at least one height element in a frontal section and/or sagittal section and/or deviates with respect to its height position changed by the at least one height element,
wherein in at least one other device of the series (100) a different inclination in a frontal section and/or sagittal section and/or a different height position of the respective plane is adjusted by at least one further height element, which differs from the at least one height element in the adjusted height.

2. The series (100) according to claim 1, wherein the height elements of the series serving to displace the chewing plane are designed in such a way that a permanent displacement of the chewing plane is prepared, preferably by a direct approach to a target chewing plane in which the height adjusted by at least one height element progressively increases or decreases incrementally or by an indirect approach to the target chewing plane in which the height adjusted by at least one height element progressively increases incrementally at first and then decreases in the opposite direction or initially decreases and then increases in the opposite direction.

3. The series (100) according to one of the preceding claims, wherein in at least two devices (10.1, 10.2) the at least one jaw device (11.1, 11.2; 12.1, 12.2) comprises the at least one contact area on at least one height element in each case,
wherein in a first device (10.1) of the at least two devices (10.1, 10.2) first receiving regions (AB1.1, AB4.1) for a tooth element structure of the upper jaw (OK, 5) or of the lower jaw (UK, 4) are arranged relative to a first plane (GE1) of the first device (10.1) in accordance with a first arrangement,
in a second device (10.2, 10.3) of the at least two devices (10), second receiving regions (AB1.2, AB4.2) for the tooth element structure of the upper jaw (OK, 5) or the lower jaw (UK, 4) are arranged relative to a second plane (GE2) of the second device (10.2) according to a second arrangement which differs from the first arrangement, and
wherein the second arrangement, which differs from the first arrangement, causes a change in the position of the chewing plane of the person (P) from a chewing plane associated with the plane of the first arrangement to a chewing plane associated with the plane of the second arrangement, in particular a change in the inclination of the chewing plane of the person (P).

4. The series (100) according to claim 3, wherein in a third device (10.3) of the at least two devices (10.1, 10.x) the at least one jaw device (11.3; 12.3) comprises the at least one contact area on at least one height element,
wherein third receiving regions (AB1.3, AB4.3) for tooth elements of the upper jaw (OK, 5) or the lower jaw (UK, 4) are arranged in the third device (10.3) relative to a third plane (GE3) of the third device (10.3) in accordance with a third arrangement,
wherein the third arrangement differs from the first arrangement and from the second arrangement, and
wherein the third arrangement causes a change in the position of the chewing plane of the person (P) towards a third chewing plane which differs from the first chewing plane and/or from the second chewing plane, in particular a change in the inclination of the chewing plane, and
wherein a change in the second arrangement compared to the first arrangement is made in the same direction as a change in the third arrangement compared to the second arrangement.

5. The series (100) according to claim 3, wherein in a third device (10.14, 10.15) of the at least two devices (10.1, 12.x) the at least one jaw device (11.14, 11.15) comprises the at least one contact area on at least one height element,
wherein in the third device (10.14, 10.15) of the at least two devices (10.1, 12.x) third receiving regions (AB) for tooth elements of the upper jaw (OK, 5) or the lower jaw (UK, 4) are arranged relative to a third plane (GE14, GE15) of the third device (10.14, 10.15) according to a third arrangement,
the third arrangement being different from the second arrangement, and
wherein the third arrangement causes a change in the position of the chewing plane of the person (P) towards a third chewing plane which differs from the first chewing plane and/or from the second chewing plane, in particular a change in the inclination of the chewing plane, and wherein a change in the second arrangement compared to the first arrangement occurs in the opposite direction to a change in the third arrangement compared to the second arrangement.

6. The series (100) according to claim 5, wherein in a fourth device (10.n) the at least one jaw device comprises the at least one contact area on at least one height element,
wherein in the fourth device (10.n) of the at least two devices (10.x), fourth receiving regions (AB) for tooth elements of the upper jaw (OK, 5) or the lower jaw (UK, 4) are arranged relative to a fourth plane (GEn) of the fourth device (11.14, 11.15) in accordance with a fourth arrangement,
the fourth arrangement being different from the third arrangement, and
wherein the fourth arrangement results in a change in the position of the chewing plane of the person (P) towards a fourth chewing plane which differs from the first chewing plane and/or from the second chewing plane, in particular with respect to its inclination, and
wherein a change in the third arrangement compared to the second arrangement is in the opposite direction to a change in the fourth arrangement compared to the third arrangement.

7. The series (100) according to claim 1, wherein the at least one height element extends over at least two receiving regions or at least three receiving regions for at least one molar element in each case or has a length in the range from 15 mm to 30 mm, and
wherein the at least one height element has a height of at least 2 mm, at least 3 mm or at least 4 mm at at least one of the at least two receiving regions or of the at least three receiving regions.

8. The series (100) according to one of the preceding claims, wherein the at least one height element defines a height between the at least one contact area and a surface of a receiving region facing away from the at least one contact area,
wherein an occlusal surface of a tooth element at the same tooth element position as the at least one contact region and covered by the height element lies against the surface, or wherein the surface lies opposite the occlusal surface, and
where the distance is in the range from 2 mm to 6 mm or in the range from 2.5 mm to 5 mm,
and wherein no height element is arranged on the second side of the at least one device, which causes a height difference of more than 1 mm.

9. The series (100) according to any one of claims 1 to 7, wherein the at least one height element defines a height between the at least one contact area and a surface of a receiving region facing away from the at least one contact area,
wherein an occlusal surface of a tooth element at the same tooth element position as the at least one contact region and covered by the height element lies against the surface or wherein the surface lies opposite the occlusal surface,
where the distance is in the range from 2 mm to 6 mm or in the range from 2.5 mm to 5 mm,
and wherein at least one height element is arranged on the second side of the at least one device, which causes a height difference of more than 1 mm, more than 2 mm or more than 3 mm.

10. The series (100) according to one of the preceding claims, wherein the at least one height element adjusts a height which is at least twice as high or at least three times as high as a height of the at least one device above the at least one receiving region for the anterior tooth element or for the canine tooth element.

11. The series (100) according to one of the preceding claims, wherein the at least one height element is free of detents which are designed to enter into a mechanical or magnetic coupling with a counter-detent.

12. The series (100) according to one of the preceding claims, wherein the at least one height element sets a first height at a first tooth position and a second height at a second tooth position, wherein the first height is at least 0.25 mm or at least 0.5 mm or at least 1 mm greater than the second height.

13. The series (100) according to one of the preceding claims, wherein the height element defines a distance between the contact area and an occlusal surface of a tooth element covered by the height element,
where the distance is in the range from 2 mm to 6 mm or in the range from 2.5 mm to 5 mm.

14. The series (100) according to claim according to one of the preceding claims, wherein the at least one device (10.1, 10.2) provides at least one further additional dental technical function, and
wherein the at least one device (10.1, 10.2) differs from at least one other device (10) of the series (100) by the additional function itself.

15. The series (100) according to claim according to one of the preceding claims, wherein the at least one device (10.1, 10.2) provides at least one further additional dental function,
wherein the at least one device (10.1, 10.2) has the additional function in common with at least one other device (10) of the series (100).

16. The series (100) according to claim 15, wherein the at least one device (10.1, 10.2) has the additional function in common with the at least one other device (10) of the series (100) in the same characteristic of functional elements for providing the function or in a different embodiment of functional elements for providing the function.

17. The series (100) according to claim 15, wherein the at least one device (10.1, 10.2) has the additional function in common with the at least one other device (10) of the series (100) in a different characteristic of functional elements for providing the function.

18. The series (100) according to one of the preceding claims, especially according to claim 3, wherein the arrangement comprises an angle (W1) between a respective plane (GE) and a respective chewing plane (KE) in a frontal plane (F),
wherein the angle (W1) between the respective plane (GE) and the respective chewing plane (KE) in the frontal plane (F) changes from one of the arrangements to an arrangement following this arrangement according to the order of the devices, and/or
wherein the arrangement comprises an angle (W2) between the respective plane (GE) and the respective chewing plane (KE) in a sagittal plane (S),
wherein the angle (W1) between the respective plane (GE) and the respective chewing plane (KE) in the sagittal plane (S) changes from one of the arrangements to an arrangement following this arrangement according to the order of the devices.

19. The series (100) according to one of the preceding claims, wherein the jaw device of the at least one device (10.1, 10.2) comprises an upper jaw device (11.1, 11.2) and a lower jaw device (11.2). lower jaw device (12.1, 12.2), wherein:
a flat first sliding surface area (GF1.1, GF1.2) and a flat second sliding surface area (GF2.1, GF2.2) are present on the underside of the upper jaw device (11.1, 11.2),
a flat third sliding surface area (GF3.1, GF3.2) and a flat fourth sliding surface area (GF4.1, GF4.2) are provided on the upper side of the lower jaw device (12.1, 12.2), and
the first sliding surface area (GF1.1, GF1.2) and the fourth sliding surface area (GF4.1, GF4.2) as well as the second sliding surface area (GF2.1, GF2.2) and the third sliding surface area (GF3.1, GF3.2) slide against each other in the plane (GE) when the at least one device (10.1, 10.2) is in the inserted state.

20. The series (100) according to one of the preceding claims, wherein in the at least one jaw device (11.1, 12.1) of the first device (10.1):
a lowest point of a right receiving region (AB1.1, AB4.1) for a right tooth (Z.1a.1, Z.4a.1) has a right distance (A1a.1) to the plane (GE1),
a lowest point of a left receiving region (AB2.1, AB3.1) for a left tooth (Z.2a.1, Z.3a.1) has a left distance (A3a.1) to the plane (GE1),
wherein a first frontal difference (D26a) is given by subtracting the value of the right distance (A1a.1) from the value of the left distance (A3a.1), and
wherein in the at least one jaw device (11.2, 12.2) of the second device (10.2):
a lowest point of a right receiving region (AB1.2, AB4.2) for the right tooth (Z.1a.2, Z.4a.2) has a right distance (A1a.2) to the plane (GE2),
a lowest point of a left receiving region (AB2.2, AB3.2) for the left tooth (Z.2a.2, Z3a.2) has a left distance (A3a.2) to the plane (GE2),
where a second frontal difference (D26b) is given by subtracting the value of the right distance (A1a.2) from the value of the left distance (A3a.2),
and wherein the value of the first frontal difference (D26a) differs from the value of the second frontal difference (D26b), in particular by at least 0.3 mm or by at least 0.5 mm and/or by a value in the range from 0.3 mm to 2 mm.

21. The series (100) according to one of the preceding claims, wherein
A) in the at least one jaw device (11.1, 12.1) of the first device (10.1):
a lowest point of a first right receiving region (AB1a.1) for a first right tooth (Z.1a.1) has a first right distance (A1a.1) to the plane (GE1),
a lowest point of a second right receiving region (AB1b.1) for a second right tooth (Z.1b.1) has a second right distance (A1b.1) from the plane (GE1),
wherein a first difference (D25a) is given by subtracting the value of the first right distance (A1a.1) from the value of the second right distance (A1b.1), and
wherein in the at least one jaw device (11.2, 12.2) of the second device (10.2):
a lowest point of a first right receiving region (AB1.2) for the first right-hand tooth (Z.1a.2) has a first right distance (A1a.2) from the plane (GE2),
a lowest point of a second right receiving region (AB1.2) for the second right tooth (Z.1b.2) has a second right distance (A1b.2) to the plane (GE2),
wherein a second difference (D25b) is given by subtracting the value of the first right distance (A1a.2) from the value of the second right distance (A1b.2),
and wherein the value of the first difference (D25a) differs from the value of the second difference (D25b), in particular by at least 0.3 mm or by at least 0.5 mm and/or by a value in the range from 0.3 mm to 2 mm, and/or
B) wherein in the at least one jaw device (11.1, 12.1) of the first device (10.1):
a lowest point of a first left receiving region (AB2.1) for a first left tooth (Z.2a.1) has a first left distance to the plane (GE1),
a lowest point of a second left receiving region (AB2.1) for a second left tooth (Z.2b.1) has a second left distance (A1b.1) to the plane (GE1),
wherein a first difference is given by subtracting the value of the first left distance from the value of the second left distance, and
wherein in the at least one jaw device (11.2, 12.1) of the second device (10.2):
a lowest point of a first left receiving region (AB2.2) for the first left tooth (Z.2a.2) has a first left distance to the plane (GE2),
a lowest point of a second left receiving region (AB2.2) for the second left tooth (Z.1b.2) has a second left distance (A1b.2) to the plane (GE2),
where a second difference is given by subtracting the value of the first left distance from the value of the second left distance,
and wherein the value of the first difference differs from the value of the second difference, in particular by at least 0.3 mm or by at least 0.5 mm and/or by a value in the range from 0.3 mm to 2 mm.

22. The series (100) according to one of the preceding claims, wherein the at least one jaw device (11, 12) of the first device (10.1, 10.2) carries at least one tooth veneer (N.I.1.2, N.IV.1.2) on its front side,
the at least one jaw device (11, 12) of the second device (10.n) carries at least one tooth veneer (N.I.1.n, N.IV.1.n) on its front side,
the at least one tooth veneer (N.I.1.2, N.IV.1.2) of the first device (10.1, 10.2) is located at the same tooth position as the tooth veneer (N.I.1.n, N.IV.1.n) of the second device (10.n), and
wherein the at least one tooth veneer (N.I.1.2, N.IV.1.2) of the first device (10.1, 10.2) comprises a first inner contour and a first outer contour, the relative position of which differs from the relative position of a second inner contour on the at least one tooth veneer (N.I.1.n, N.IV.1.n) of the second device (10.n) to a second outer contour of the at least one tooth veneer (N.I.1.n, N.IV.1.n) of the second device (10.n).

23. The series (100) according to one of the preceding claims, wherein the first device (10.1) and/or the second device (10.2) or at least one further device of the series (100) comprises functional elements which exert an alignment function (210) of teeth or on teeth and/or which exert a shifting function (220) of teeth or on teeth in relation to at least one dental arch or at least one arch-shaped tooth element structure of the person (P) in order to move the at least one dental arch or the at least one arch-shaped tooth element structure of the person (P) on teeth in relation to at least one dental arch or at least one arch-shaped tooth element structure of the person (P), in order to bring the at least one dental arch or the at least one arch-shaped tooth element structure of the person (P) into a new constellation.

24. The series (100) according to one of the preceding claims, wherein at least one subset of the devices (10) is configured such that a height superstructure (build-up) is first carried out in the molar region of the person (P) by means of a height function (250), wherein the height superstructure is suitable for increasing the distance of the lower jaw (UK, 4) from the upper jaw (OK, 5) in the contact bite and thereby leading to a deblocking of previously blocked tooth displacements, and
wherein at least one further subset of the devices (10) is designed such that this deblocking achieved by the height functions (250) is followed by a tooth displacement of teeth of the person (P) by alignment functions (210) as part of the subsequent devices (10.n) and/or a change in the dental arch of the person (P) by shifting functions (220) as an additional part of the subsequent devices (10.n).

25. The series (100) according to one of the preceding claims, wherein a roughness number (Rz) of the at least one contact area is smaller than 5 micrometers or wherein the average roughness value (Ra) of the at least one contact area is smaller than 1.5 micrometers or smaller than 1.3 micrometers.

26. The series (100) according to one of the preceding claims, wherein at least a part of the devices (10) or all devices (10) homogeneously comprise a single material, or
wherein at least some of the devices (10) or all of the devices (10) comprise at least two different materials, preferably a first material in an outer region (19) and a second material in an inner region (18) enclosed by the outer region (19),
wherein the first material has a greater hardness than the second material or wherein the second material has a greater hardness than the first material.

27. The series (100) according to one of the preceding claims, wherein the at least one device which enables relearning of the chewing plane is designed in such a way that sideways movement and/or forward-backward movement of the modules relative to one another and/or relative to tooth element structures is possible, and
wherein preferably in the at least one jaw device the receiving regions (AB) or receiving regions for tooth elements are dimensioned such that a lateral edge gap is formed.

28. The method for designing dental devices, in particular for designing or for designing and manufacturing a series (100) according to any one of claims 1 to 27, comprising:
Recording a starting tooth arrangement of the teeth or tooth elements of a person (P) in their upper jaw (OK, 5) and/or of the teeth or tooth elements of the person (P) in their lower jaw (UK, 4),
Determining at least one reference structure of the person (P) before, during or after the recording,
Determining a target tooth arrangement of the teeth or the tooth elements of the upper jaw (OK, 5) of the person (P) with respect to the upper jaw (OK, 5) or a target upper jaw (OK, 5) and/or of the teeth or the tooth elements of the lower jaw (UK, 4) of the person (P) with respect to the lower jaw (UK, 4) or a target lower jaw (UK, 4) of the person (P), taking into account the reference structure,
Based on the start tooth arrangement and the target tooth arrangement, providing digital data comprising digital data for the teeth or the tooth elements of the upper jaw (upper jaw, 5) and/or for the teeth or the tooth elements of the lower jaw (lower jaw, 4) in successive order,
Designing, based on the digital data, a series (100) of devices for assisting in the displacement of the chewing plane of a person (P), comprising at least two devices (10),
wherein the devices (10) each comprise at least one jaw device (11, 12),
wherein the at least one jaw device (11, 12) comprises an upper jaw device (11) or/and a lower jaw device (12),
wherein the devices (10) are designed to be worn by the person (P) according to the predetermined sequence,
characterized in that in at least one device (10.1, 10.2) the at least one jaw device (11, 12) comprises at least one height element on a first side,
that at least two contact areas, preferably local contact areas, are formed on the at least one height element at mutually different positions of jaw tooth elements,
in that at least one further contact region is formed on a second side of the at least one jaw device (11, 12), preferably a local further contact region, and
that the at least three contact areas define the level (GE),
wherein the plane (GE) deviates from a starting chewing plane of the person (P) or from a current chewing plane of the person (P) with respect to its inclination changed by the at least one height element in a frontal section or sagittal section and/or deviates with respect to its height position changed by the at least one height element,
wherein in at least one other device of the series (100) a different inclination in a frontal section and/or sagittal section and/or a different height position of the respective plane is set by at least one further height element, which differs from the at least one height element in the set height.

29. The method according to claim 18, wherein in at least two devices (10.1, 10.2) the jaw devices (11.1, 11.2; 12.1, 12.2) are adapted to form the at least one contact region respectively,
wherein in a first device (10.1) of the at least two devices (10.1, 10.2), first receiving regions (AB1.1, AB4.1) for teeth or for a tooth element structure of the upper jaw (OK, 5) or of the lower jaw (UK, 4) are arranged relative to a first plane (GE1) of the first device (10.1) in accordance with a first arrangement,
in a second device (10.2, 10.3) of the at least two devices (10), second receiving regions (AB1.2, AB4.2) for the teeth or for the tooth element structure of the upper jaw (OK, 5) or of the lower jaw (UK, 4) are arranged relative to a second plane (GE2) of the second device (10.2) according to a second arrangement which differs from the first arrangement, and
wherein the second arrangement, which differs from the first arrangement, makes it possible to relearn the position of the chewing plane of the person (P), in particular the inclination of the chewing plane, from a chewing plane associated with the first arrangement to a chewing plane associated with the second arrangement.

30. The method according to claim 28 or 29, wherein the determining of the reference structure comprises:
i) Determining an inner ear axis, preferably using digital 3D image data,
ii) Determining the position of at least one eye,
iii) Determining at least one skull plane comprising the inner ear axis and the position of at least one eye,
iv) Using the skull plane as an auxiliary plane or for the calculation of an auxiliary plane, e.g. by determining the mean value of two planes, each comprising one eye position,
v) Using of the auxiliary plane to set the chewing plane by:
A1) Determining an axis of rotation which is parallel to the inner ear axis and which lies on the other side of the inner ear axis compared to the eye axis,
A2) Using the rotation axis to rotate the auxiliary plane downward by a predetermined angle, e.g. by an angle in the range of 11 to 17 degrees or in the range of 13 to 15 degrees, so as to obtain the target chewing plane or a plane parallel to the target chewing plane, or
B1) Rotation of the auxiliary plane around the inner tube axis to obtain a second auxiliary plane, and
B2) Shifting (Translation) of the second auxiliary level downwards.

31. The method according to claim 28 or 29, wherein the determining of the reference structure comprises:
3D imaging and generation of digital data,
Manual identification or automatic identification of anatomical landmarks using the digital data,
Definition of a transversal direction using the identified anatomical landmarks, which also defines the direction of a sagittal plane,
Determine the center point between the anatomical landmarks,
Use a digital 3D structure marker that comprises at least three plane packages:
1) A transversal plane package that comprises several transversal planes parallel to each other,
2) A frontal plane package comprising several frontal planes parallel to each other, and
3) At least one sagittal plane package comprising several sagittal planes parallel to each other,
Insertion of the 3D structure marker into the 3D image space of the digital data,
Aligning the 3D structure marker to the determined center point or to a median sagittal plane Sm that was previously placed at the determined center point,
Translation of the 3D structure marker to a first anchor point, which is preferably located in the median sagittal plane.
Rotation of the 3D structure marker using a second anchor point.
Scaling of the 3D structure marking using a third anchor point,
Determining the ideal chewing plane using the 3D structure marking.

32. The method according to any one of claims 28 to 31, wherein after wearing the last device (10) according to a treatment plan (BP2 to BP4), a final restoration (300) of the teeth and/or tooth stumps of the person (P) is carried out,
whereby the final restoration (300) creates a permanent chewing surface that corresponds to a planned chewing surface.

33. A manufacturing method, in particular for manufacturing a series according to one of claims 1 to 27 or based on the devices of the series (100) designed according to a method of claims 28 to 32,
wherein a subtractive manufacturing process is used to manufacture the series (100) of devices (10) or at least to manufacture a part of the devices (10),
preferably using a subtractive machining process, in particular milling, or
wherein an additive manufacturing process is used to manufacture the series (100) from devices or from pairs of devices (10.1 to 10.n) or at least to manufacture a part of the devices, in particular 3D printing,

34. A computer system (1600) comprising:
at least one memory unit (M) configured to store instructions of a program, and
a control unit (P) adapted to execute instructions of the program that cause the computer to execute at least part of the method according to any one of claims 28 to 32, in particular the steps related to the design of the devices of the series (100), and/or
a computer program comprising machine-readable instructions which, when executed by a control unit (P), cause the control unit (P) to execute at least part of the method according to any one of claims 28 to 32, and/or
a computer program product comprising machine-readable instructions which, when executed by a control unit (P), cause the control unit (P) to execute at least part of the method according to any one of claims 28 to 32, and/or
digital data generated by a method according to any one of claims 28 to 32 or required by a method according to claim 33, in particular design data and/or manufacturing data for manufacturing the devices of the series (100) or device pairs (10) of the devices of the series (100) with a manufacturing machine (Ma).
